(19) United States
(12) Patent Application Publication
(10) Pub. No.: US 2010/0071574 A1
(43) Pub. Date: Mar. 25, 2010

(54) LITHOGRAPHIC PRINTING PLATE PRECURSOR AND PRINTING METHOD USING THE SAME

(76) Inventors: Toyohisa Oya, Shizuoka (JP); Koji Sonokawa, Shizuoka (JP); Tomoya Sasaki, Shizuoka (JP)

Correspondence Address: BIRCH STEWART KOLASCH & BIRCH, PO BOX 747, FALLS CHURCH, VA, 22040-0747, US

(21) Appl. No.: 12/563,547

(22) Filed: Sep. 21, 2009

(30) Foreign Application Priority Data
Sep. 22, 2008 (JP) P2008-243377
Sep. 29, 2008 (JP) P2008251923
Jul. 22, 2009 (JP) P2009-171394

(51) Int. Cl. B41N 1/00; G03C 1/00

(52) U.S. Cl. 101/454; 430/270.1

(57) ABSTRACT

A lithographic printing plate precursor includes a support and an image-recording layer containing (A) an infrared absorbing agent, (B) a polymerization initiator, (C) a polymerizable compound and (D) a compound represented by the following formula (I):

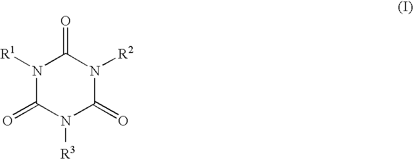

wherein R¹ to R³ each independently represents a hydrogen atom or a group selected from an alkyl group, an aryl group and a heterocyclic group, provided that at least one of R¹ to R³ represents the group having a substituent containing an amido bond, the group having a substituent containing a urethane bond, the group having a substituent containing a urea bond or the group having two or more hydroxy groups.

### FIELD OF THE INVENTION

The present invention relates to a lithographic printing plate precursor capable of being subjected to image recording with laser and capable of being subjected to on-press development, and a printing method using the same.

### BACKGROUND OF THE INVENTION

In general, a lithographic printing plate is composed of an oleophilic image area accepting ink and a hydrophilic non-image area accepting dampening water in the process of printing. Lithographic printing is a printing method utilizing the nature of water and oily ink to repel with each other and comprising rendering the oleophilic image area of the lithographic printing plate to an ink-receptive area and the hydrophilic non-image area thereof to a dampening water-receptive area (ink-unreceptive area), thereby making a difference in adherence of the ink on the surface of the lithographic printing plate, depositing the ink only to the image area, and then transferring the ink to a printing material, for example, paper.

In order to produce the lithographic printing plate, a lithographic printing plate precursor (PS plate) comprising a hydrophilic support having provided thereon an oleophilic photosensitive resin layer (image-recording layer) has heretofore been broadly used. Ordinarily, the lithographic printing plate is obtained by conducting plate making according to a method of exposing the lithographic printing plate precursor through an original, for example, a lith film, and then while leaving the image-recording layer corresponding to the image area, removing the unnecessary image-recording layer corresponding to the non-image area by dissolving with an alkaline developer or a developer containing an organic solvent thereby revealing the hydrophilic surface of support.

In the hitherto known plate making process of lithographic printing plate precursor, after exposure, the step of removing the unnecessary image-recording layer by dissolving, for example, with a developer is required. However, it is one of the subjects to save or simplify such an additional wet treatment described above. Particularly, since disposal of liquid wastes discharged accompanying the wet treatment has become a great concern throughout the field of industry in view of the consideration for global environment in recent years, the demand for the solution of the above-described subject has been increased more and more.

As one of simple plate making methods in response to the above-described requirement, a method referred to as on-press development has been proposed wherein a lithographic printing plate precursor having an image-recording layer capable of being removed in its unnecessary areas during a conventional printing process is used and after exposure, the unnecessary area of the image-recording layer is removed on a printing machine to prepare a lithographic printing plate.

Specific methods of the on-press development include, for example, a method of using a lithographic printing plate precursor having an image-recording layer that can be dissolved or dispersed in dampening water, an ink solvent or an emulsion of dampening water and ink, a method of mechanically removing an image-recording layer by contact with rollers or a blanket cylinder of a printing machine, and a method of lowering cohesion of an image-recording layer or adhesion between an image-recording layer and a support upon penetration of dampening water, ink solvent or the like and then mechanically removing the image-recording layer by contact with rollers or a blanket cylinder of a printing machine.

In the specification, unless otherwise indicated particularly, the term “development processing step” means a step of using an apparatus (ordinarily, an automatic developing machine) other than a printing machine and removing an unexposed area in an image-recording layer of a lithographic printing plate precursor upon contact with liquid (ordinarily, an alkaline developer) thereby revealing a hydrophilic surface of support. The term “on-press development” means a method or a step of removing an unexposed area in an image-recording layer of a lithographic printing plate precursor upon contact with liquid (ordinarily, printing ink and/or dampening water) by using a printing machine thereby revealing a hydrophilic surface of support.

On the other hand, digitalized technique of electronically processing, accumulating and outputting image information using a computer has been popularized in recent years, and various new image-outputting systems responding to the digitalized technique have been put into practical use. Correspondingly, attention has been drawn to a computer-to-plate technique of carrying digitalized image information on highly converging radiation, for example, a laser beam and conducting scanning exposure of a lithographic printing plate precursor with the radiation thereby directly preparing a lithographic printing plate without using a lith film. Thus, it is one of the important technical subjects to obtain a lithographic printing plate precursor adaptable to the technique described above.

In the simplification of plate making operation and the realization of dry system or non-processing system as described above, since the image-recording layer after the exposure is not fixed with the development processing, it is likely to be fogged before printing. Therefore, an image-recording layer capable of being handled in a bright room or under a yellow lump and a light source for the exposure are necessary.

As such a laser light source, a semiconductor laser emitting an infrared ray having a wavelength of 760 to 1,200 and a solid laser, for example, YAG laser, are extremely useful because these lasers having a large output and a small size are inexpensively available. Also, an UV laser can be used.

As the lithographic printing plate precursor of on-machine development type capable of conducting image-recording with an infrared laser, for example, a lithographic printing plate precursor having provided on a hydrophilic support, an image-forming layer in which hydrophobic thermoplastic polymer particles are dispersed in a hydrophilic binder is described in Japanese Patent 2938397. It is described in Japanese Patent 2938397 that the lithographic printing plate precursor is exposed to an infrared laser to agglomerate the hydrophobic thermoplastic polymer particles by heat thereby forming an image and mounted on a plate cylinder of a printing machine to be able to carry out on-press development by supplying dampening water and/or ink.

Although the method of forming image by agglomeration of fine particles only upon thermal fusion shows good on-press development property, it has a problem in that the image strength is extremely weak and printing durability is insufficient.

Further, lithographic printing plate precursors having provided on a hydrophilic support, microcapsules containing a polymerizable compound encapsulated therein are described in JP-A-2001-277740 (the term “JP-A” as used herein means an “unexamined published Japanese patent application”) and JP-A-2001-277742.

Moreover, lithographic printing plate precursors having provided on a support, a photosensitive layer containing an infrared absorbing agent, a radical polymerization initiator and a polymerizable compound are described in JP-A 2002-287334 and JP-A 2006-116941. Moreover, lithographic printing plate precursors having a photosensitive layer containing a polymer compound having at least one ethylenically unsaturated bond are described in JP-A 2006-111860.

These methods using the polymerization reaction as described above have a feature that since the chemical bond density in the image area is high, the image strength is relatively good in comparison with the image area formed by the thermal fusion of fine polymer particles. However, these methods have a problem in that development removability of the unexposed area (non-image area), that is, on-press development property is insufficient and in particular, the on-press development property deteriorates with the lapse of time in some cases.

Thus, compatibility of improvement in the on-press development property and improvement in printing durability is a difficult problem to be solved in the conventional technology and the improvement has been desired.

Also, with respect to a lithographic printing plate precursor which is subjected to the development processing, the compatibility of improvement in the developing property and improvement in printing durability has been also desired.

### SUMMARY OF THE INVENTION

An object of the present invention is to provide a lithographic printing plate precursor which provides good development removability, particularly, good on-press development property after the lapse of time while maintaining good printing durability, and a printing method using the same.

As a result of the intensive investigations, the inventors have found that good development removability, particularly, good on-press development property after the lapse of time can be achieved while maintaining good printing durability by a lithographic printing plate precursor containing in its image-recording layer a compound having an isocyanuric acid skeleton containing a specific substituent to complete the present invention.

Specifically, the present invention includes the following items.

(1) A lithographic printing plate precursor comprising a support and an image-recording layer containing (A) an infrared absorbing agent, (B) a polymerization initiator, (C) a polymerizable compound and (D) a compound represented by the following formula (I):

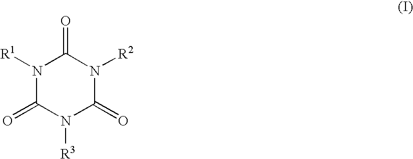

In formula (I), R¹ to R³ each independently represents a hydrogen atom or a group selected from an alkyl group, an aryl group and a heterocyclic group, provided that at least one of R¹ to R³ represents the group having a substituent containing an amido bond, the group having a substituent containing a urethane bond, the group having a substituent containing a urea bond or the group having two or more hydroxy groups.

(2) The lithographic printing plate precursor as described in (1) above, wherein the group selected from an alkyl group, an aryl group and a heterocyclic group which has a substituent containing an amido bond, a urethane bond or a urea bond further has a hydroxy group.
(3) The lithographic printing plate precursor as described in (1) or (2) above, wherein at least one of R¹ to R³ in the compound represented by formula (I) is an alkyl group having two or more hydroxy groups.
(4) The lithographic printing plate precursor as described in any one of (1) to (3) above, wherein the polymerizable compound has an isocyanuric acid skeleton.
(5) The lithographic printing plate precursor as described in any one of (1) to (4) above, wherein the image-recording layer is capable of forming an image by supplying printing ink and dampening water (fountain solution) on a printing machine after imagewise exposure to remove an unexposed area.
(6) A printing method comprising mounting the lithographic printing plate precursor as described in any one of (1) to (5) above on a printing machine after imagewise exposure or exposing imagewise the lithographic printing plate precursor as described in any one of (1) to (5) above after mounting on a printing machine, and then conducting on-press development processing by supplying printing ink and dampening water to perform printing.

The lithographic printing plate precursor according to the invention exhibits excellent performances of improvements in development removability in the unexposed area and on-press development property and of extremely small variation of the on-press development property with the lapse of time while maintaining good printing durability by the incorporation of the compound (D) represented by formula (I) into the image-recording layer.

Although the reason that the compound (D) represented by formula (I) according to the invention exhibits the effects is not quite clear, it is believed to be that since the compound (D) represented by formula (I) has a hydrophilic substituent, it provides sufficient water permeability at the on-press development and due to the presence of the isocyanuric acid skeleton undesirable change with the lapse of time, for example, localization of the compound on the surface of the image-recording layer, is prevented.

According to the present invention, a lithographic printing plate precursor which provides good development removability, particularly, good on-press development property after the lapse of time while maintaining good printing durability, and a printing method using the same can be provided.

### DETAILED DESCRIPTION OF THE INVENTION

### Lithographic Printing Plate Precursor

The lithographic printing plate precursor according to the invention comprises a support and an image-recording layer containing (A) an infrared absorbing agent, (B) a polymerization initiator, (C) a polymerizable compound and (D) a compound (hereinafter, also referred to as a specific compound) represented by formula (I).

In particular, it is preferred that the lithographic printing plate precursor according to the invention is capable of forming an image by supplying printing ink and dampening water on a printing machine after imagewise exposure to remove the unexposed area of the image-recording layer (that is, by on-press development).

The lithographic printing plate precursor according to the invention may also have a construction in which a protective layer is provided on the image-recording layer provided on the support.

The lithographic printing plate precursor according to the invention will be described in more detail below.

### Image-Recording Layer

### [(D) Compound Represented by Formula (I) (Specific Compound)]

The image-recording layer according to the invention contains the compound represented by formula (I) shown below.

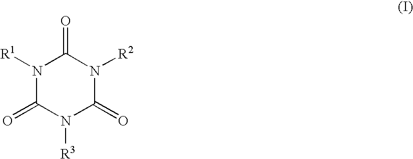

In formula (I), R¹ to R³ each independently represents a hydrogen atom or a group selected from an alkyl group, an aryl group and a heterocyclic group, provided that at least one of R¹ to R³ represents the group having a substituent containing an amido bond, the group having a substituent containing a urethane bond, the group having a substituent containing a urea bond or the group having two or more hydroxy groups.

The amido bond represents a structure of —C(═O)—N(R⁴)—. The urethane bond represents a structure of —N(R⁵)—C(═O)—O—. The urea bond represents a structure of —N(R⁶)—C(═O)—N(R⁷)—. In the above formulae, R⁴ to R⁷ each independently represents a hydrogen atom, an alkyl group which may be substituted, an aryl group which may be substituted or a heterocyclic group which may be substituted.

Hereinafter, the amido bond, urethane bond and urea bond are each also referred to as a specific bond.

When each R¹ to R³ represents the group having a substituent containing the specific bond, it is preferred that the group further has a hydroxy group and it is particularly preferred that the group further has two or more hydroxy groups.

[Compound represented by formula (I) wherein R¹ to R³ each independently represents a hydrogen atom or a group selected from an alkyl group, an aryl group and a heterocyclic group, provided that at least one of R¹ to R³ represents the group having a substituent containing an amido bond, the group having a substituent containing the urethane bond or a group having a substituent containing a urea bond (hereinafter, also referred to as specific compound I-I)]

The alkyl group represented by any one of R¹ to R³ includes a straight-chain, branched or cyclic alkyl group having from 1 to 20 carbon atoms. Among them, a straight-chain alkyl group having from 1 to 12 carbon atoms, a branched alkyl group having from 3 to 12 carbon atoms and a cyclic alkyl group having from 5 to 10 carbon atoms are more preferable.

Specific examples of the alkyl group include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eucosyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclohexyl group, a cyclopentyl group and a 2-norbornyl group.

In the specific compound I-I according to the invention, when the alkyl group represented by any one of R¹ to R³ has a substituent (that is, in case of a substituted alkyl group), as an alkylene moiety in the substituted alkyl group, a divalent organic residue resulting from elimination of any one of hydrogen atoms on the above-described alkyl group can be enumerated. The range of preferable number of carbon atoms included in the alkylene moiety is same as that described with respect to the alkyl group.

When the alkyl group represented by any one of R¹ to R³ has a substituent, the substituent is preferably a group containing the specific bond. The group may further be substituted.

The alkyl moiety in the description of the substituent capable of being introduced described below is same as the alkyl group represented by any one of R¹ to R³ and the range of preferable number of carbon atoms included in the alkyl moiety is same as that described with respect to the alkyl group.

Specific examples of the aryl moiety in the description of the substituent capable of being introduced described below include a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, an acetylaminophenyl group, a carboxyphenyl group, a methoxycarbonylphenyl group, an ethoxycarbonylphenyl group, a phenoxycarbonylphenyl group, an N-phenylcarbamoylphenyl group, a cyanophenyl group, a sulfophenyl group, a sulfonatophenyl group, a phosphonophenyl group and a phosphonatophenyl group.

Examples of the substituent containing an amido bond capable of being introduced into the alkyl group include an acylamino group, an N-alkylacylamino group, an N-arylacylamino group, a carbamoyl group, an N-alkylcarbamoyl group, an N,N-dialkylcarbamoyl group, an N-arylcarbamoyl group, an N,N-diarylcarbamoyl group and an N-alkyl-N-arylcarbamoyl group.

Examples of the substituent containing a urethane bond capable of being introduced into the alkyl group include a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group and an N-aryl-N-aryloxycarbonylamino group.

Examples of the substituent containing a urea bond capable of being introduced into the alkyl group include a ureido group, an N′-alkylureido group, an N′,N′-dialkylureido group, an N′-arylureido group, an N′,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-allylureido group, an N′,N′-diaryl-N-arylureido group, an N′-alkyl-N′-aryl-N-alkylureido group and an N′-alkyl-N′-aryl-N-arylureido group.

The alkyl moiety and aryl moiety in the substituent described above are same as the alkyl group and aryl group represented by any one of R¹ to R³ and the preferable range is also same as that described above, respectively.

Preferable specific examples of the alkyl group having a substituent containing an amido bond represented by any one of R¹ to R³ include an N-acetylamionoethyl group, an N-acetylamionopropyl group, an N-acetylamionobutyl group, an N-acetylamionohexyl group, an N-acetylamionooctyl group, an N-propionylamionoethyl group, an N-propionylamionopropyl group, an N-propionylamionobutyl group, an N-propionylamionohexyl group, an N-butyrylamionoetyl group, an N-butyrylamionopropyl group, an N-butyrylamionobutyl group, an N-butyrylamionohexyl group, an N-benzoylamionoethyl group, a 3-(N-(hydroxymethylcarbonyl)amino)propyl group, a 2-hydroxy-3-(N-(hydroxymethylcarbonyl)amino)propyl group, a 3-(N-((2-hydroxyethoxy)methylcarbonyl)amino)propyl group, an N-benzoylamionopropyl group, an N-benzoylamionobutyl group, an N-benzoylamionohexyl group, a carbamoylmethyl group, a carbamoylethyl group, a carbamoylpropyl group, a carbamoylbutyl group, a carbamoylhexyl group, an N-methylcarbamoylmethyl group, an N-methylcarbamoylethyl group, an N-methylcarbamoylpropyl group, an N-methylcarbamoylbutyl group, an N-methylcarbamoylhexyl group, an N-ethylcarbamoylmethyl group, an N-ethylcarbamoylethyl group, an N-ethylcarbamoylpropyl group, an N-ethylcarbamoylbutyl group, an N-ethylcarbamoylhexyl group, an N-phenylcarbamoylmethyl group, an N-phenylcarbamoylethyl group, an N-phenylcarbamoylpropyl group, an N-phenylcarbamoylbutyl group, an N-phenylcarbamoylhexyl group, an N-benzylcarbamoylmethyl group, an N-benzylcarbamoylethyl group, an N-benzylcarbamoylpropyl group, an N-benzylcarbamoylbutyl group, an N-benzylcarbamoylhexyl group, an N,N-dimethylcarbamoylmethyl group, an N,N-dimethylcarbamoylpropyl group, an N,N-dimethylcarbamoylbutyl group, an N,N-dimethylcarbamoylhexyl group, an N,N-dimethylcarbamoylethyl group, N,N-dimethylcarbamoylpropyl group, an N,N-dimethylcarbamoylbutyl group, an N,N-dimethylcarbamoylhexyl group, an N-cyclohexylcarbamoylmethyl group, an N-cyclohexylcarbamoylethyl group, an N-isopropylcarbamoylmethyl group, an N-isopropylcarbamoylethyl group, an N-(methoxyphenyl)carbamoylethyl group, an N-methyl-N-(solfophenyl)carbamoylmethyl group, an N-(2-hydroxyethyl)carbamoylethyl group, an N-(3-hydroxypropyl)carbamoylethyl group, an N-(2-hydroxyethyl)carbamoylpropyl group, an N-(3-hydroxypropyl)carbamoylpropyl group, an N-(2-(2-hydroxyethoxy)ethyl)carbamoylethyl group, an N,N-di(2-hydroxyethyl)carbamoylethyl group and an N,N-di(2-(2-hydroxyethoxy)ethyl)carbamoylethyl group.

Preferable specific examples of the alkyl group having a substituent containing a urethane bond represented by any one of R¹ to R³ include a carbamoyloxyethyl group, a carbamoyloxypropyl group, a carbamoyloxybutyl group, a carbamoyloxyhexyl group, an N-methylcarbamoyloxyethyl group, an N-methylcarbamoyloxypropyl group, an N-methylcarbamoyloxybutyl group, an N-methylcarbamoyloxyhexyl group, an N-ethylcarbamoyloxyethyl group, an N-ethylcarbamoyloxypropyl group, an N-ethylcarbamoyloxybutyl group, an N-ethylcarbamoyloxyhexyl group, an N-propylcarbamoyloxyethyl group, an N-propylcarbamoyloxypropyl group, an N-propylcarbamoyloxybutyl group, an N-propylcarbamoyloxyhexyl group, an N-isopropylcarbamoyloxyethyl group, an N-isopropylcarbamoyloxypropyl group, an N-isopropylcarbamoyloxybutyl group, an N-isopropylcarbamoyloxyhexyl group, an N-(2-hydroxyethyl)carbamoyloxyethyl group, an N-(2-hydroxyethyl)carbamoyloxypropyl group, an N-(1,2-dihydroxyethyl)carbamoyloxypropyl group, a 2-hydroxy-3-(N-(1,2-dihydroxyethyl)carbamoyloxy)propyl group, an N-(3-hydroxypropyl)carbamoyloxyethyl group, an N-(2-methoxyethyl)carbamoyloxyethyl group, an N-(2-ethoxyethyl)carbamoyloxyethyl group, an N-(2-(2-hydroxyethoxy)ethyl)carbamoyloxyethyl group, an N-(2-(2-(2-hydroxyethoxy)ethoxy)ethyl)carbamoyloxyethyl group, an 2-(N-(2-hydroxyethyl)carbamoyloxy)ethoxyethyl group, an 2-(N-(3-hydroxypropyl)carbamoyloxy)ethoxyethyl group, an 2-(N-(2-methoxyethyl)carbamoyloxy)ethoxyethyl group, an 2-(N-(2-ethoxyethyl)carbamoyloxy)ethoxyethyl group, an 2-(N-(2-(2-hydroxyethoxy)ethyl)carbamoyloxy)ethoxyethyl group, an 2-(N-(2-(2-(2-hydroxyethoxy)ethoxy)ethyl)carbamoyloxy)ethoxyethyl group, an (N-(2-(2-ethoxy)ethoxyethyl)carbamoyloxyethyl group, an N-phenylcarbamoyloxyethyl group, an N-cyclohexylcarbamoyloxyethyl group, an N-benzylcarbamoyloxyethyl group, an N,N-dimethylcarbamoyloxyethyl group, an N,N-diethylcarbamoyloxyethyl group, an N,N-di(2-hydroxymethyl)carbamoyloxyethyl group, an N,N-di(2-hydroxyethyl)carbamoyloxyethyl group, an N,N-di(2-hydroxypropyl)carbamoyloxyethyl group, an N,N-di(2-(2-hydroxyethoxy)ethyl)carbamoyloxyethyl group, an N,N-di(2-(2-(2-methoxy)ethoxy)ethyl)carbamoyloxyethyl group, an N,N-di(2-(2-(2-ethoxy)ethoxy)ethyl)carbamoyloxyethyl group, an N-methoxycarbonylaminoethyl group, an N-ethoxycarbonylaminoethyl group, an N-methoxycarbonylaminopropyl group, an N-ethoxycarbonylaminopropyl group, an N-phenoxycarbonylaminoethyl group, an N-phenoxycarbonylaminopropyl group, an N-benzyloxycarbonylaminoethyl group, an N-benzyloxycarbonylaminopropyl group, an N-(2-hydroxyethoxycarbonyl)aminoethyl group, an N-(2-hydroxyethoxycarbonyl)aminopropyl group, an N-(3-hydroxypropoxycarbonyl)aminoethyl group, an N-(3-hydroxypropoxycarbonyl)aminopropyl group, an N-(2,3-dihydroxypropoxycarbonyl)aminoethyl group and an N-(2,3-dihydroxypropoxycarbonyl)aminopropyl group.

Preferable specific examples of the alkyl group having a substituent containing a urea bond represented by any one of R¹ to R³ include a ureidoethyl group, a ureidopropyl group, a ureidobutyl group, a ureidohexyl group, an N-methylureidoethyl group, an N-methylureidopropyl group, an N-methylureidobutyl group, an N-methylureidohexyl group, an N-ethylureidoethyl group, an N-ethylureidopropyl group, an N-ethylureidobutyl group, an N-ethylureidohexyl group, an N-propylureidoethyl group, an N-propylureidopropyl group, an N-propylureidobutyl group, an N-propylureidohexyl group, an N-isopropylureidoethyl group, an N-isopropylureidopropyl group, an N-isopropylureidobutyl group, an N-isopropylureidohexyl group, an N-(2-hydroxyethyl)ureidoethyl group, an N-(2-hydroxyethyl)ureidopropyl group, an N-(1,2-dihydroxyethyl)ureidoethyl group, an N-(1,2-dihydroxyethypureidopropyl group, an N-(3-hydroxypropyl)ureidoethyl group, an N-(2-methoxyethyl)ureidoethyl group, an N-(2-ethoxyethyl)ureidoethyl group, an N-(2-(2-hydroxyethoxy)ethyl)ureidoethyl group, an N-(2-(2-(2-hydroxyethoxy)ethoxy)ethyl)ureidoethyl group, an 2-(N-(2-hydroxyethypureido)ethoxyethyl group, an 2-(N-(3-hydroxypropyl)ureido)ethoxyethyl group, an 2-(N-(2-methoxyethyl)ureido)ethoxyethyl group, an 2-(N-(2-ethoxyethyl)ureido)ethoxyethyl group, an 2-(N-(2-(2-hydroxyethoxy)ethyl)ureido)ethoxyethyl group, an 2-(N-(2-(2-(2-hydroxyethoxy)ethoxy)ethyl)ureido)ethoxyethyl group, an (N-(2-(2-ethoxy)ethoxyethyl)ureidoethyl group, an N-phenylureidoethyl group, an N-cyclohexylureidoethyl group, an N-benzylureidoethyl group, an N,N-dimethylureidoethyl group, an N,N-diethylureidoethyl group, an N,N-di(2-hydroxymethypureidoethyl group, an N,N-di(2-hydroxyethyl)ureidoethyl group, an N,N-di(2-hydroxypropyl)ureidoethyl group, an N,N-di(2-(2-hydroxyethoxy)ethyl)ureidoethyl group, an N,N-di(2-(2-(2-methoxy)ethoxy)ethyl)ureidoethyl group, an N,N-di(2-(2-(2-ethoxy)ethoxy)ethyl)ureidoethyl group.

A substituent capable of being introduced into the alkyl group represented by any one of R¹ to R³ other than the group containing the specific bond includes a monovalent substituent constituting from a nonmetallic atom as shown below. Preferable examples thereof include a halogen atom (for example, —F, —Br, —Cl or —I), a hydroxy group, an alkoxy group, an aryloxy group, a mercapto group, an alkylthio group, an arylthio group, an alkyldithio group, an aryldithio group, an amino group, an N-alkylamino group, an N,N-dialkylamino group, an N-arylamino group, an N,N-diarylamino group, an N-alkyl-N-arylamino group, an acyloxy group, an alkylsulfoxy group, an arylsulfoxy group, an acylthio group, a formyl group, an acyl group, a carboxyl group, an alkoxycarbonyl group, an aryloxycarbonyl group, an alkylsulfinyl group, an arylsulfinyl group, an alkylsulfonyl group, an arylsulfonyl group, a sulfo group (—SO₃H) and its conjugate base group (hereinafter referred to as a “sulfonato group”), an alkoxysulfonyl group, an aryloxysulfonyl group, a sulfinamoyl group, an N-alkylsulfinamoyl group, an N,N-dialkylsulfinamoyl group, an N-aryl-sulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, a phosphono group (—PO₃H₂) and its conjugate base group (hereinafter referred to as a “phosphonato group”), a dialkylphosphono group (—PO₃(alkyl)₂, wherein “alkyl” represents an alkyl group, hereinafter the same), a diarylphosphono group (—PO₃(aryl)₂, wherein “aryl” represents an aryl group, hereinafter the same), an alkylarylphosphono group (—PO₃(alkyl)(aryl)), a monoalkylphosphono group (—PO₃H(alkyl)) and its conjugate base group (hereinafter referred to as an “alkylphosphonato group”), a monoarylphosphono group (—PO₃H(aryl)) and its conjugate base group (hereinafter referred to as an “arylphosphonato group”), a phosphonooxy group (—OPO₃H₂) and its conjugate base group (hereinafter referred to as a “phosphonatooxy group”), a dialkylphosphonooxy group (—OPO₃(alkyl)₂), a diarylphosphonooxy group (—OPO₃(aryl)₂), an alkylarylphosphonooxy group (—OPO₃(alkyl)(aryl)), a monoalkylphosphonooxy group (—OPO₃H(alkyl)) and its conjugate base group (hereinafter referred to as an “allylphosphonatooxy group”), a monoarylphosphonooxy group (—OPO₃H(aryl)) and its conjugate base group (hereinafter referred to as an “arylphosphonatooxy group”), a cyano group, a nitro group, an aryl group, an alkenyl group, an alkynyl group, a heterocyclic group and a silyl group.

Preferable specific examples of the alkyl group having a substituent other than the group containing the specific bond represented by any one of R¹ to R³ include a 2-hydroxyethyl group, a 3-hydroxypropyl group, a 2-hydroxypropyl group, a 2,3-dihydroxypropyl group, a 4-hydroxybutyl group, a 2,3-dihydroxybutyl group, a 3,4-dihydroxybutyl group, a 2,3,4-trihydroxybutyl group, a hydroxyethoxyethyl group, a hydroxyethoxyethoxyethyl group, a 5-hydroxypentyl group, a 6-hydroxyhexyl group, a 2-hydroxycyclohexyl group, a 3-hydroxycyclohexyl group, a 4-hydroxycyclohexyl group, a 2,3-dihydroxycyclohexyl group, a 3,4-dihydroxycyclohexyl group, a 2,4-dihydroxycyclohexyl group, a chloromethyl group, a bromomethyl group, a 2-chloroethyl group, a trifluoromethyl group, a methoxymethyl group, a methoxycarbonylmethyl group, an isopropoxymethyl group, a butoxymethyl group, a sec-butoxybutyl group, a methoxyethoxyethyl group, an allyloxymethyl group, a phenoxymethyl group, an acetyloxymethyl group, a methylthiomethyl group, a tolylthiomethyl group, a pyridylmethyl group, a tetramethylpiperidinylmethyl group, an N-acetyltetramethylpiperidinylmethyl group, a trimethylsilylmethyl group, a methoxyethyl group, an ethylaminoethyl group, a diethylaminopropyl group, a morpholinopropyl group, an acetyloxymethyl group, a benzoyloxymethyl group, a 2-oxoethyl group, a 2-oxopropyl group, a carboxypropyl group, a methoxycarbonylethyl group, an allyloxycarbonylbutyl group, a chlorophenoxycarbonylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phosphonooxypropyl group, a phosphonatooxybutyl group, a benzyl group, a phenethyl group, an α-methylbenzyl group, a 1-methyl-1-phenylethyl group and a p-methylbenzyl group.

The aryl group represented by any one of R¹ to R³ preferably includes groups derived from a benzene ring, a condensed ring formed from 2 to 5 benzene rings and a condensed ring formed from a benzene ring and a 5-membered to 7-membered unsaturated ring, each of which has from 6 to 30 carbon atoms. Among them, a benzene ring group and a naphthalene ring group are more preferable. Also, the aryl group represented by any one of R¹ to R³ may have a substituent on the carbon atom forming the ring. Preferable examples of the substituent include the alkyl group, the substituted alkyl group and the substituents for the alkyl group represented by any one of R¹ to R³ described above.

When the aryl group represented by any one of R¹ to R³ has a substituent, the substituent is preferably a group containing the specific bond. The group may further be substituted.

Preferable specific examples of the aryl group having a substituent containing an amido bond represented by any one of R¹ to R³ include a 2-(acetylamino)phenyl group, a 3-(acetylamino)phenyl group, a 4-(acetylamino)phenyl group, a 2-(propionylamino)phenyl group, a 3-(propionylamino)phenyl group, a 4-(propionylamino)phenyl group, a 2-(N-methylcarbamoyl)phenyl group, a 3-(N-methylcarbamoyl)phenyl group, a 4-(N-methylcarbamoyl)phenyl group, a 2-(N-ethylcarbamoyl)phenyl group, a 3-(N-ethylcarbamoyl)phenyl group, a 4-(N-ethylcarbamoyl)phenyl group, a 2-(N-(2-hydroxyethyl)carbamoyl)phenyl group, a 3-(N-(2-hydroxyethyl)carbamoyl)phenyl group, a 4-(N-(2-hydroxyethyl)carbamoyl)phenyl group, a 2-(N-(2-methoxyethyl)carbamoyl)phenyl group, a 3-(N-(2-methoxyethyl)carbamoyl)phenyl group, a 4-(N-(2-methoxyethyl)carbamoyl)phenyl group, a 2-(N-(2-ethoxyethyl)carbamoyl)phenyl group, a 3-(N-(2-ethoxyethyl)carbamoyl)phenyl group and a 4-(N-(2-ethoxyethyl)carbamoyl)phenyl group.

Preferable specific examples of the aryl group having a substituent containing a urethane bond represented by any one of R¹ to R³ include a carbamoyloxyphenyl group, an N-methylcarbamoyloxyphenyl group, an N-ethylcarbamoyloxyphenyl group, an N-(2-hydroxyethyl)carbamoyloxyphenyl group, an N-(3-hydroxypropyl)carbamoyloxyphenyl group, an N-(2-methoxyethyl)carbamoyloxyphenyl group, an N-(2-ethoxyethyl)carbamoyloxyphenyl group, an N-(2-(2-hydroxyethoxy)ethyl)carbamoyloxyphenyl group, an N-(2-(2-(2-hydroxyethoxy)ethoxy)ethyl)carbamoyloxyphenyl group, an 2-(N-(2-hydroxyethyl)carbamoyloxy)ethoxyphenyl group, an 2-(N-(2-methoxyethyl)carbamoyloxy)ethoxyphenyl group, an 2-(N-(2-ethoxyethyl)carbamoyloxy)ethoxyphenyl group, an 2-(N-(2-(2-hydroxyethoxy)ethyl)carbamoyloxy)ethoxyphenyl group, an 2-(N-(2-(2-(2-hydroxyethoxy)ethoxy)ethyl)carbamoyloxy)ethoxyphenyl group, an (N-(2-(2-ethoxy)ethoxyethyl)carbamoyloxyphenyl group, an N-phenylcarbamoyloxyphenyl group, an N,N-dimethylcarbamoyloxyphenyl group, an N,N-di(2-hydroxyethyl)carbamoyloxyphenyl group, an N,N-di(2-(2-hydroxyethoxy)ethyl)carbamoyloxyphenyl group, an N-methoxycarbonylaminophenyl group, an N-ethoxycarbonylaminophenyl group, an N-methoxycarbonylaminopropyl group, an N-ethoxycarbonylaminopropyl group, an N-phenoxycarbonylaminophenyl group, an N-phenoxycarbonylaminophenyl group, an N-benzyloxycarbonylaminopropyl group and an N-benzyloxycarbonylaminopropyl group.

Preferable specific examples of the aryl group having a substituent containing a ureido bond represented by any one of R¹ to R³ include a ureidophenyl group, an N-methylureidophenyl group, an N-ethylureidophenyl group, an N-(2-hydroxyethyl)ureidophenyl group, an N-(3-hydroxypropyl)ureidophenyl group, an N-(2-methoxyethyl)ureidophenyl group, an N-(2-ethoxyethyl)ureidophenyl group, an N-(2-(2-hydroxyethoxy)ethyl)ureidophenyl group, an N-(2-(2-(2-hydroxyethoxy)ethoxy)ethyl)ureidophenyl group, an 2-(N-(2-hydroxyethyl)ureido)ethoxyphenyl group, an 2-(N-(2-methoxyethyl)ureido)ethoxyphenyl group, an 2-(N-(2-ethoxyethyl)ureido)ethoxyphenyl group, an 2-(N-(2-(2-hydroxyethoxy)ethyl)ureido)ethoxyphenyl group, an 2-(N-(2-(2-(2-hydroxyethoxy)ethoxy)ethyl)ureido)ethoxyphenyl group, an (N-(2-(2-ethoxy)ethoxyethyl)ureidophenyl group, an N-phenylureidophenyl group, an N,N-dimethylureidophenyl group, an N,N-di(2-hydroxyethyl)ureidophenyl group, an N,N-di(2-(2-hydroxyethoxy)ethyl)ureidophenyl group and an N-methoxyureidophenyl group.

Preferable specific examples of the aryl group having a substituent other than the group containing the specific bond represented by any one of R¹ to R³ include a biphenyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, a carboxyphenyl group, a methoxycarbonylphenyl group, an ethoxyphenylcarbonyl group, a phenoxycarbonylphenyl group, a cyanophenyl group, a sulfophenyl group, a sulfonatophenyl group, a phosphonophenyl group and a phosphonatophenyl group.

The heterocyclic group represented by any one of R¹ to R³ includes preferably a 3-membered to 8-membered heterocyclic group having from 6 to 30 carbon atoms which may have a condensed ring, more preferably a 3-membered to 6-membered heterocyclic group containing a nitrogen atom, an oxygen atom or a sulfur atom, still more preferably a 5-membered to 6-membered heterocyclic group containing a nitrogen atom, an oxygen atom or a sulfur atom. Specific examples of the heterocyclic group include a pyrrole ring group, a furan ring group, a thiophene ring group, a benzopyrrole ring group, a benzofuran ring group, a benzothiophene ring group, a pyrazole ring group, an isoxazole ring group, an isothiazole ring group, an indazole ring, a benzisoxazole ring group, a benzisothiazole ring group, an imidazole ring group, an oxazole ring group, a thiazole ring group, a benzimidazole ring group, a benzoxazole ring group, a benzothiazole ring group, a pyridine ring group, a quinoline ring group, an isoquinoline ring group, a pyridazine ring group, a pyrimidine ring group, a pyrazine ring group, a phthalazine ring group, a quinazoline ring group, a quinoxaline ring group, an aciridine ring group, a phenanthrydine ring group, a carbazole ring group, a purine ring group, a pyrane ring group, a piperidine ring group, a piperazine ring group, a morpholine ring group, an indole ring group, an indolizine ring group, a chromene ring group, a cinnnoline ring group, an acridine ring group, a phenothiazine ring group, a tetrazole ring group and a triazine ring group.

Also, the heterocyclic group represented by any one of R¹ to R³ may have a substituent on the carbon atom forming the ring. Preferable examples of the substituent include the alkyl group, the substituted alkyl group and the substituents for the alkyl group represented by any one of R¹ to R³.

When the heterocyclic group represented by any one of R¹ to R³ has a substituent, the substituent is preferably a group containing the specific bond. The group may further be substituted.

Of the groups represented by any one of R¹ to R³, the alkyl group having a substituent containing the specific bond is more preferable, and the alkyl group further has a hydroxy group is particularly preferable. The groups represented by R¹ to R³ may be different groups from each other or two or more groups may be the same groups. It is more preferred that all of the groups represented by R¹ to R³ are the same groups.

Particularly preferable specific examples of the group represented by any one of R¹ to R³ are set forth below, but the invention should not be construed as being limited thereto.

An N-(2-hydroxyethyl)carbamoylethyl group, an N-(3-hydroxypropyl)carbamoylethyl group, an N-(2-hydroxyethyl)carbamoylpropyl group, an N-(3-hydroxypropyl)carbamoylpropyl group, an N-(2-(2-hydroxyethoxy)ethyl)carbamoylethyl group, an N,N-di(2-hydroxyethyl)carbamoylethyl group, an N,N-di(2-(2-hydroxyethoxy)ethyl)carbamoylethyl group, an N-(2-hydroxyethyl)carbamoyloxyethyl group, an N-(3-hydroxypropyl)carbamoyloxyethyl group, an N-(2-(2-hydroxyethoxy)ethyl)carbamoyloxyethyl group, an N-(2-(2-(2-hydroxyethoxy)ethoxy)ethyl)carbamoyloxyethyl group, an 2-(N-(2-hydroxyethyl)carbamoyloxy)ethoxyethyl group, an 2-(N-(3-hydroxypropyl)carbamoyloxy)ethoxyethyl group, an 2-(N-(2-(2-hydroxyethoxy)ethyl)carbamoyloxy)ethoxyethyl group, an 2-(N-(2-(2-(2-hydroxyethoxy)ethoxy)ethyl)carbamoyloxy)ethoxyethyl group, an N,N-di(2-hydroxymethyl)carbamoyloxyethyl group, an N,N-di(2-hydroxyethyl)carbamoyloxyethyl group, an N,N-di(2-hydroxypropyl)carbamoyloxyethyl group, an N,N-di(2-(2-hydroxyethoxy)ethyl)carbamoylethyl group, an N-(2-hydroxyethyl)ureidoethyl group, an N-(3-hydroxypropyl)ureidoethyl group, an N-(2-(2-hydroxyethoxy)ethyl)ureidoethyl group, a 2-(N-(2-(2-(2-hydroxyethoxy)ethoxy)ethyl)ureidoethyl group, a 2-(N-(2-hydroxyethyl)ureido)ethoxyethyl group, a 2-(N-(3-hydroxypropyl)ureido)ethoxyethyl group, a 2-(N-(2-(2-hydroxyethoxy)ethyl)ureido)ethoxyethyl group, a 2-(N-(2-(2-(2-hydroxyethoxy)ethoxy)ethyl)ureido)ethoxyethyl group, an N,N-di(2-hydroxymethypureidoethyl group, an N,N-di(2-hydroxyethyl)ureidoethyl group, an N,N-di(2-hydroxypropyl)ureidoethyl group, an N,N-di(2-(2-hydroxyethoxy)ethyl)ureidoethyl group, a 3-(N-(hydroxymethylcarbonyl)amino)propyl group, a 2-hydroxy-3-(N-(hydroxymethylcarbonyl)amino)propyl group, a 3-N-((2-hydroxyethoxy)methylcarbonyl)amino)propyl group, an N-(2-hydroxyethyl)carbamoyloxypropyl group, an N-(1,2-dihydroxyethyl)carbamoyloxypropyl group, a 2-hydroxy-3-(N-(1,2-dihydroxyethyl)carbamoyloxy)propyl group, an N-(2-hydroxyethoxycarbonyl)aminoethyl group, an N-(2-hydroxyethoxycarbonyl)aminopropyl group, an N-(3-hydroxypropoxycarbonyl)aminoethyl group, an N-(3-hydroxypropoxycarbonyl)aminopropyl group, an N-(2,3-dihydroxypropoxycarbonyl)aminoethyl group, an N-(2,3-dihydroxypropoxycarbonyl)aminopropyl group, an N-(2-hydroxyethyl)ureidopropyl group, an N-(1,2-dihydroxyethypureidoethyl group and an N-(1,2-hydroxyethyl)ureidopropyl group are exemplified.

Specific examples of the specific compound I-I according to the invention are set forth below, but the invention should not be construed as being limited thereto.

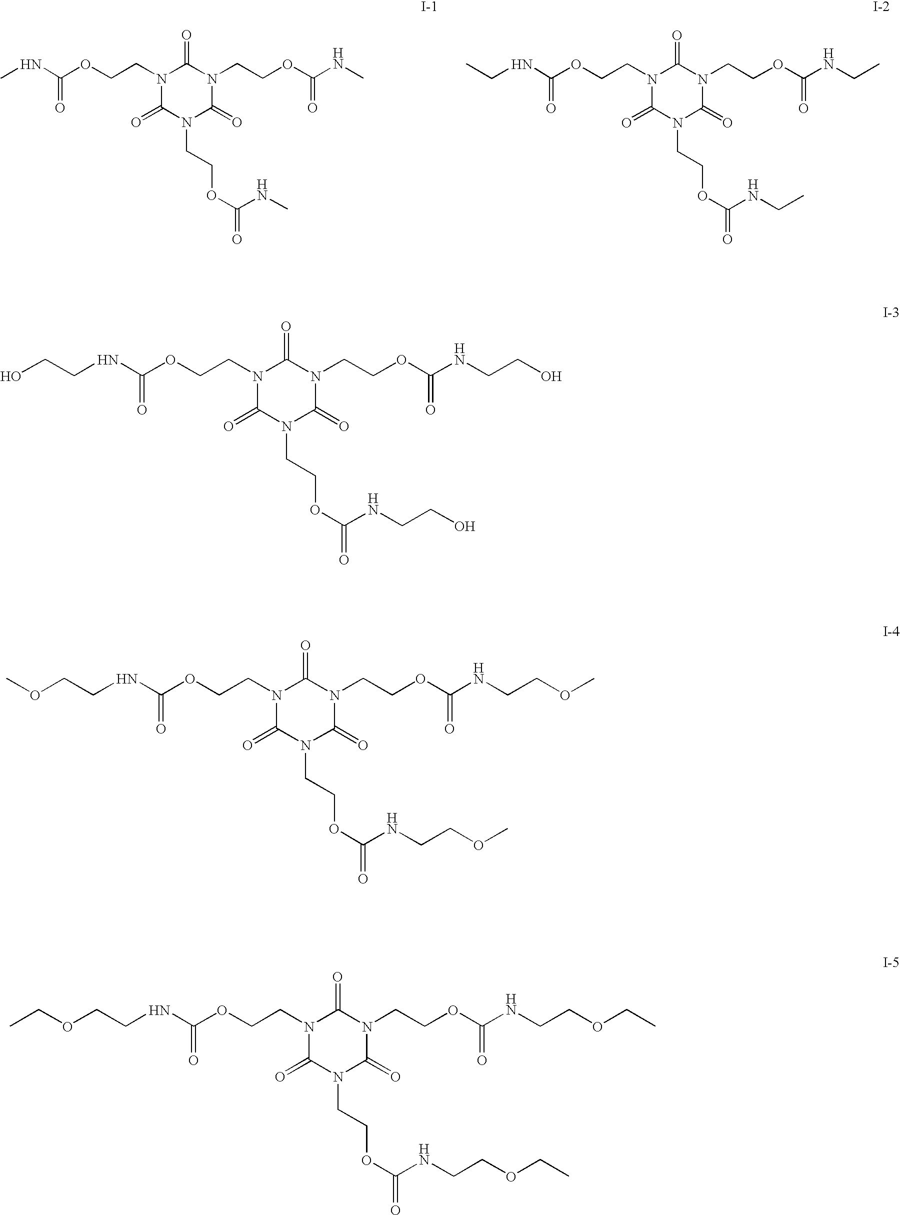

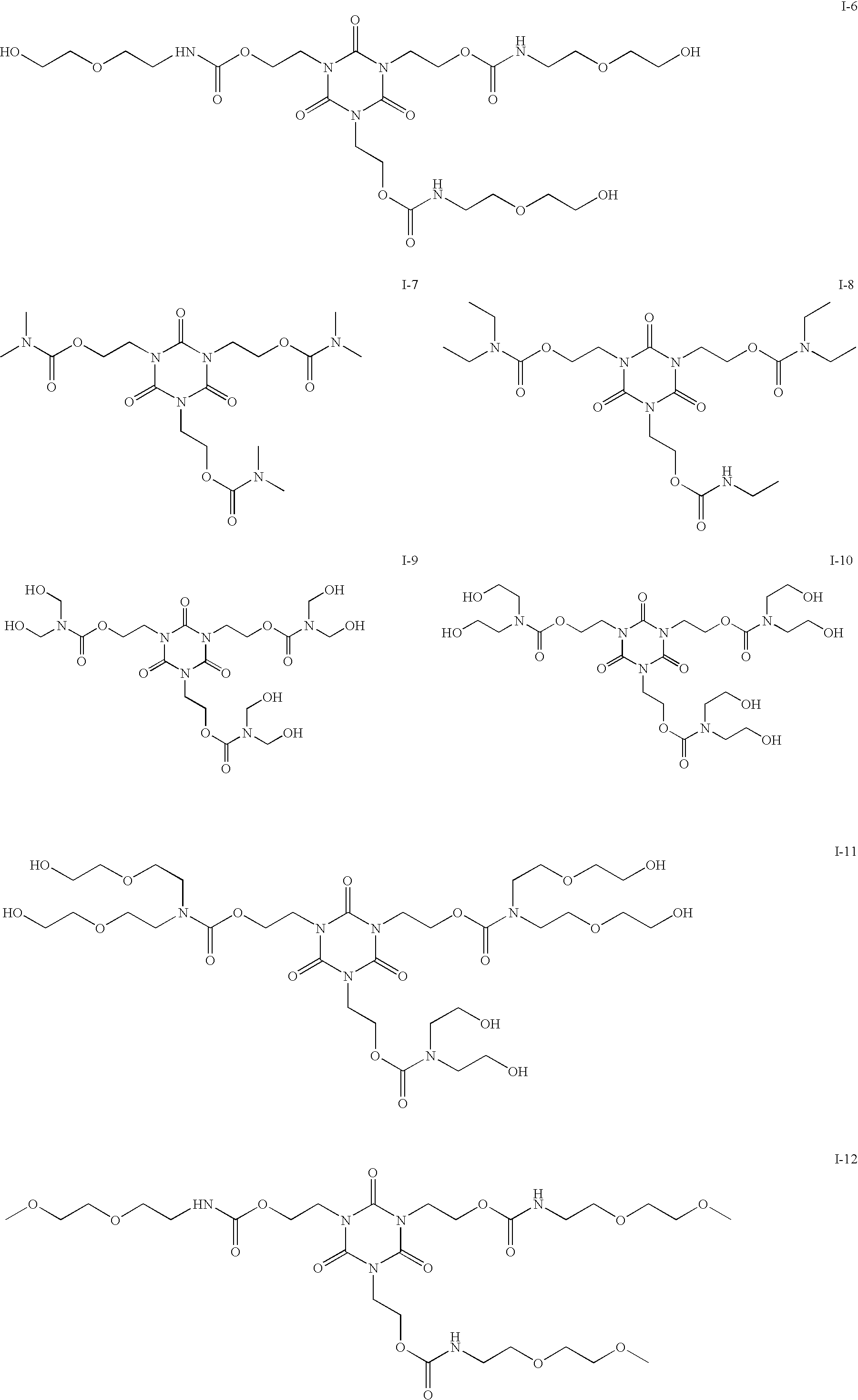

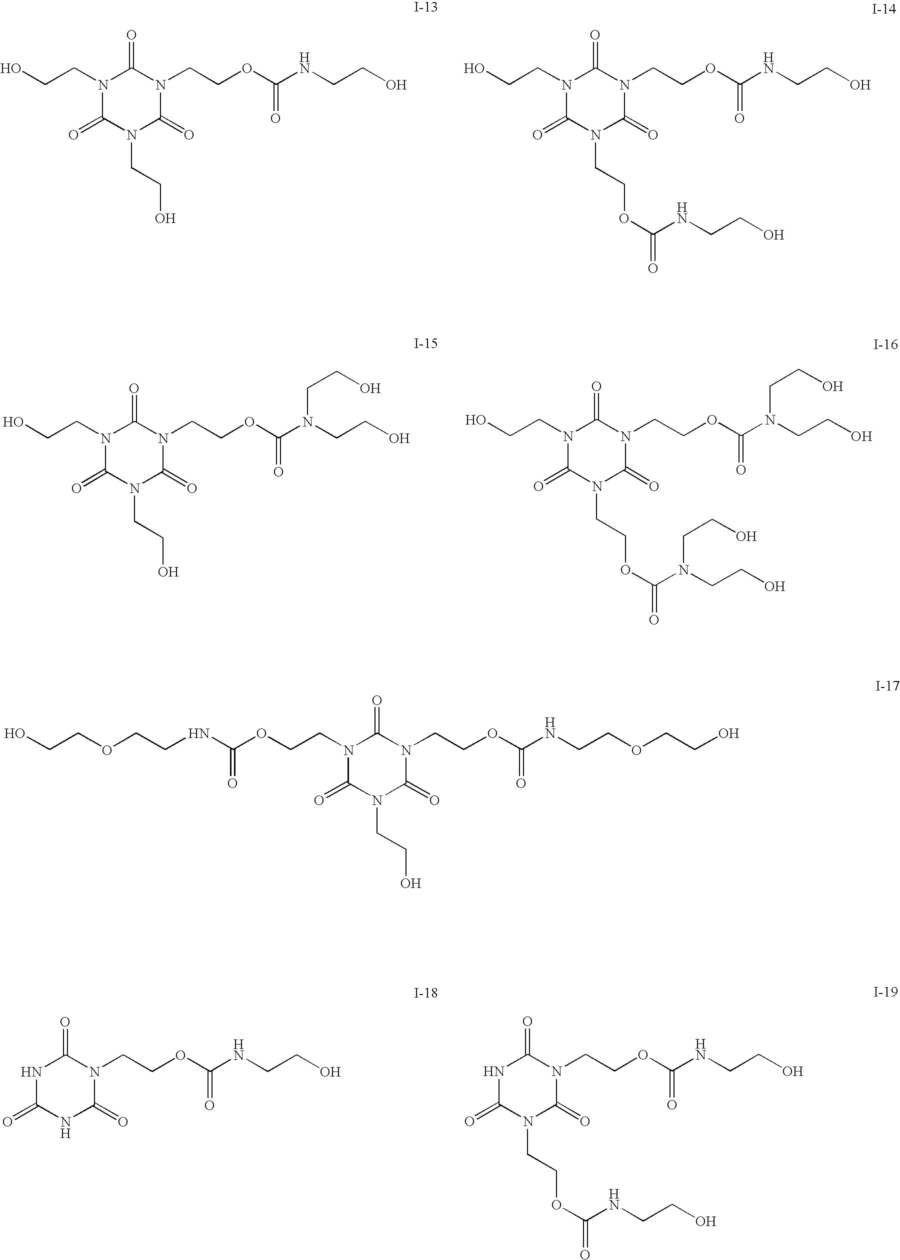

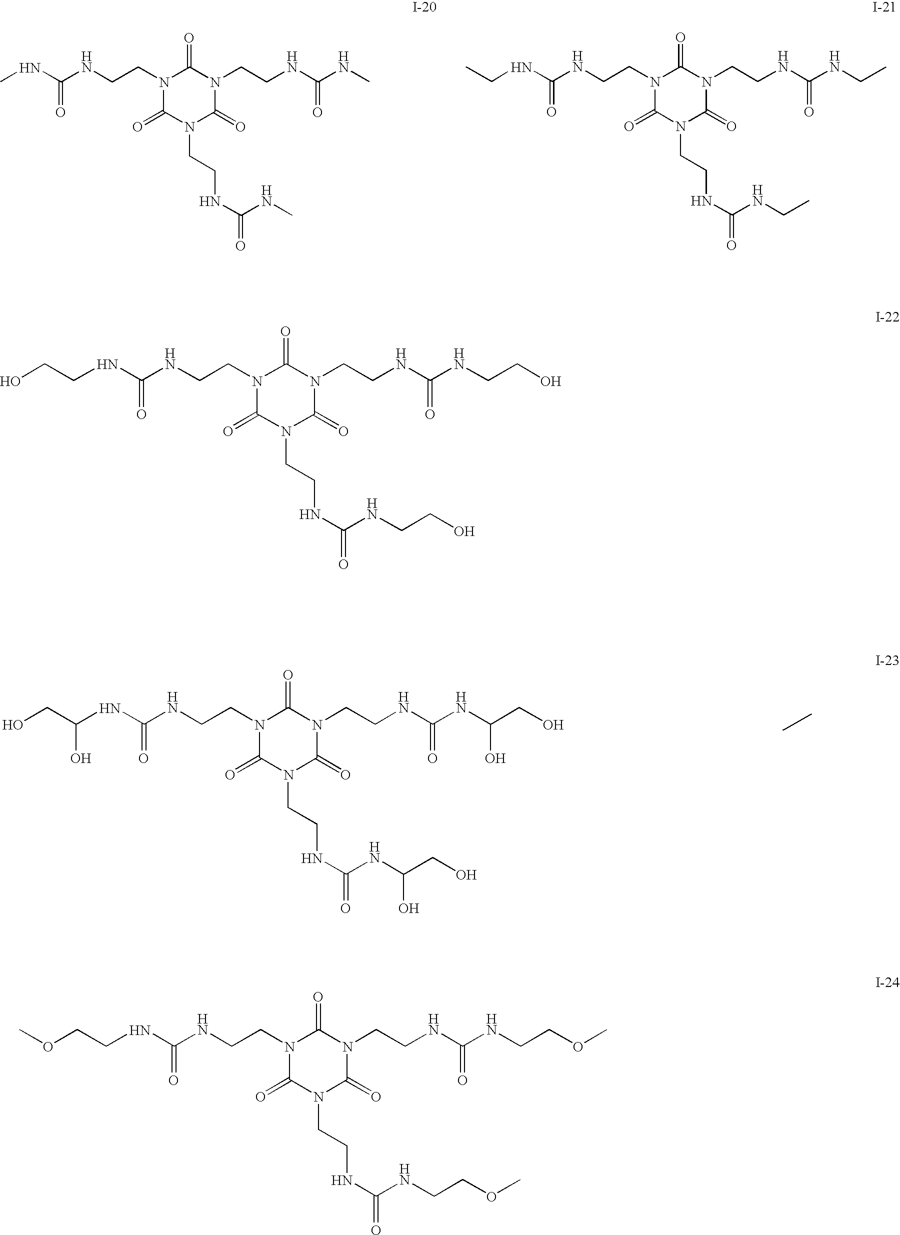

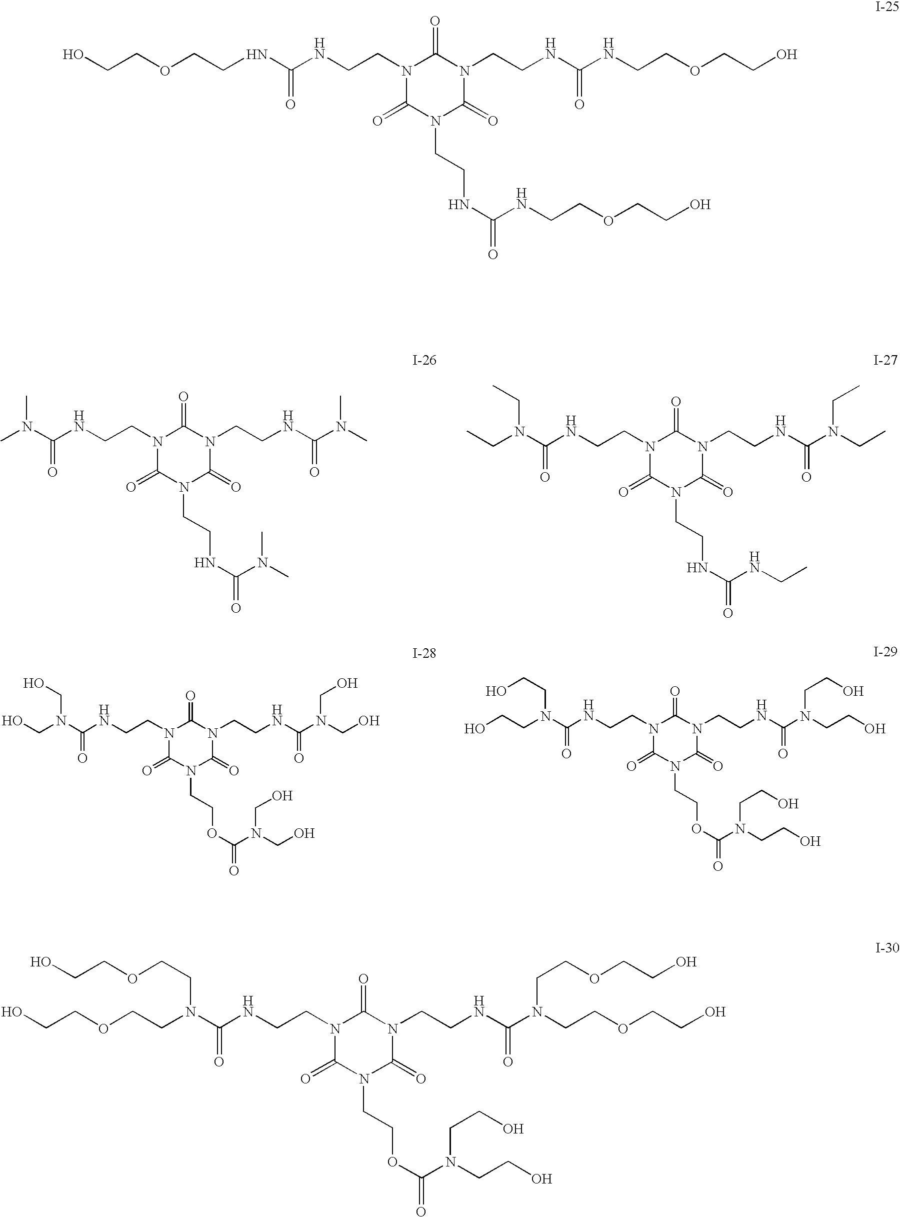

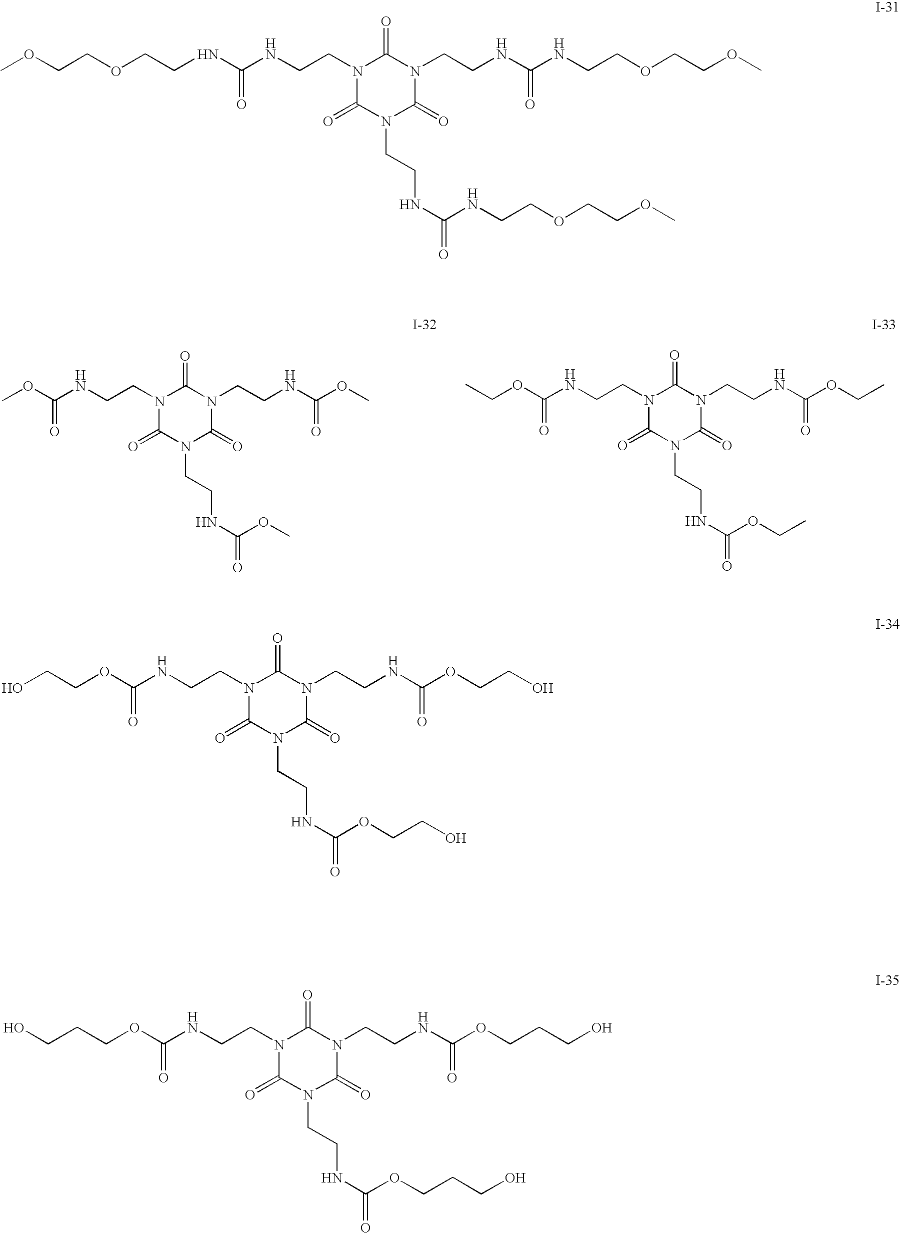

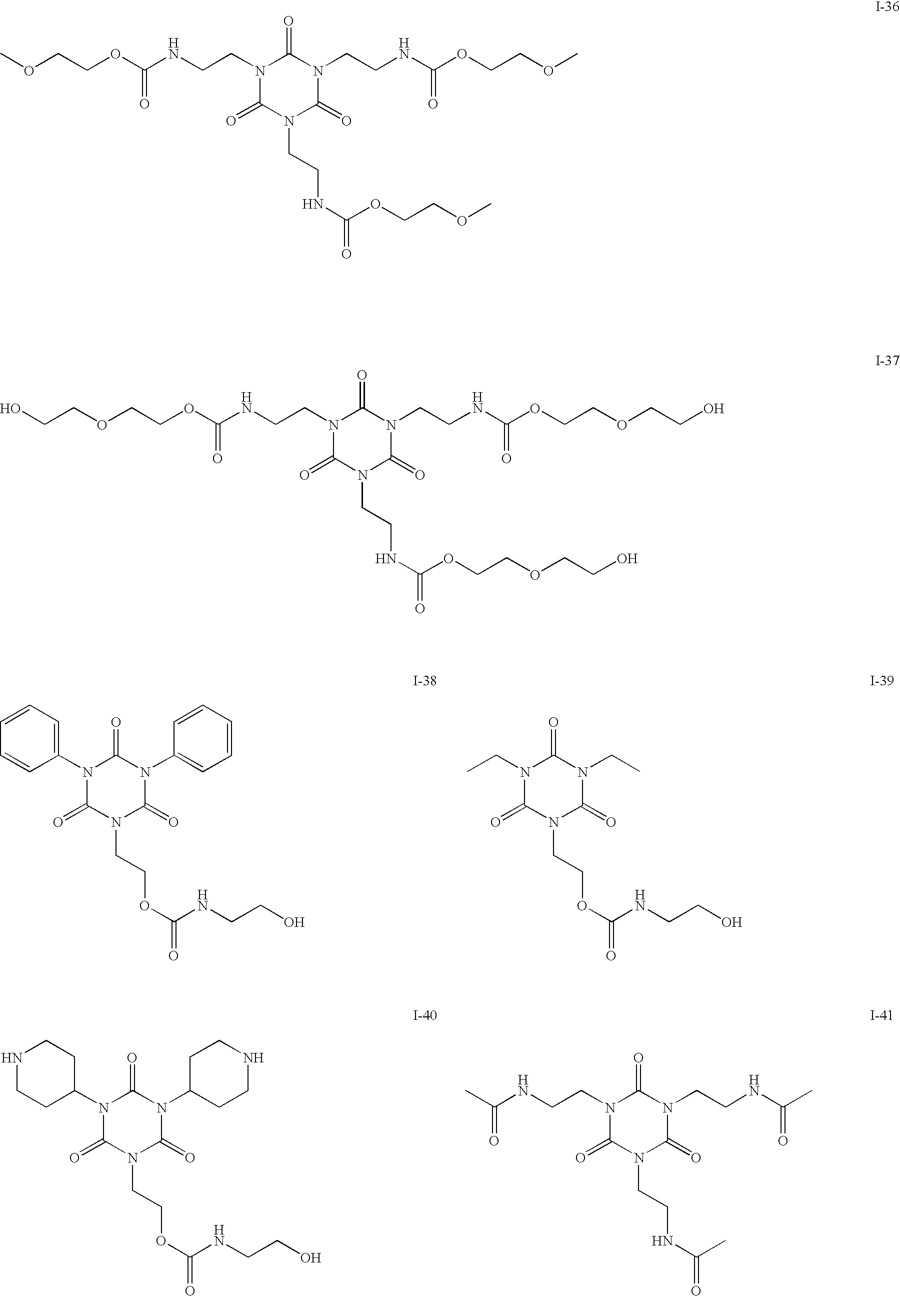

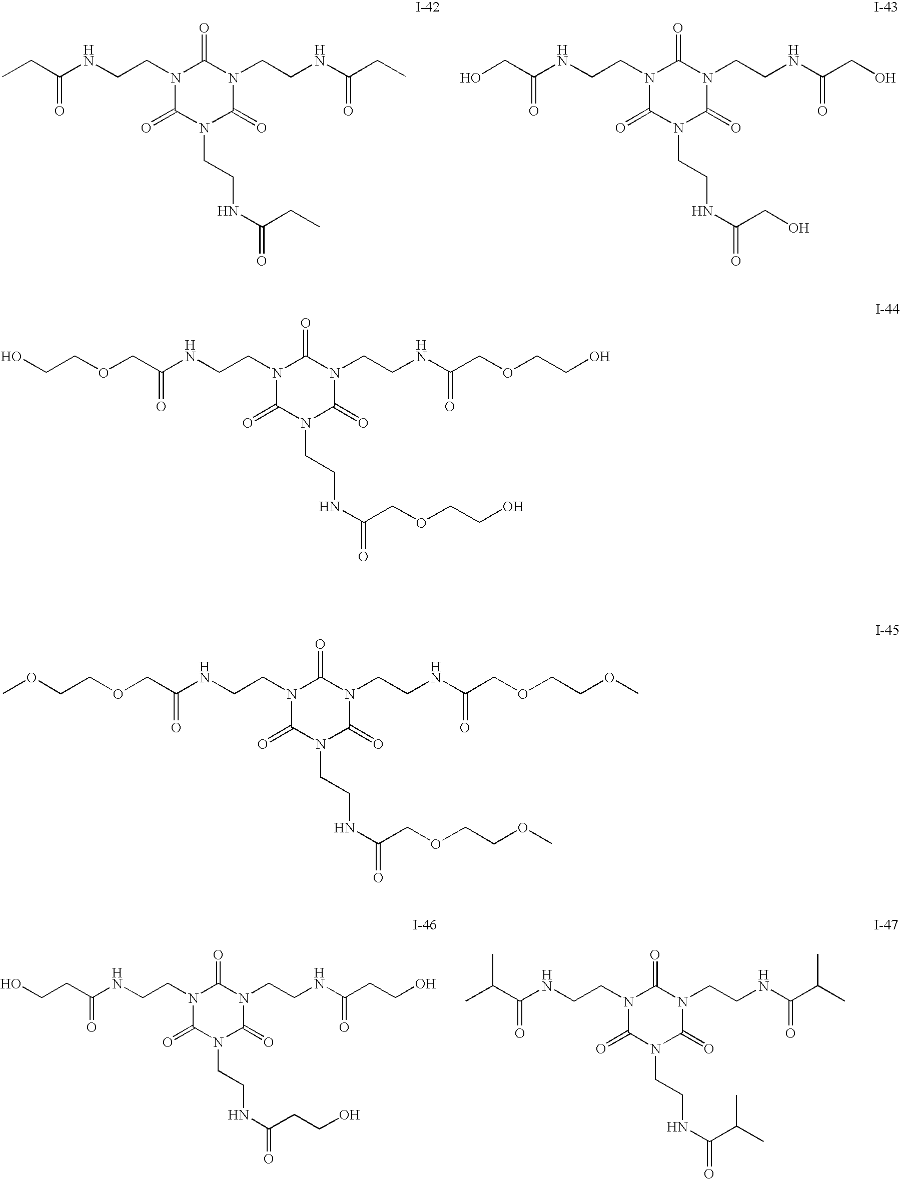

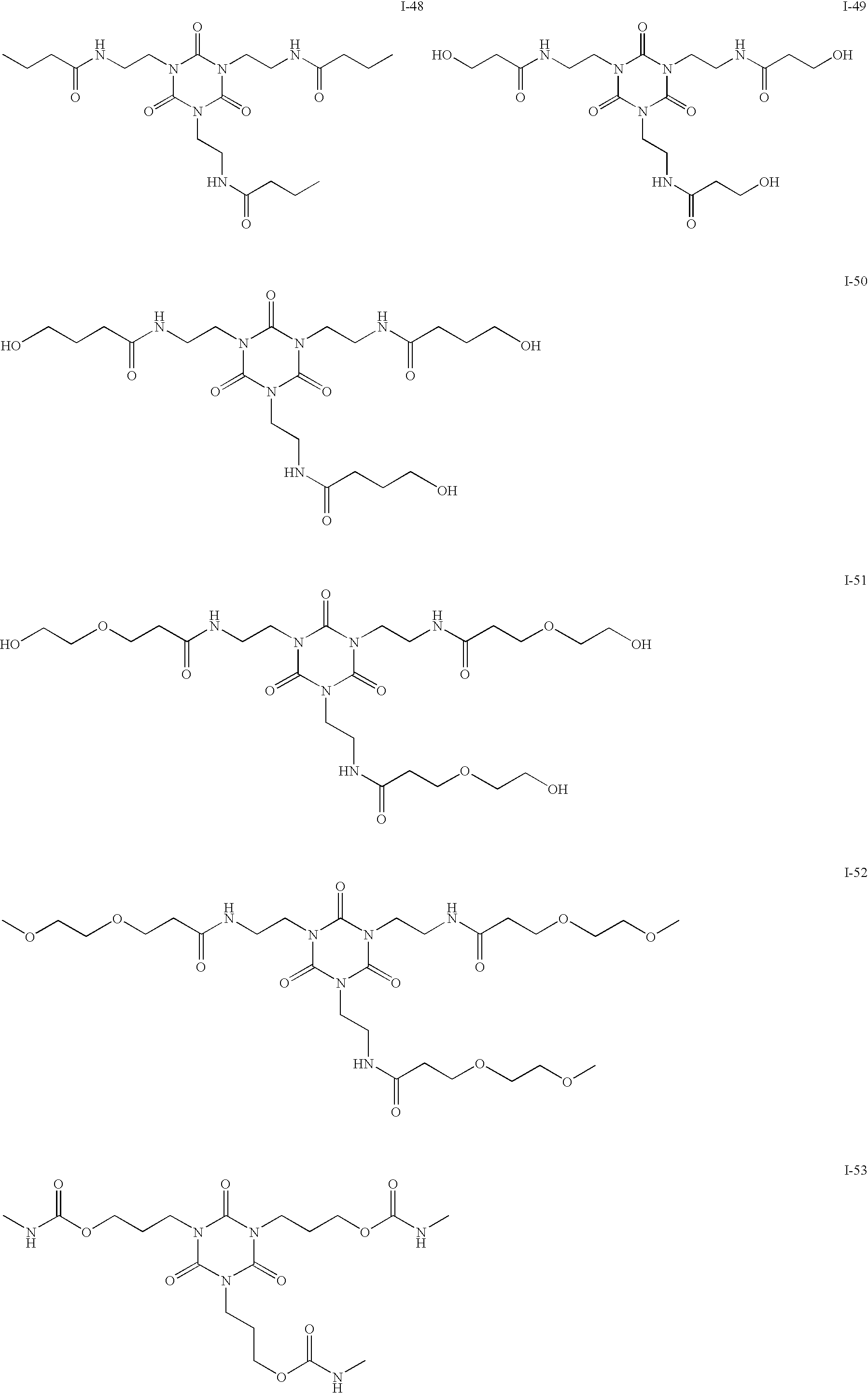

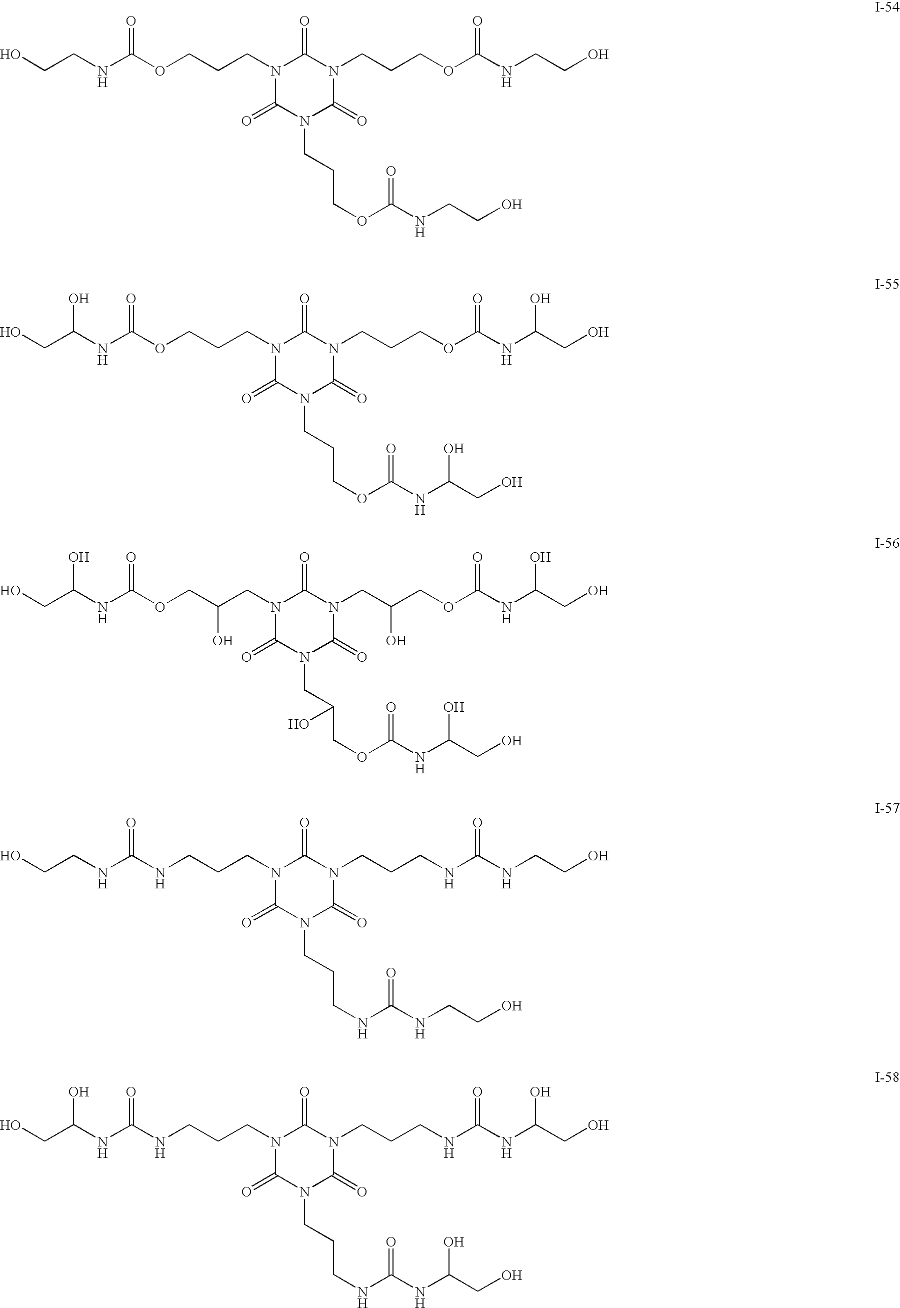

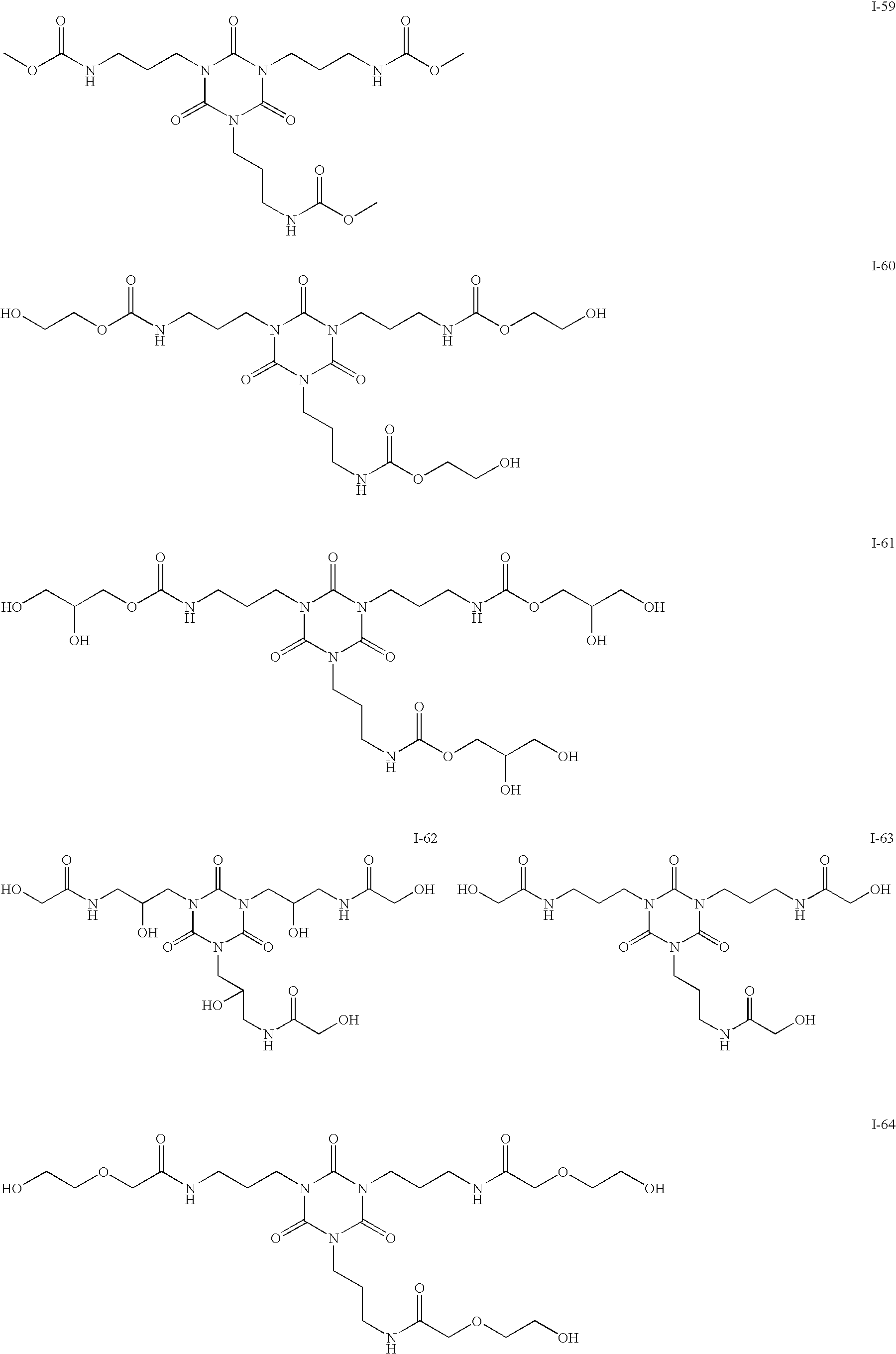

[Compound represented by formula (I) wherein R¹ to R³ each independently represents a hydrogen atom or a group selected from an alkyl group, an aryl group and a heterocyclic group, provided that at least one of R¹ to R³ represents the group having two or more hydroxy groups (hereinafter, also referred to as specific compound I-J)]

The specific compound I-J according to the invention is characterized in that at least one of R¹ to R³ is an alkyl group having two or more hydroxy groups, an aryl group having two or more hydroxy groups or a heterocyclic group having two or more hydroxy groups.

When the group represented by any one of R¹ to R³ represents an alkyl group having two or more hydroxy groups, the alkyl group preferably includes a straight-chain, branched or cyclic alkyl group having from 2 to 20 carbon atoms. Among them, a straight-chain alkyl group having from 2 to 12 carbon atoms, a branched alkyl group having from 3 to 12 carbon atoms and a cyclic alkyl group having from 5 to 10 carbon atoms are more preferable, and the straight-chain alkyl group having from 2 to 12 carbon atoms is particularly preferable.

Preferable specific examples of the alkyl group having two or more hydroxy groups include a 2,3-dihydroxypropyl group, a 2,3-dihydroxybutyl group, a 3,4-dihydroxybutyl group, a 2,3,4-trihydroxybutyl group, a 2,3-dihydroxycyclohexyl group, a 3,4-dihydroxycyclohexyl group and a 2,4-dihydroxycyclohexyl group.

When the group represented by any one of R¹ to R³ represents an aryl group having two or more hydroxy groups, the aryl group preferably includes a monocyclic or condensed cyclic aryl group having from 6 to 30 carbon atoms. Among them, for example, groups derived from a benzene ring, a condensed ring formed from 2 to 5 benzene rings and a condensed ring formed from a benzene ring and a 5-membered unsaturated ring are more preferable.

Preferable specific examples of the aryl group having two or more hydroxy groups include a 2,3-dihydroxyphenyl group, a 2,4-dihydroxyphenyl group, a 2,5-dihydroxyphenyl group, a 2,6-dihydroxyphenyl group, a 3,4-dihydroxyphenyl group, a 2,3,4-trihydroxyphenyl group, a 3,4,5-trihydroxyphenyl group, a 2,3-dihydroxynaphthyl group and a 2,4-dihydroxynaphthyl group. The aryl group having two or more hydroxy groups according to the invention includes an aryl group on which the hydroxy group is substituted through a divalent connecting group.

The divalent connecting group is preferably a group constituting individually or in combination from 0 to 60 carbon atoms, from 0 to 10 nitrogen atoms, from 0 to 50 oxygen atoms, from 0 to 100 hydrogen atoms and from 0 to 20 sulfur atoms.

Specific examples thereof include the divalent connecting groups shown below and divalent connecting groups constituting from appropriate combinations of the divalent connecting groups shown below. In the formulae below, R⁴ to R⁷ each independently represents a hydrogen atom or a substituent.

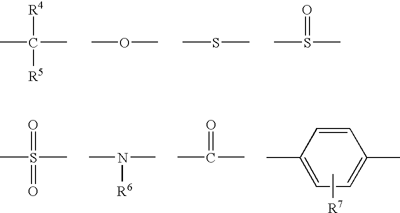

More preferable specific examples of the divalent connecting group include the divalent connecting groups represented by structural formulae shown below, but the invention should not be construed as being limited thereto.

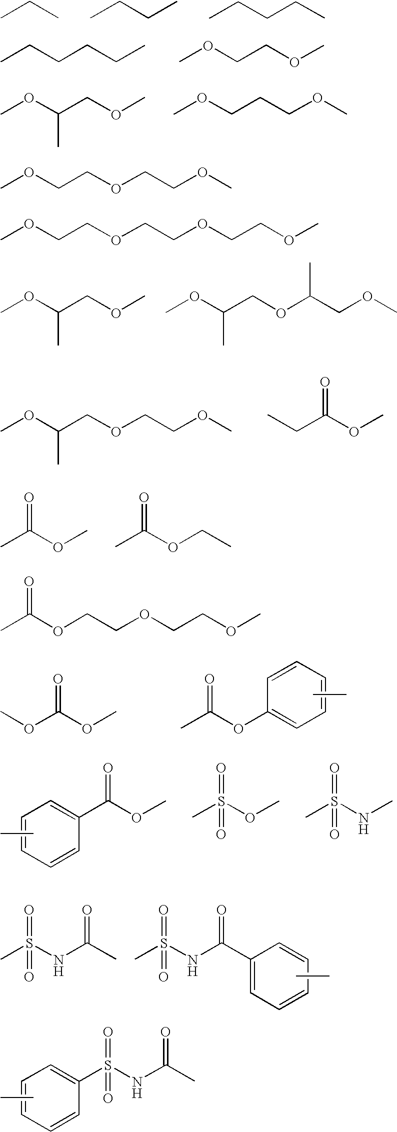

Specific examples of the aryl group on which the hydroxy group is substituted through a divalent connecting group include a 4-(N,N-di(hydroxyethyl)amino)phenyl group and a 3-hydroxy-4-(2-hydroxyethoxycarbonyl)phenyl group.

When the group represented by any one of R¹ to R³ represents a heterocyclic group having two or more hydroxy groups, the heterocyclic group preferably includes a heterocyclic group having from 1 to 30 carbon atoms. Among them, a 3-membered to 8-membered heterocyclic group is preferable, a 3-membered to 6-membered heterocyclic group containing a nitrogen atom, an oxygen atom or a sulfur atom is more preferable, and a 5-membered to 6-membered heterocyclic group containing a nitrogen atom, an oxygen atom or a sulfur atom are particularly preferable. The heterocyclic group may further have a condensed ring.

Preferable specific examples of the heterocyclic group having two or more hydroxy groups include a 2,6-dihydroxy-4-pyridinyl group, a 2,3-dihydroxy-4-pyridinyl group and a 2,3,6-trihydroxy-4-pyridinyl group. The heterocyclic group having two or more hydroxy groups according to the invention includes a heterocyclic group on which the hydroxy group is substituted through a divalent connecting group. Specific examples of the heterocyclic group on which the hydroxy group is substituted through a divalent connecting group include an N-(1-hydroxymethyl-2-hydroxyethyl)-4-piperidinyl group. The divalent connecting group is same as the divalent connecting group in the aryl group having two or more hydroxy groups described above.

In the specific compound I-J according to the invention, it is preferred that at least one of R¹ to R³ represents an alkyl group having two or more hydroxy groups, and it is particularly preferred that all of R¹ to R³ each represents an alkyl group having two or more hydroxy groups. The groups represented by R¹, R² and R³ may be different groups from each other or two or more groups may be the same groups. It is more preferred that all of the groups represented by R¹, R² and R³ are the same groups.

(Group Represented by any One of R¹ to R³ which has One or Less Hydroxy Group)

In formula (I), the group represented by any one of R¹ to R³ which has one or less hydroxy group is described in detail below.

When the group represented by any one of R¹ to R³ represents an alkyl group, the alkyl group preferably includes a straight-chain, branched or cyclic alkyl group having from 1 to 20 carbon atoms. Among them, a straight-chain alkyl group having from 1 to 12 carbon atoms, a branched alkyl group having from 3 to 12 carbon atoms and a cyclic alkyl group having from 5 to 10 carbon atoms are more preferable. Specific examples of the alkyl group include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eucosyl group, an isopropyl group, an isobutyl group, a sec-butyl group, a tert-butyl group, an isopentyl group, a neopentyl group, a 1-methylbutyl group, an isohexyl group, a 2-ethylhexyl group, a 2-methylhexyl group, a cyclohexyl group, a cyclopentyl group and a 2-norbornyl group.

In the specific compound I-J according to the invention, when the alkyl group represented by any on of R¹ to R³ has a substituent (that is, in case of a substituted alkyl group), as an alkylene moiety in the substituted alkyl group, a divalent organic residue resulting from elimination of any one of hydrogen atoms on the above-described alkyl group can be enumerated. The range of preferable number of carbon atoms included in the alkylene moiety is same as that described with respect to the alkyl group.

Examples of the substituent capable of being introduced into the alkyl group represented by any on of R¹ to R³ include a halogen atom (e.g., —F, —Br, —Cl or —I), a hydroxy group, an alkoxy group, an alkoxyalkoxy group, an alkenyloxy group, an aryloxy group, a mercapto group, an alkylthio group, an arylthio group, an alkyldithio group, an aryldithio group, an amino group, an N-alkylamino group, an N,N-dialkylamino group, an N-acylamino group, an N,N-diarylamino group, an N-alkyl-N-acylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-arylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′,N′-dialkylureido group, N′-arylureido group, an N′,N′-diarylureido group, an N′-alkyl-N′-arylureido group, an N-alkylureido group, N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, an arylsulfonyl group, a sulfo group (—SO₃H) and a conjugate base group thereof (hereinafter, referred to as a sulfonato group), an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group,

a phosphono group (—PO₃H₂) and a conjugate base group thereof (hereinafter, referred to as a phosphonato group), a dialkylphosphono group (—PO₃(alkyl)₂) wherein “alkyl” means an alkyl group, hereinafter the same, a diarylphosphono group (—PO₃(aryl)₂) wherein “aryl” means an aryl group, hereinafter the same, an alkylarylphosphono group (—PO₃(alkyl)(aryl)), a monoalkylphosphono group (—PO₃H(alkyl)) and a conjugate base group thereof (hereinafter, referred to as an alkylphosphonato group), a monoarylphosphono group (—PO₃H(aryl)) and a conjugate base group thereof (hereinafter, referred to as an arylphosphonato group), a phosphonoxy group (—OPO₃H₂) and a conjugate base group thereof (hereinafter, referred to as a phosphonatoxy group), a dialkylphosphonoxy group (—OPO₃(alkyl)₂), a diarylphosphonoxy group (—OPO₃(alkyl)₂), an alkylarylphosphonoxy group (—OPO₃(alkyl)(aryl)), a monoalkylphosphonoxy group (—OPO₃H(alkyl)) and a conjugate base group thereof (hereinafter, referred to as an alkylphosphonatoxy group), a monoarylphosphonoxy group (—OPO₃H(aryl)) and a conjugate base group thereof (hereinafter, referred to as an arylphosphonatoxy group), a cyano group, a nitro group, an aryl group, an alkenyl group, an alkynyl group, a heterocyclic group, a silyl group and a trialkylsilyl group.

Specific examples of the alkyl moiety in the substituent capable of being introduced into the alkyl group represented by any on of R¹ to R³ are same as those described in the case where any on of R¹ to R³ represents the substituted alkyl group. Also, the range of preferable number of carbon atoms is same as that of the alkyl group described above.

Also, specific examples of the aryl moiety in the substituent capable of being introduced into the alkyl group represented by any on of R¹ to R³ include a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, an acetylaminophenyl group, a carboxyphenyl group, a methoxycarbonylphenyl group, an ethoxycarbonylphenyl group, a phenoxycarbonylphenyl group, an N-phenylcarbamoylphenyl group, a cyanophenyl group, a sulfophenyl group, a sufonatophenyl group, a phosphonophenyl group and a phosphonatophenyl group.

Preferable specific examples of substituted alkyl group include a 2-hydroxyethyl group, a 3-hydroxypropyl group, a 2-hydroxypropyl group, a 4-hydroxybutyl group, a hydroxyethoxyethyl group, a hydroxyethoxyethoxyethyl group, a 5-hydroxypentyl group, a 6-hydroxyhexyl group, a 2-hydroxycyclohexyl group, a 3-hydroxycyclohexyl group, a 4-hydroxycyclohexyl group, a 2-chloroethyl group, a trifluoromethyl group, a methoxymethyl group, a methoxycarbonylmethyl group, an isopropoxymethyl group, a butoxymethyl group, a sec-butoxybutyl group, a methoxyethoxyethyl group, an ethoxyethoxyethyl group, an allyloxymethyl group, a phenoxymethyl group, a glycidyl group, an acetyloxymethyl group, a methylthiomethyl group, a tolylthiomethyl group, a pyridylmethyl group, a tetramethylpiperidinylmethyl group, an N-acetyltetramethylpiperidinylmethyl group, a trimethylsilylmethyl group, a methoxyethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-oxoethyl group, a 2-oxopropyl group, a carboxypropyl group, a methoxycarbonylethyl group, an allyloxycarbonylbutyl group, a chlorophenoxycarbonylmethyl group, a carbamoylmethyl group, an N-methylcarbamoylethyl group, an N,N-dipropylcarbamoylmethyl group, an N-(methoxyphenyl)carbamoylethyl group, an N-methyl-N-(sulfophenyl)carbamoylmethyl, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl, a phosphonoxypropyl group, a phosphonatoxybutyl group, a benzyl group, a phenethyl group, an α-methylbenzyl group, a 1-methyl-1-phenylethyl group and a p-methylbenzyl group.

When the group represented by any one of R¹ to R³ represents an aryl group, the aryl group preferably includes a monocyclic or condensed cyclic aryl group having from 6 to 30 carbon atoms. Among them, for example, groups derived from a benzene ring, a condensed ring formed from 2 to 5 benzene rings and a condensed ring formed from a benzene ring and a 5-membered unsaturated ring are more preferable.

Specifically, groups derived from a benzene ring, a condensed ring formed from 2 to 5 benzene rings and a condensed ring formed from a benzene ring and a 5-membered unsaturated ring are exemplified. Specific examples of the aryl group include a phenyl group, a naphthyl group, an anthryl group, a phenanthryl group, an indenyl group, an acenaphthenyl group and a fluorenyl group. Among them, a phenyl group and a naphthyl group are preferable.

Also, the aryl group represented by any one of R¹ to R³ may have a substituent on the carbon atom forming the ring. The substituent includes a monovalent substituent constituting from a non-metallic atom. Preferable examples of the substituent capable of being introduced include the above-described alkyl group and substituted alkyl group and those described for the substituents of the substituted alkyl group.

When the group represented by any one of R¹ to R³ represents a heterocyclic group, the heterocyclic group preferably includes a heterocyclic group having from 1 to 30 carbon atoms. Among them, a 3-membered to 8-membered heterocyclic group is preferable, a 3-membered to 6-membered heterocyclic group containing a nitrogen atom, an oxygen atom or a sulfur atom is more preferable, and a 5-membered to 6-membered heterocyclic group containing a nitrogen atom, an oxygen atom or a sulfur atom are particularly preferable. The heterocyclic group may further have a condensed ring.

Specific examples of the heterocyclic group include a pyrrole ring group, a furan ring group, a thiophene ring group, a benzopyrrole ring group, a benzofuran ring group, a benzothiophene ring group, a pyrazole ring group, an isoxazole ring group, an isothiazole ring group, an indazole ring, a benzisoxazole ring group, a benzisothiazole ring group, an imidazole ring group, an oxazole ring group, a thiazole ring group, a benzimidazole ring group, a benzoxazole ring group, a benzothiazole ring group, a pyridine ring group, a quinoline ring group, an isoquinoline ring group, a pyridazine ring group, a pyrimidine ring group, a pyrazine ring group, a phthalazine ring group, a quinazoline ring group, a quinoxaline ring group, an achicline ring group, a phenanthrydine ring group, a carbazole ring group, a purine ring group, a pyrane ring group, a piperidine ring group, a piperazine ring group, a morpholine ring group, an indole ring group, an indolizine ring group, a chromene ring group, a cinnnoline ring group, an acridine ring group, a phenothiazine ring group, a tetrazole ring group and a triazine ring group.

Also, the heterocyclic group represented by any on of R¹ to R³ may have a substituent on the carbon atom forming the ring. The substituent includes a monovalent substituent constituting from a non-metallic atom. Preferable examples of the substituent capable of being introduced include the above-described alkyl group and substituted alkyl group and those described for the substituents of the substituted alkyl group.

Specific examples of the specific compound I-J according to the invention are set forth below, but the invention should not be construed as being limited thereto.

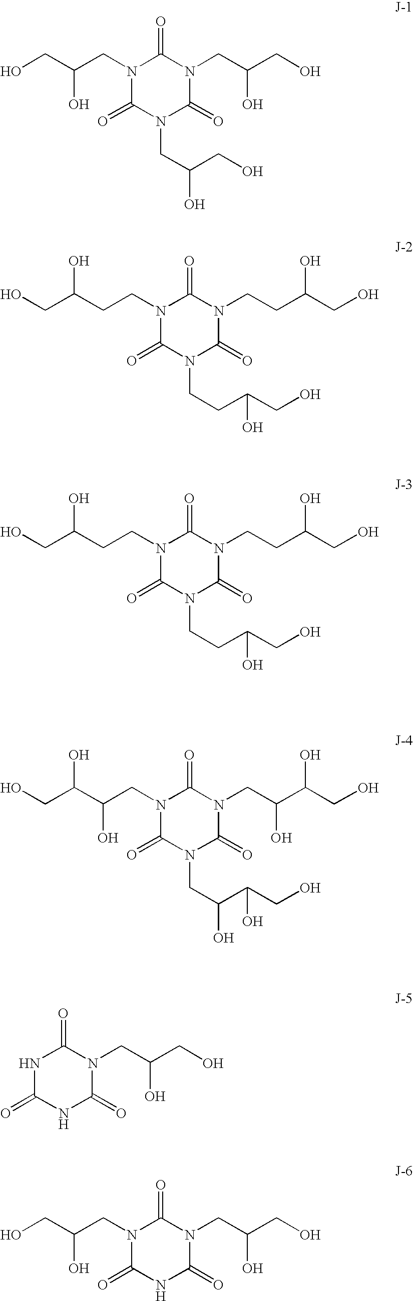

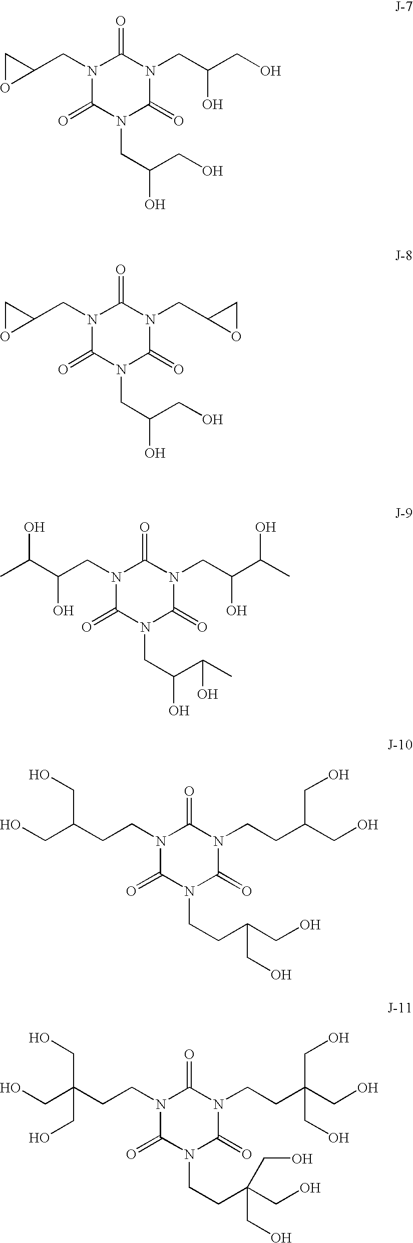

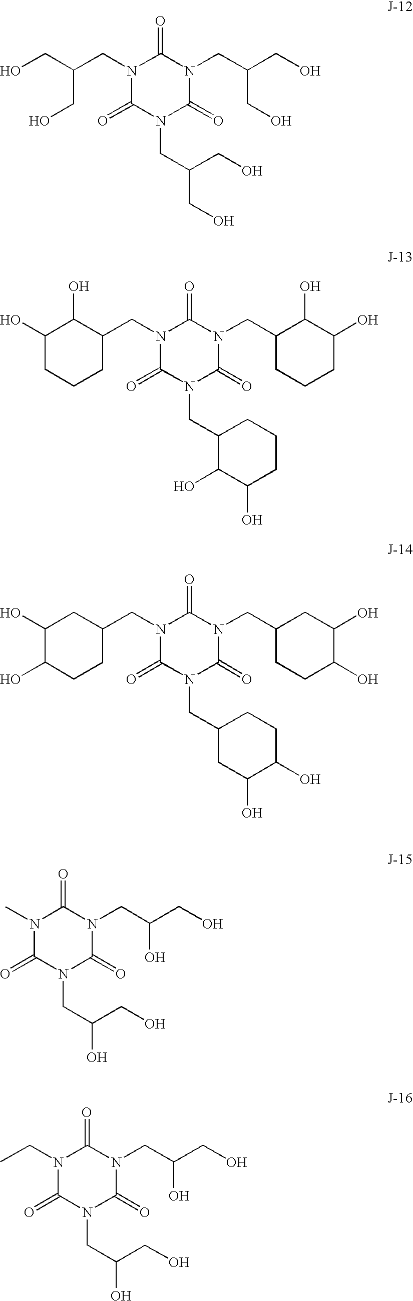

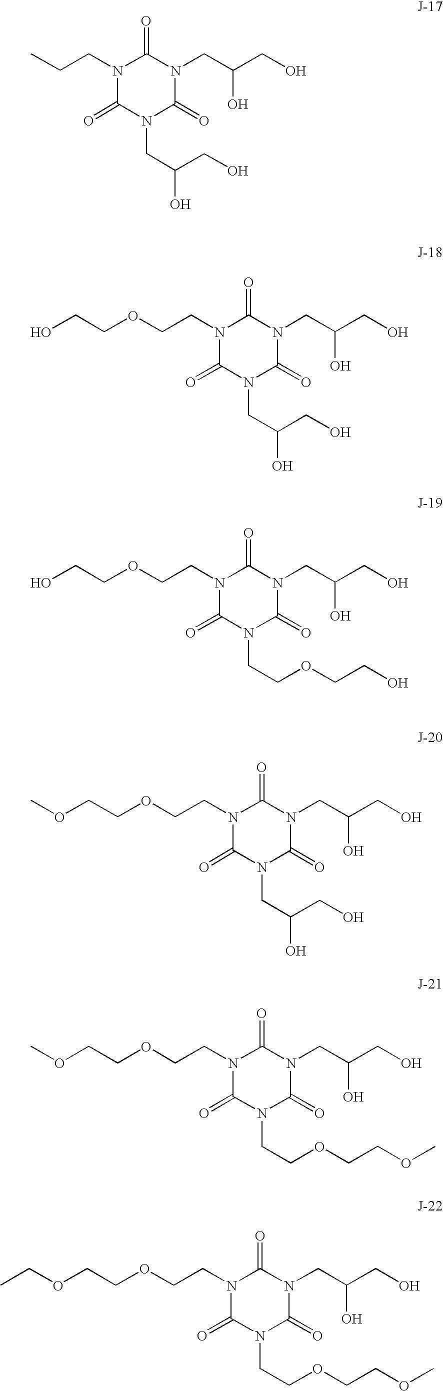

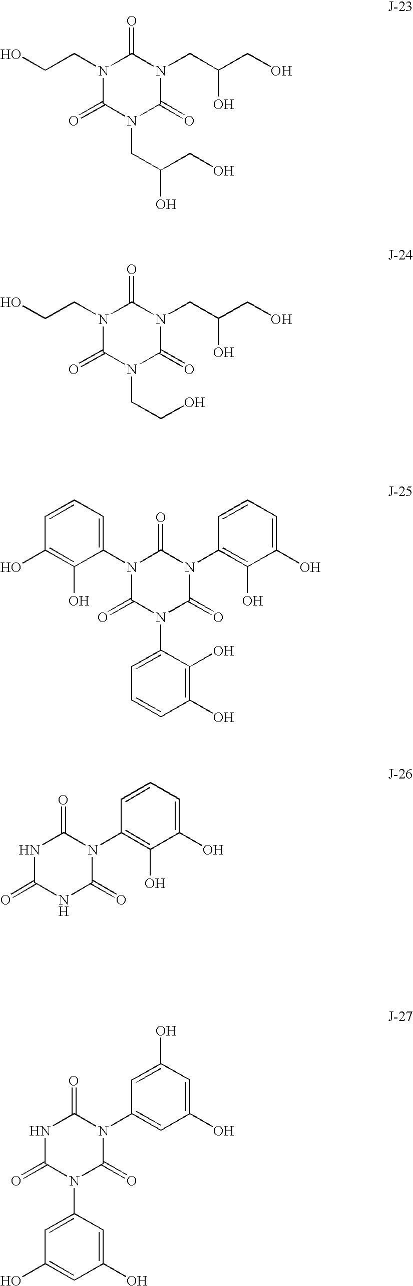

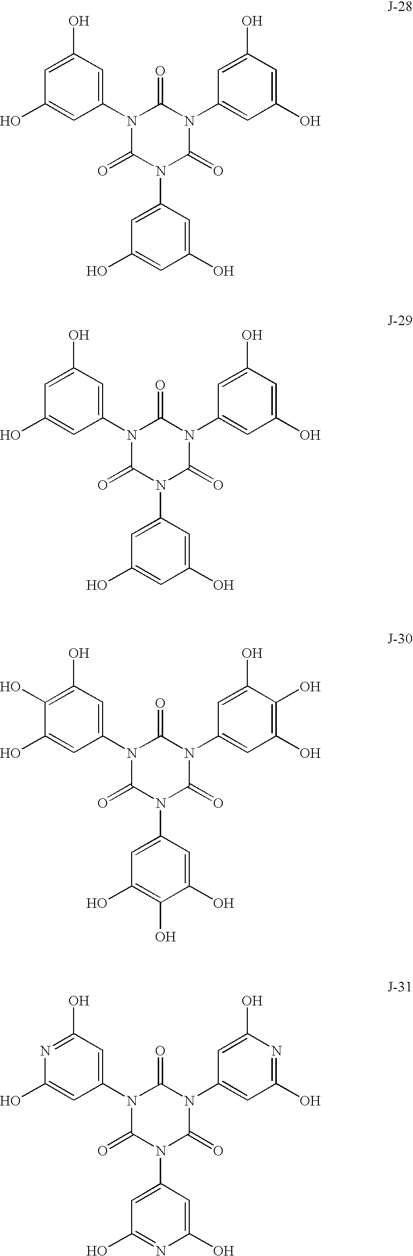

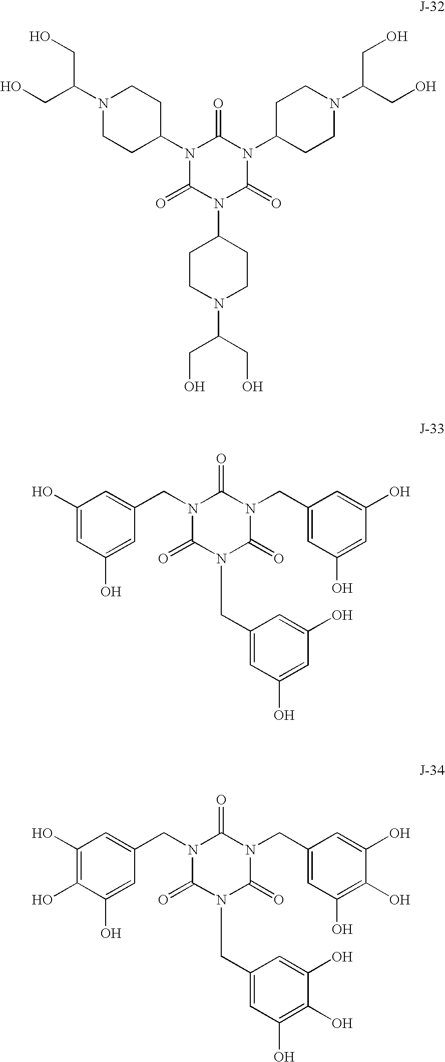

The content of the specific compound according to the invention is preferably from 0.01 to 50% by weight, more preferably from 0.1 to 35% by weight, based on the solid content of the image-recording layer in view of the balance between on-press development property and printing durability. In the range described above, good on-press development property and good printing durability are obtained.

The specific compounds according to the invention may be used individually or in combination of two or more thereof.

### [(A) Infrared Absorbing Agent]

The image-recording layer of the lithographic printing plate precursor according to the invention contains (A) an infrared absorbing agent. By the incorporation of infrared absorbing agent (A) into the image-recording layer, the image formation using as a light source, a laser emitting an infrared ray of 760 to 1,200 nm or the like becomes possible.

The infrared absorbing agent has a function of converting the infrared ray absorbed to heat and a function of being excited by the infrared ray to perform electron transfer and/or energy transfer to a polymerization initiator (radical generator) described hereinafter. The infrared absorbing agent for use in the invention is preferably a dye or pigment having an absorption maximum in a wavelength range of 760 to 1,200 nm.

As the dye, commercially available dyes and known dyes described in literatures, for example, Senryo Binran (Dye Handbook) compiled by The Society of Synthetic Organic Chemistry, Japan (1970) can be used. Specifically, the dyes includes azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal thiolate complexes.

Examples of preferable dye include cyanine dyes described, for example, in JP-A-58-125246, JP-A-59-84356 and JP-A-60-78787, methine dyes described, for example, in JP-A-58-173696, JP-A-58-181690 and JP-A-58-194595, naphthoquinone dyes described, for example, in JP-A-58-112793, JP-A-58-224793, JP-A-59-48187, JP-A-59-73996, JP-A-60-52940 and JP-A-60-63744, squarylium dyes described, for example, in JP-A-58-112792, and cyanine dyes described, for example, in British Patent 434,875.

Also, near infrared absorbing sensitizers described in U.S. Pat. No. 5,156,938 are preferably used. Further, substituted arylbenzo(thio)pyrylium salts described in U.S. Pat. No. 3,881,924, trimethinethiapyrylium salts described in JP-A-57-142645 (corresponding to U.S. Pat. No. 4,327,169), pyrylium compounds described in JP-A-58-181051, JP-A-58-220143, JP-A-59-41363, JP-A-59-84248, JP-A-59-84249, JP-A-59-146063 and JP-A-59-146061, cyanine dyes described in JP-A-59-216146, pentamethinethiopyrylium salts described in U.S. Pat. No. 4,283,475, and pyrylium compounds described in JP-B-5-13514 (the term “JP-B” as used herein means an “examined Japanese patent publication”) and JP-B-5-19702 are also preferably used. Other preferable examples of the dye include near infrared absorbing dyes represented by formulae (I) and (II) in U.S. Pat. No. 4,756,993.

Other preferable examples of the infrared absorbing dye according to the invention include specific indolenine cyanine dyes described in JP-A-2002-278057 as illustrated below.

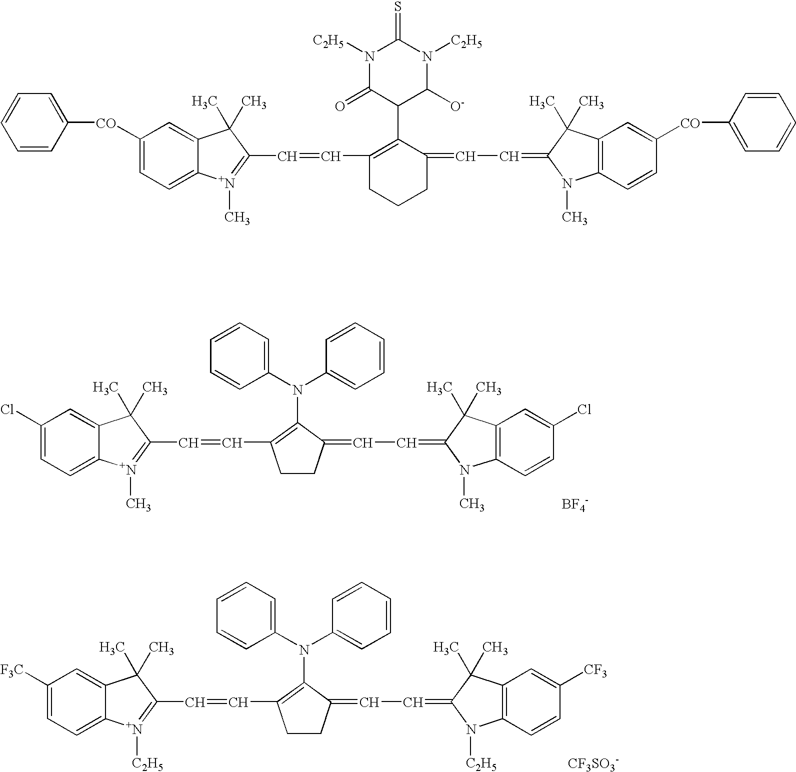

Of the dyes, cyanine dyes, squarylium dyes, pyrylium dyes, nickel thiolate complexes and indolenine cyanine dyes are preferred. Further, cyanine dyes and indolenine cyanine dyes are more preferred. As a particularly preferable example of the dye, a cyanine dye represented by formula (i) shown below is exemplified.

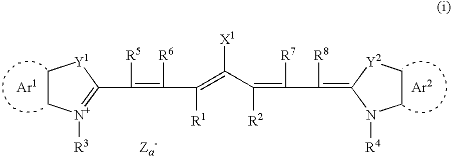

In formula (i), X¹ represents a hydrogen atom, a halogen atom, —NPh₂, X²-L¹ or a group represented by the structural formula shown below. X² represents an oxygen atom, a nitrogen atom or a sulfur atom, L¹ represents a hydrocarbon group having from 1 to 12 carbon atoms, an aromatic ring containing a hetero atom or a hydrocarbon group having from 1 to 12 carbon atoms and containing a hetero atom. The hetero atom used herein indicates a nitrogen atom, a sulfur atom, an oxygen atom, a halogen atom and a selenium atom. R^{a} represents a substituent selected from a hydrogen atom, an alkyl group, an aryl group, a substituted or unsubstituted amino group and a halogen atom, and Xa⁻ has the same meaning as Za⁻ defined hereinafter.

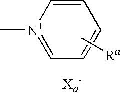

R¹ and R² each independently represents a hydrocarbon group having from 1 to 12 carbon atoms. In view of the preservation stability of a coating solution for image-recording layer, it is preferred that R¹ and R² each represents a hydrocarbon group having two or more carbon atoms, and it is particularly preferred that R¹ and R² are combined with each other to form a 5-membered or 6-membered ring.

Ar¹ and Ar², which may be the same or different, each represents an aromatic hydrocarbon group which may have a substituent. Preferable examples of the aromatic hydrocarbon group include a benzene ring and a naphthalene ring. Also, preferable examples of the substituent include a hydrocarbon group having 12 or less carbon atoms, a halogen atom and an alkoxy group having 12 or less carbon atoms, and a hydrocarbon group having 12 or less carbon atoms and an alkoxy group having 12 or less carbon atoms are most preferable. Y¹ and Y², which may be the same or different, each represents a sulfur atom or a dialkylmethylene group having 12 or less carbon atoms. R³ and R⁴, which may be the same or different, each represents a hydrocarbon group having 20 or less carbon atoms, which may have a substituent. Preferable examples of the substituent include an alkoxy group having 12 or less carbon atoms, a carboxyl group and a sulfo group, and an alkoxy group having 12 or less carbon atoms is most preferable. R⁵, R⁶, R⁷ and R⁸, which may be the same or different, each represents a hydrogen atom or a hydrocarbon group having 12 or less carbon atoms. In view of the availability of raw materials, a hydrogen atom is preferred. Za⁻ represents a counter anion. However, Za⁻ is not necessary when the cyanine dye represented by formula (i) has an anionic substituent in the structure thereof and neutralization of charge is not needed. In view of the preservation stability of a coating solution for image-recording layer, preferable examples of the counter ion for Za⁻ include a halide ion, a perchlorate ion, a tetrafluoroborate ion, a hexafluorophosphate ion and a sulfonate ion, and particularly preferable examples thereof include a perchlorate ion, a tetrafluoroborate ion, a hexafluorophosphate ion and an arylsulfonate ion.

Specific examples of the cyanine dye represented by formula (i), which can be preferably used in the invention, include those described in paragraph Nos. [0017] to [0019] of JP-A-2001-133969.

Further, other particularly preferable examples include specific indolenine cyanine dyes described in JP-A-2002-278057 described above.

Examples of the pigment for use in the invention include commercially available pigments and pigments described in Colour Index (C.I.), Saishin Ganryo Binran (Handbook of the Newest Pigments) compiled by Pigment Technology Society of Japan (1977), Saishin Ganryo Oyou Gijutsu (Newest Application on Technologies for Pigments), CMC Publishing Co., Ltd. (1986) and Insatsu Ink Gijutsu (Printing Ink Technology), CMC Publishing Co., Ltd. (1984).

Examples of the pigment include black pigments, yellow pigments, orange pigments, brown pigments, red pigments, purple pigments, blue pigments, green pigments, fluorescent pigments, metal powder pigments and polymer-bonded dyes. Specific examples of usable pigment include insoluble azo pigments, azo lake pigments, condensed azo pigments, chelated azo pigments, phthalocyanine pigments, anthraquinone pigments, perylene and perynone pigments, thioindigo pigments, quinacridone pigments, dioxazine pigments, isoindolinone pigments, quinophthalone pigments, dying lake pigments, azine pigments, nitroso pigments, nitro pigments, natural pigments, fluorescent pigments, inorganic pigments and carbon black. Of the pigments, carbon black is preferred.

The pigment may be used without undergoing surface treatment or may be used after the surface treatment. For the surface treatment, a method of coating a resin or wax on the surface, a method of attaching a surfactant and a method of bonding a reactive substance (for example, a silane coupling agent, an epoxy compound or polyisocyanate) to the pigment surface. The surface treatment methods are described in Kinzoku Sekken no Seishitsu to Oyo (Properties and Applications of Metal Soap), Saiwai Shobo, Insatsu Ink Gijutsu (Printing Ink Technology), CMC Publishing Co., Ltd. (1984), and Saishin Ganryo Oyo Gijutsu (Newest Application on Technologies for Pigments), CMC Publishing Co., Ltd. (1986).

The pigment has a particle size of preferably from 0.01 to 10 μm, more preferably from 0.05 to 1 μm, particularly preferably from 0.1 to 1 μm. In the range described above, good stability of the pigment dispersion in the coating solution for image-recording layer and good uniformity of the image-recording layer can be obtained.

For dispersing the pigment, a known dispersion technique for use in the production of ink or toner may be used. Examples of the dispersing machine include an ultrasonic dispersing machine, a sand mill, an attritor, a pearl mill, a super-mill, a ball mill, an impeller, a disperser, a KD mill, a colloid mill, a dynatron, a three roll mill and a pressure kneader. The dispersing machines are described in detail in Saishin Ganryo Oyo Gijutsu (Newest Application on Technologies for Pigments), CMC Publishing Co., Ltd. (1986).

The infrared absorbing agent may be added together with other components to the same image-recording layer or may be added to a different image-recording layer separately provided. With respect to the amount of the infrared absorbing agent added, in the case of preparing a lithographic printing plate precursor, the amount is so controlled that absorbance of the image-recording layer at the maximum absorption wavelength in the wavelength region of 760 to 1,200 nm measured by reflection measurement is in a range of 0.3 to 1.2, preferably in a range of 0.4 to 1.1. In the range described above, the polymerization reaction proceeds uniformly in the thickness direction of the image-recording layer and good film strength of the image area and good adhesion property of the image area to the support are achieved.

The absorbance of the image-recording layer can be controlled depending on the amount of the infrared absorbing agent added to the image-recording layer and the thickness of the image-recording layer. The measurement of the absorbance can be carried out in a conventional manner. The method for measurement includes, for example, a method of forming an image-recording layer having a thickness determined appropriately in the range necessary for a coating amount after drying of the lithographic printing plate precursor on a reflective support, for example, an aluminum plate, and measuring reflection density of the image-recording layer by an optical densitometer or a spectrophotometer according to a reflection method using an integrating sphere.

Speaking specifically, the content of the infrared absorbing agent in the image-recording layer according to the invention is preferably from 0.2 to 10% by weight, more preferably from 0.5 to 5% by weight, based on the total solid content of the image-recording layer.

### [(B) Polymerization Initiator]

The polymerization initiator (B) for use in the invention is a compound that generates a radical with light energy, heat energy or both energies to initiate or accelerate polymerization of polymerizable compound (C) and a binder polymer having a polymerizable group. The polymerization initiator for use in the invention includes, for example, known thermal polymerization initiators, compounds containing a bond having small bond dissociation energy and photopolymerization initiators.

The polymerization initiators in the invention include, for example, organic halides, carbonyl compounds, organic peroxides, azo compounds, azido compounds, metallocene compounds, hexaarylbiimicinzole compounds, organic borate compounds, disulfone compounds, oxime ester compounds and onium salt compounds.

The organic halides specifically include, for example, compounds described in Wakabayashi et al., Bull. Chem. Soc. Japan, 42, 2924 (1969), U.S. Pat. No. 3,905,815, JP-B-46-4605, JP-A-48-35281, JP-A-55-32070, JP-A-60-239736, JP-A-61-169835, JP-A-61-169837, JP-A-62-58241, JP-A-62-212401, JP-A-63-70243, JP-A-63-298339 and M. P. Hutt, Journal of Heterocyclic Chemistry, 1, No. 3 (1970). Particularly, oxazole compounds and s-triazine compounds each substituted with a trihalomethyl group are preferably exemplified.

More preferably, s-triazine derivatives and oxadiazole derivatives each of which has at least one of mono-, di- and tri-halogen substituted methyl groups connected are exemplified. Specific examples thereof include 2,4,6-tris(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloroethyl)-4,6-bis(trichloromethyl)-s-tiazine, 2-phenyl-4,6-bis(trichloromethyl)-s-triazine, 2-(p-methoxyphenyl)-4,6-bis(trichloromethyl)-s-tiazine, 2-(3,4-epoxyphenyl)-4,6-bis(trichloromethyl)-s-tiazine, 2-(p-chlorophenyl)-4,6-bis(trichloromethyl)-s-tiazine, 2-(p-bromophenyl)-4,6-bis(trichloromethyl)-s-triazine, 2-(p-fluorophenyl)-4,6-bis(trichloromethyl)-s-triazine, 2-(p-trifluoromethylphenyl)-4,6-bis(trichloromethyl)-s-triazine, 2-(2,6-dichlorophenyl)-4,6-bis(trichloromethyl)-s-triazine, 2-(2,6-difluorophenyl)-4,6-bis(trichloromethyl)-s-triazine, 2-(2,6-dibromophenyl)-4,6-bis(trichloromethyl)-s-triazine, 2-(4-biphenylyl)-4,6-bis(trichloromethyl)-s-tiazine, 2-(4′-chloro-4-biphenylyl)-4,6-bis(trichloromethyl)-s-triazine, 2-(p-cyanophenyl)-4,6-bis(trichloromethyl)-s-triazine, 2-(p-acetylphenyl)-4,6-bis(trichloromethyl)-s-triazine, 2-(p-ethoxycarbonylphenyl)-4,6-bis(trichloromethyl)-s-triazine, 2-(p-phenoxycarbonylphenyl)-4,6-bis(trichloromethyl)-s-triazine, 2-(p-methylsulfonylphenyl)-4,6-bis(trichloromethyl)-s-triazine, 2-(p-dimethylsulfoniumphenyl)-4,6-bis(trichloromethyl)-s-triazine tetrafluoroborate, 2-(2,4-difluorophenyl)-4,6-bis(trichloromethyl)-s-triazine, 2-(p-diethoxyphosphorylphenyl)-4,6-bis(trichloromethyl)-s-triazine, 2-[4-(4-hydroxyphenylcarbonylamino)phenyl]-4,6-bis(trichloromethyl)-s-triazine, 2-[4-(p-methoxyphenyl)-1,3-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-isopropyloxystyryl)-4,6-bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, 2-methoxy-4,6-bis(tribromomethyl)-s-triazine, 2-(o-methoxystyryl)-5-trichloromethyl-1,3,4-oxadiazole, 2-(3,4-epoxystyryl)-5-trichloromethyl-1,3,4-oxadiazole, 2-[1-phenyl-2-(4-methoxyphenyl)vinyl]-5-trichloromethyl-1,3,4-oxadiazole, 2-(p-hydroxystyryl)-5-trichloromethyl-1,3,4-oxadiazole, 2-(3,4-dihydroxystyryl)-5-trichloromethyl-1,3,4-oxadiazole and 2-(p-tert-butoxystyryl)-5-trichloromethyl-1,3,4-oxadiazole.

The carbonyl compounds include, for example, benzophenone derivatives, e.g., benzophenone, Michler's ketone, 2-methylbenzophenone, 3-methylbenzophenone, 4-methylbenzophenone, 2-chlorobenzophenone, 4-bromobenzophenone or 2-carboxybenzophenone, acetophenone derivatives, e.g., 2,2-dimethoxy-2-phenylacetophenone, 2,2-diethoxyacetophenone, 1-hydroxycyclohexylphenylketone, α-hydroxy-2-methylphenylpropanone, 1-hydroxy-1-methylethyl-(p-isopropylphenyl)ketone, 1-hydroxy-1-(p-dodecylphenyl)ketone, 2-methyl-(4′-(methylthio)phenyl)-2-morpholino-1-propanone or 1,1,1,-trichloromethyl-(p-butylphenyl)ketone, thioxantone derivatives, e.g.; thioxantone, 2-ethylthioxantone, 2-isopropylthioxantone, 2-chlorothioxantone, 2,4-dimethylthioxantone, 2,4-dietylthioxantone or 2,4-diisopropylthioxantone, and benzoic acid ester derivatives, e.g., ethyl p-dimethylaminobenzoate or ethyl p-diethylaminobenzoate.

The azo compounds include, for example, azo compounds described in JP-A-8-108621.

The organic peroxides include, for example, trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butylhydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic peroxide, benzoyl peroxide, 2,4-dichlorobenzoyl peroxide, diisopropylperoxy dicarbonate, di-2-ethylhexylperoxy dicarbonate, di-2-ethoxyethylperoxy dicarbonate, dimethoxyisopropylperoxy dicarbonate, di(3-methyl-3-methoxybutyl)peroxy dicarbonate, tert-butylperoxy acetate, tert-butylperoxy pivalate, tert-butylperoxy neodecanoate, tert-butylperoxy octanoate, tert-butylperoxy laurate, tersyl carbonate, 3,3′,4,4′-tetra(tert-butylperoxycarbonyl)benzophenone, 3,3′,4,4′-tetra(tert-hexylperoxycarbonyl)benzophenone, 3,3′,4,4′-tetra(p-isopropylcumylperoxycarbonyl)benzophenone, carbonyl di(tert-butylperoxydihydrogen diphthalate) and carbonyl di(tert-hexylperoxydihydrogen diphthalate).

The metallocene compounds include, for example, various titanocene compounds described in JP-A-59-152396, JP-A-61-151197, JP-A-63-41484, JP-A-2-249, JP-A-2-4705 and JP-A-5-83588, for example, dicyclopentadienyl-Ti-bisphenyl, dicyclopentadienyl-Ti-bis-2,6-difluorophen-1-yl, dicyclopentadienyl-Ti-bis-2,4-difluorophen-1-yl, dicyclopentadienyl-Ti-bis-2,4,6-trifluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-trifluorophen-1-yl, dimethylcyclopentadienyl-Ti-bis-2,3,5,6-tetrafluorophen-1-yl, dimethylcyclopentadienyl-Ti-bis-2,3,4,5,6-pentafluorophen-1-yl or dicyclopentadienyl-Ti-bis-2,6-difluoro-3-(pyrol-1-yl)phen-1-yl, and iron-arene complexes described in JP-A-1-304453 and JP-A-1-152109.

The azido compounds include, for example, 2,6-bis(4-azidobenzylidene)-4-methylcyclohexanone.

The hexaarylbiimidazole compounds include, for example, various compounds described in JP-B-6-29285 and U.S. Pat. Nos. 3,479,185, 4,311,783 and 4,622,286, specifically, for example, 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetrakis(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole or 2,2′-bis(o-trifluoromethylphenyl)-4,4′,5,5-tetraphenylbiimidazole.

The organic borate compounds include, for example, organic borates described in JP-A-62-143044, JP-A-62-150242, JP-A-9-188685, JP-A-9-188686, JP-A-9-188710, JP-A-2000-131837, JP-A-2002-107916, Japanese Patent 2,764,769, JP-A-2002-116539 and Martin Kunz, Rad Tech '98, Proceeding, Apr. 19-22 (1998), Chicago, organic boron sulfonium complexes or organic boron oxosulfonium complexes described in JP-A-6-157623, JP-A-6-175564 and JP-A-6-175561, organic boron iodonium complexes described in JP-A-6-175554 and JP-A-6-175553, organic boron phosphonium complexes described in JP-A-9-188710, and organic boron transition metal coordination complexes described in JP-A-6-348011, JP-A-7-128785, JP-A-7-140589, JP-A-7-306527 and JP-A-7-292014.

The disulfone compounds include, for example, compounds described in JP-A-61-166544 and JP-A-2002-328465.

The oxime ester compounds include, for example, compounds described in J. C. S. Perkin II, 1653-1660 (1979), J. C. S. Perkin II, 156-162 (1979), Journal of Photopolymer Science and Technology, 202-232 (1995) and JP-A-2000-66385, and compounds described in JP-A-2000-80068. Specific examples thereof include compounds represented by the following structural formulae:

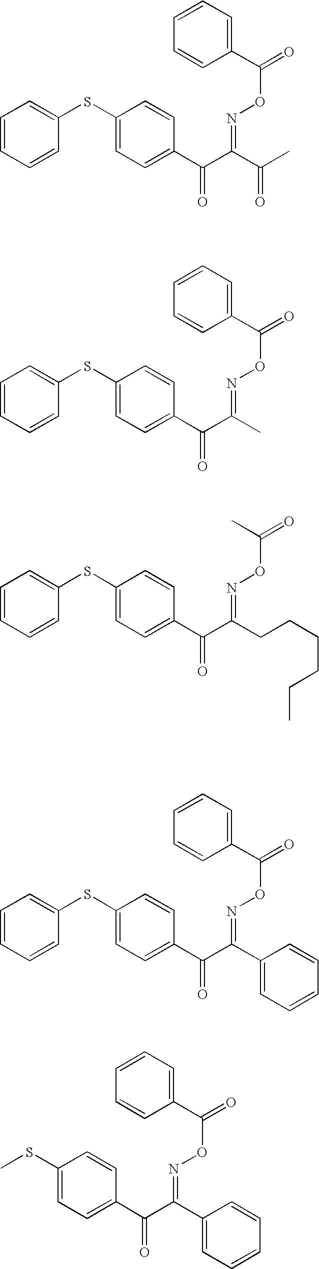

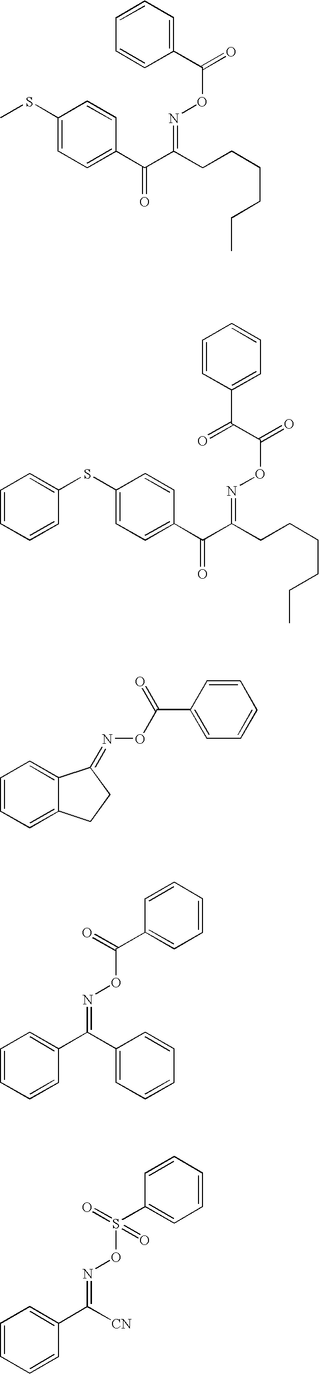

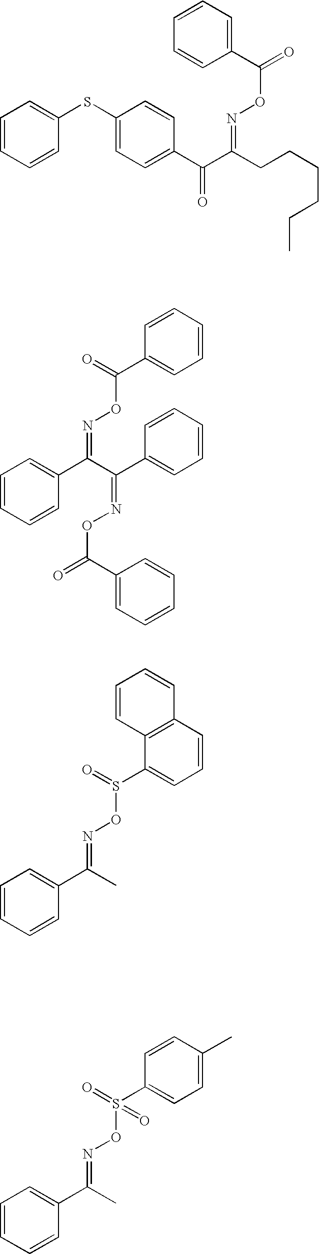

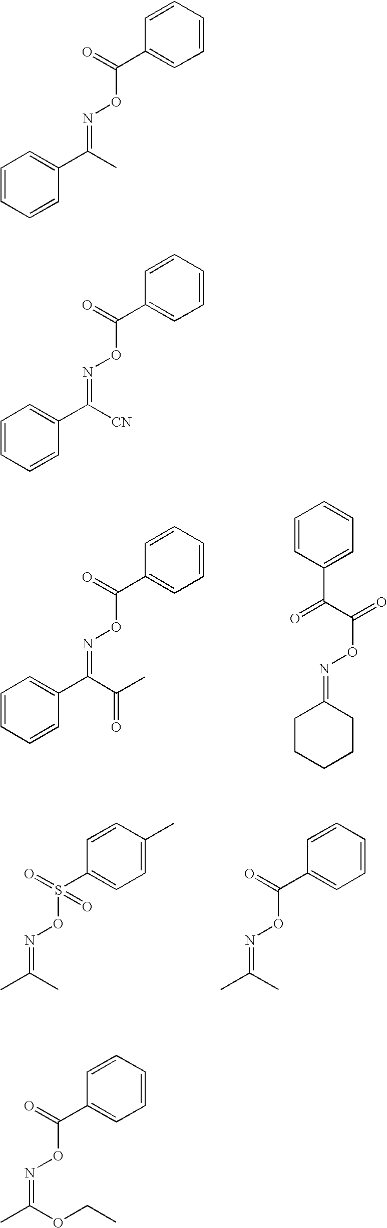

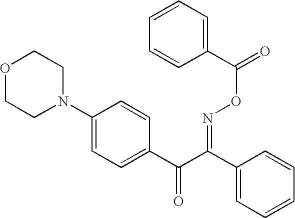

The onium salt compounds include, for example, diazonium salts described in S. I. Schlesinger, Photogr. Sci. Eng., 18, 387 (1974) and T. S. Bal et al., Polymer, 21, 423 (1980), ammonium salts described in U.S. Pat. No. 4,069,055 and JP-A-4-365049, phosphonium salts described in U.S. Pat. Nos. 4,069,055 and 4,069,056, iodonium salts described in European Patent 104,143, U.S. Pat. Nos. 339,049 and 410,201, JP-A-2-150848 and JP-A-2-296514, sulfonium salts described in European Patents 370,693, 390, 214, 233, 567, 297,443 and 297,442, U.S. Pat. Nos. 4,933,377, 161,811, 410,201, 339,049, 4,760,013, 4,734,444 and 2,833,827 and German Patents 2,904,626, 3,604,580 and 3,604,581, selenonium salts described in J. V. Crivello et al., Macromolecules, 10 (6), 1307 (1977) and J. V. Crivello et al., J. Polymer Sci., Polymer Chem. Ed., 17, 1047 (1979), and arsonium salts described in C. S. Wen et al., Teh, Proc. Conf. Rad. Curing ASIA, p. 478, Tokyo, October. (1988).

Particularly, in view of reactivity and stability, the oxime ester compounds and diazonium salts, iodonium salts and sulfonium salts described above are preferably exemplified. In the invention, the onium salt functions not as an acid generator but as an ionic radical polymerization initiator.

The onium salts preferably used in the invention include onium salts represented by the following formulae (R-I) to (R-III):

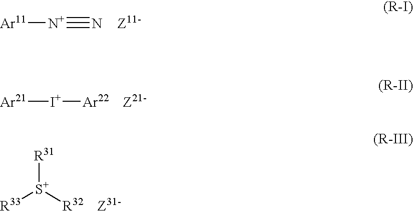

In formula (R-I), Ar¹¹ represents an aryl group having 20 or less carbon atoms, which may have 1 to 6 substituents. Preferable example of the substituent includes an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxyl group, a cyano group, a sulfonyl group, an thioalkyl group having from 1 to 12 carbon atoms and an thioaryl group having from 1 to 12 carbon atoms. Z¹¹⁻ represents a monovalent anion and specifically includes a halide ion, a perchlorate ion, a hexafluorophosphate ion, a tetrafluoroborate ion, a sulfonate ion, a sulfinate ion, a thiosulfonate ion and a sulfate ion. From the standpoint of stability and visibility of print-out image, a perchlorate ion, a hexafluorophosphate ion, a tetrafluoroborate ion, a sulfonate ion or a sulfinate ion is preferable.

In the formula (R-II), Ar²¹ and Ar²² each independently represents an aryl group having 20 or less carbon atoms, which may have 1 to 6 substituents. Preferable example of the substituent includes an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxyl group, a cyano group, a sulfonyl group, an thioalkyl group having from 1 to 12 carbon atoms and an thioaryl group having from 1 to 12 carbon atoms. Z²¹⁻ represents a monovalent anion and specifically includes a halide ion, a perchlorate ion, a hexafluorophosphate ion, a tetrafluoroborate ion, a sulfonate ion, a sulfinate ion, a thiosulfonate ion, a sulfate ion and a carboxylate ion. From the standpoint of stability and visibility of print-out image, a perchlorate ion, a hexafluorophosphate ion, a tetrafluoroborate ion, a sulfonate ion, a sulfinate ion or a carboxylate ion is preferable.

In the formula (RI-III), R³¹, R³² and R³³ each independently represents an aryl group having 20 or less carbon atoms, which may have 1 to 6 substituents, an alkyl group, an alkenyl group or an alkynyl group and is preferably an aryl group from the standpoint of reactivity and stability. Preferable example of the substituent includes an alkyl group having from 1 to 12 carbon atoms, an alkenyl group having from 1 to 12 carbon atoms, an alkynyl group having from 1 to 12 carbon atoms, an aryl group having from 1 to 12 carbon atoms, an alkoxy group having from 1 to 12 carbon atoms, an aryloxy group having from 1 to 12 carbon atoms, a halogen atom, an alkylamino group having from 1 to 12 carbon atoms, a dialkylimino group having from 1 to 12 carbon atoms, an alkylamido group or arylamido group having from 1 to 12 carbon atoms, a carbonyl group, a carboxyl group, a cyano group, a sulfonyl group, an thioalkyl group having from 1 to 12 carbon atoms and an thioaryl group having from 1 to 12 carbon atoms. Z³¹⁻ represents a monovalent anion and specifically includes a halide ion, a perchlorate ion, a hexafluorophosphate ion, a tetrafluoroborate ion, a sulfonate ion, a sulfinate ion, a thiosulfonate ion, a sulfate ion and a carboxylate ion. From the standpoint of stability and visibility of print-out image, a perchlorate ion, a hexafluorophosphate ion, a tetrafluoroborate ion, a sulfonate ion, a sulfinate ion or a carboxylate ion is preferable. Carboxylate ions described in JP-A-2001-343742 are more preferable, and carboxylate ions described in JP-A-2002-148790 are particularly preferable.

Specific examples of the onium salt compound preferably used as the polymerization initiator in the invention are set forth below, but the invention should not be construed as being limited thereto.

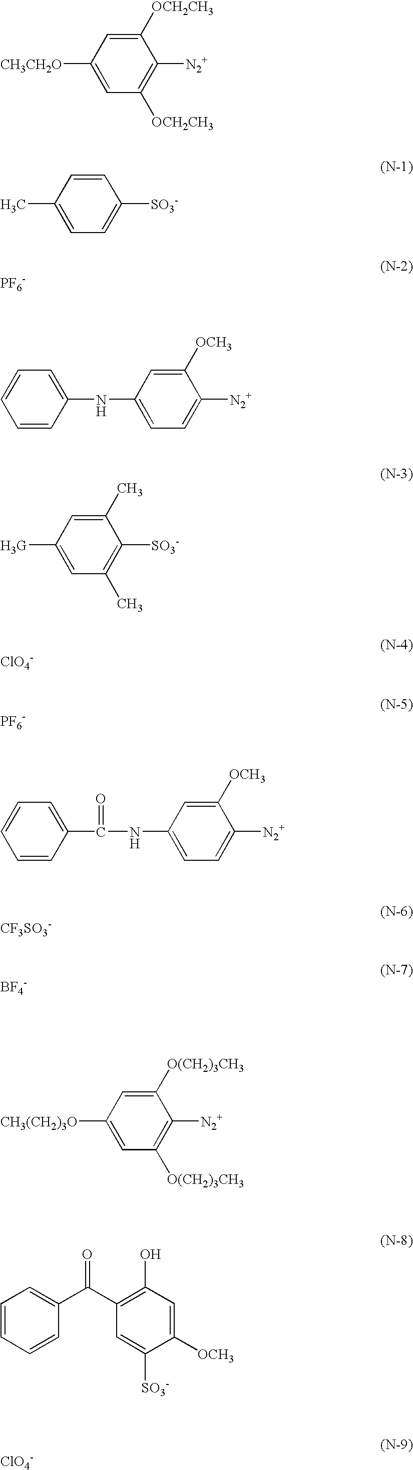

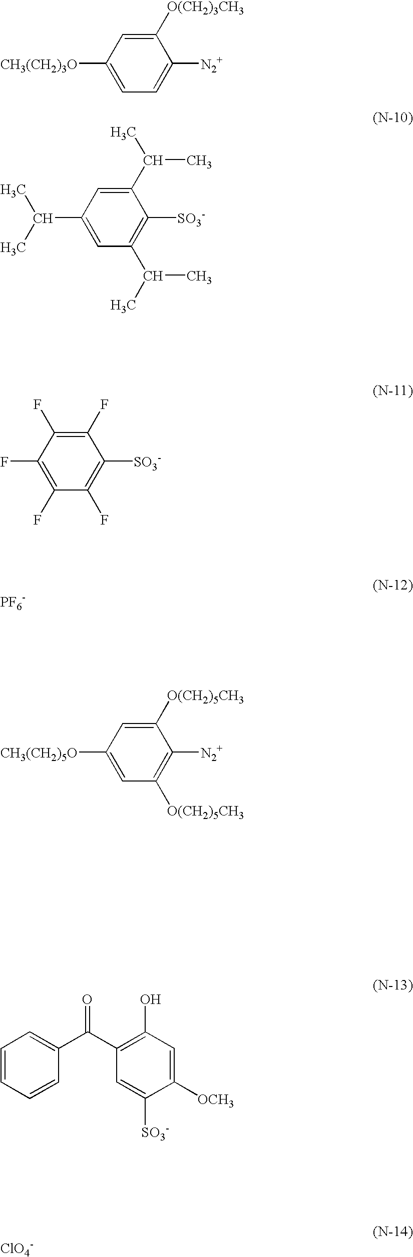

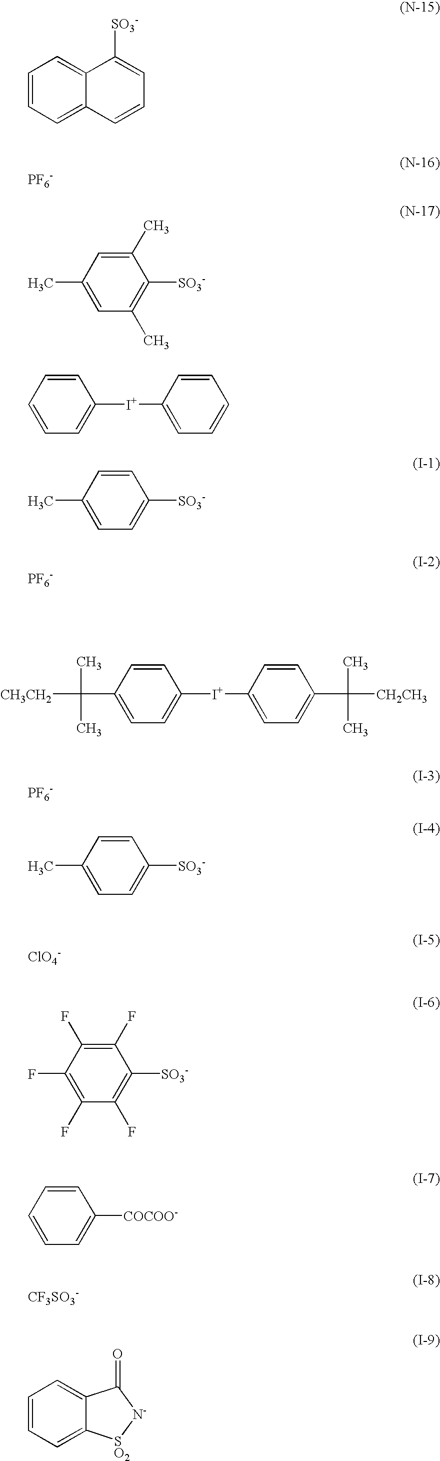

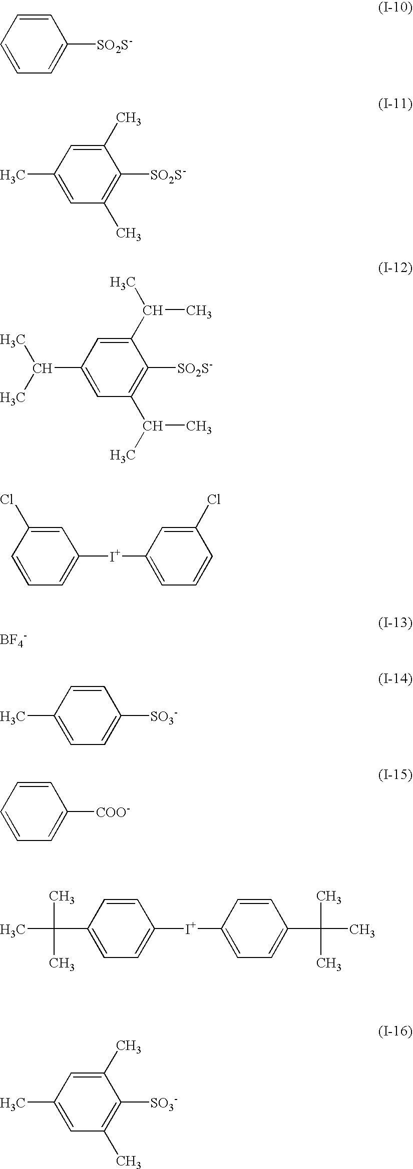

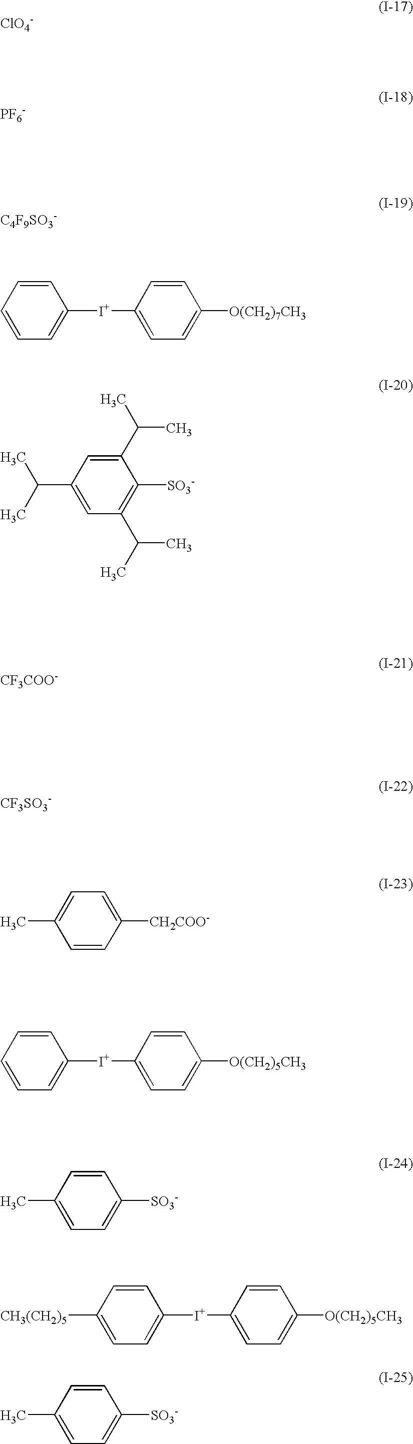

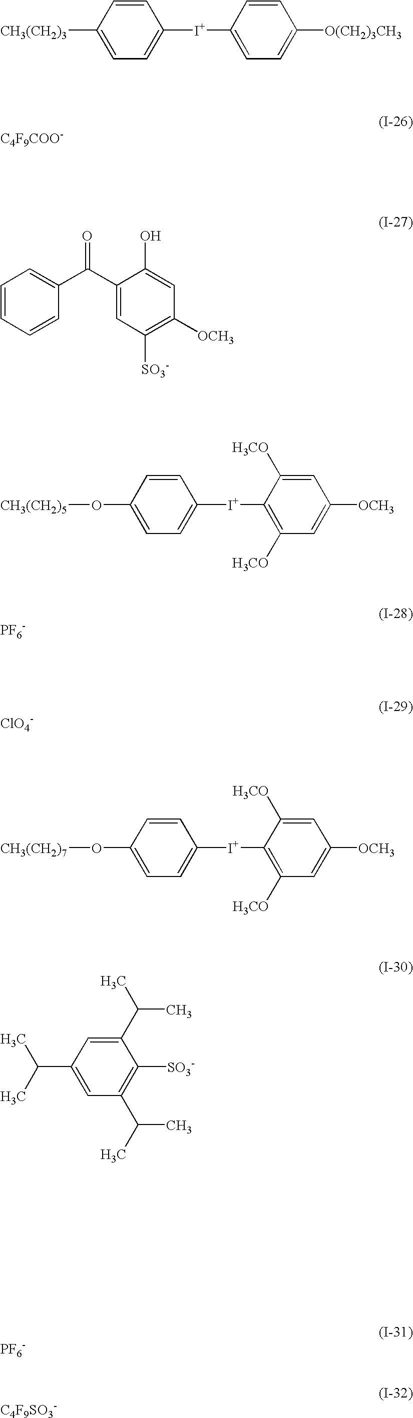

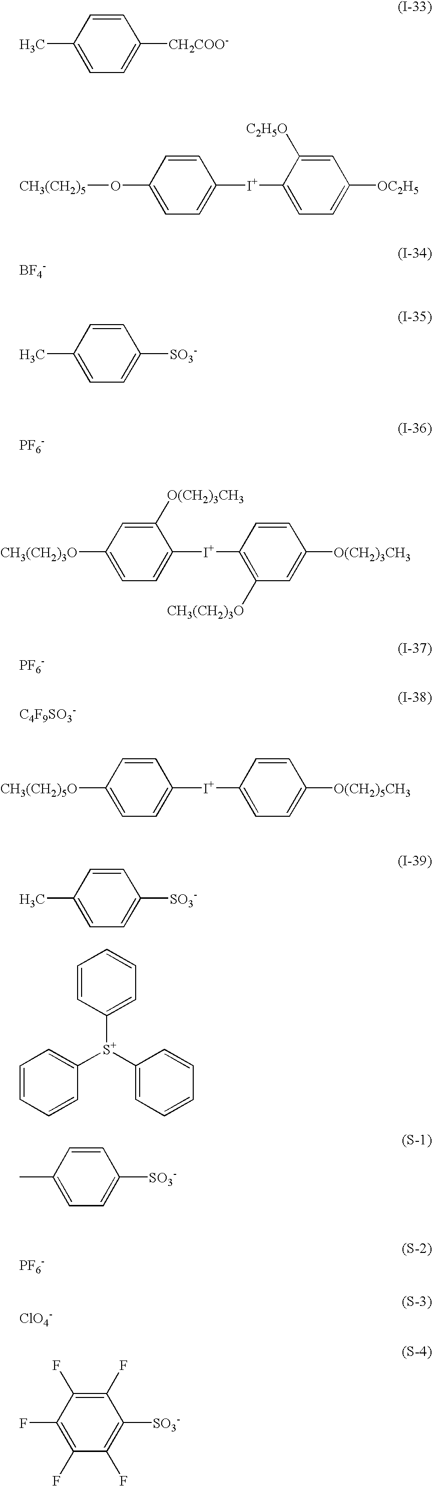

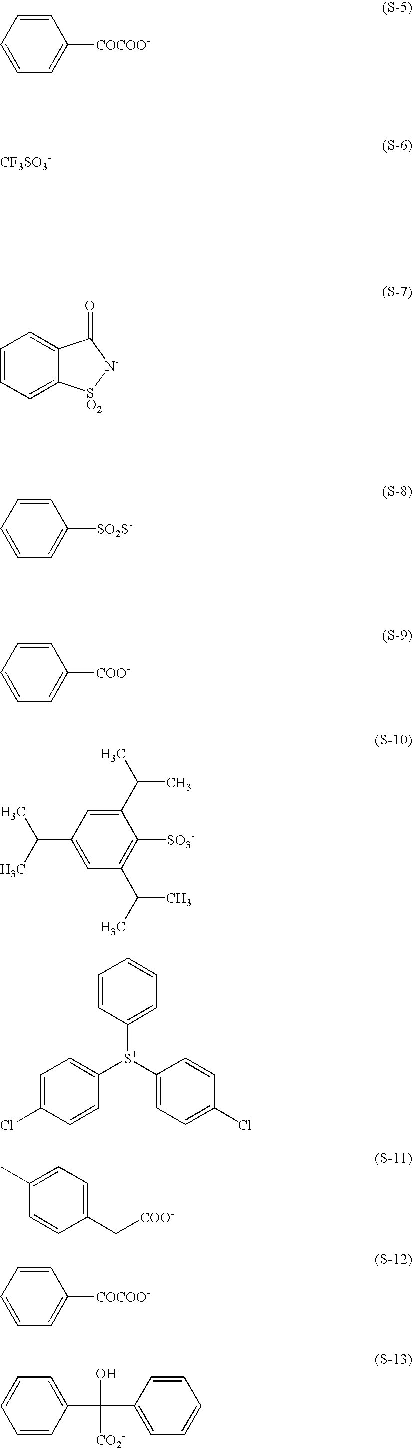

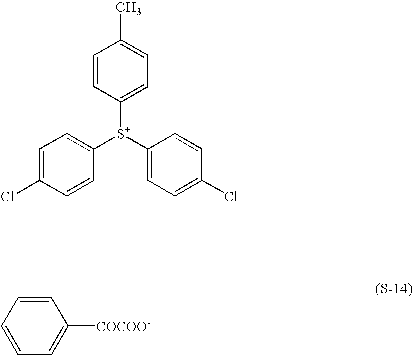

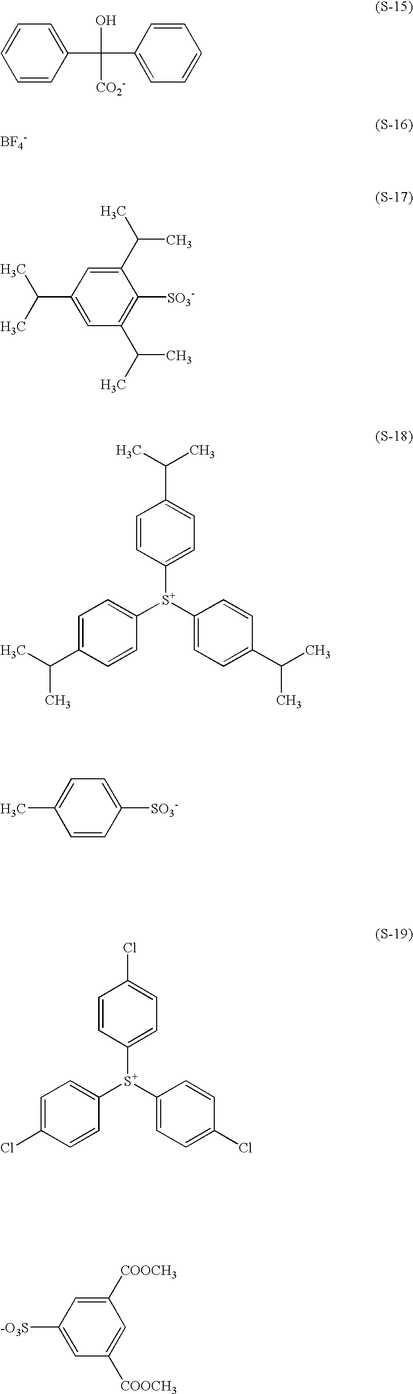

The polymerization initiator is not limited to those described above. In particular, the triazine type initiators, the organic halides, the oxime ester compounds, the diazonium salts, iodonium salts and sulfonium salts are more preferable from the standpoint of reactivity and stability. Of the radical polymerization initiators, onium salt compounds including as a counter ion, an inorganic anion, for example, PF₆⁻ or BF₄⁻ are preferable in combination with the infrared absorbing agent from the standpoint of improvement in the visibility of print-out image. Further, in view of excellence in the color-forming property, a diaryl iodonium is preferable as the onium salt.

The polymerization initiator can be added to the image-recording layer preferably in an amount from 0.1 to 50% by weight, more preferably from 0.5 to 30% by weight, particularly preferably from 0.8 to 20% by weight, based on the total solid content constituting the image-recording layer. In the range described above, good sensitivity and good stain resistance in the non-image area at the time of printing are obtained.

The polymerization initiators may be used individually or in combination of two or more thereof. The polymerization initiator may be added together with other components to the same layer or may be added to a different layer separately provided.

### [(C) Polymerizable Compound]

The polymerizable compound (C) for use in the invention is not particularly restricted and is preferably an addition-polymerizable compound having at least one ethylenically unsaturated double bond, and it is selected from compounds having at least one, preferably two or more, terminal ethylenically unsaturated double bonds. Such compounds are widely known in the field of art and they can be used in the invention without any particular limitation. The compound has a chemical form, for example, a monomer, a prepolymer, specifically, a dimer, a trimer or an oligomer, or a (co)polymer thereof, or a mixture thereof.

Examples of the monomer and copolymer thereof include unsaturated carboxylic acids (for example, acrylic acid, methacrylic acid, itaconic acid, crotonic acid, isocrotonic acid or maleic acid) and esters or amides thereof. Preferably, esters of an unsaturated carboxylic acid with an aliphatic polyhydric alcohol compound and amides of an unsaturated carboxylic acid with an aliphatic polyvalent amine compound are used. An addition reaction product of an unsaturated carboxylic acid ester or amide having a nucleophilic substituent, for example, a hydroxy group, an amino group or a mercapto group, with a monofunctional or polyfunctional isocyanate or epoxy, or a dehydration condensation reaction product of the unsaturated carboxylic acid ester or amide with a monofunctional or polyfunctional carboxylic acid is also preferably used. Furthermore, an addition reaction product of an unsaturated carboxylic acid ester or amide having an electrophilic substituent, for example, an isocyanato group or an epoxy group with a monofunctional or polyfunctional alcohol, amine or thiol, or a substitution reaction product of an unsaturated carboxylic acid ester or amide having a releasable substituent, for example, a halogen atom or a tosyloxy group with a monofunctional or polyfunctional alcohol, amine or thiol is also preferably used. In addition, compounds in which the unsaturated carboxylic acid described above is replaced by an unsaturated phosphonic acid, styrene, vinyl ether or the like can also be used.

With respect to specific examples of the monomer, which is an ester of an aliphatic polyhydric alcohol compound with an unsaturated carboxylic acid, as an acrylic acid ester, for example, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate or polyester acrylate oligomer is exemplified.

As a methacrylic acid ester, for example, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane or bis[p-(methacryloxyethoxy)phenyl]dimethylmethane is exemplified.

As an itaconic acid ester, for example, ethylene glycol diitaconate, propylene glycol diitaconate, 1,3-butanediol diitaconate, 1,4-butanediol diitaconate, tetramethylene glycol diitaconate, pentaerythritol diitaconate or sorbitol tetraitaconate is exemplified.

As a crotonic acid ester, for example, ethylene glycol dicrotonate, tetramethylene glycol dicrotonate, pentaerythritol dicrotonate and sorbitol tetracrotonate is exemplified.

As an isocrotonic acid ester, for example, ethylene glycol diisocrotonate, pentaerythritol diisocrotonate and sorbitol tetraisocrotonate is exemplified.

As a maleic acid ester, for example, ethylene glycol dimaleate, triethylene glycol dimaleate, pentaerythritol dimaleate or sorbitol tetramaleate is exemplified.

Other examples of the ester, which can be preferably used, include aliphatic alcohol esters described in JP-B-51-47334 and JP-A-57-196231, esters having an aromatic skeleton described in JP-A-59-5240, JP-A-59-5241 and JP-A-2-226149, and esters containing an amino group described in JP-A-1-165613.

The above-described ester monomers can also be used as a mixture. Specific examples of the monomer, which is an amide of an aliphatic polyvalent amine compound with an unsaturated carboxylic acid, include methylene bisacrylamide, methylene bismethacrylamide, 1,6-hexamethylene bisacrylamide, 1,6-hexamethylene bismethacrylamide, diethylenetriamine trisacrylamide, xylylene bisacrylamide and xylylene bismethacrylamide. Other preferable examples of the amide monomer include amides having a cyclohexylene structure described in JP-B-54-21726.

Urethane type addition polymerizable compounds produced using an addition reaction between an isocyanate and a hydroxy group are also preferably used, and specific examples thereof include vinylurethane compounds having two or more polymerizable vinyl groups per molecule obtained by adding a vinyl monomer containing a hydroxy group represented by formula (1) shown below to a polyisocyanate compound having two or more isocyanate groups per molecule, described in JP-B-48-41708.

CH₂═C(R⁴)COOCH₂CH(R⁵)OH (1)

wherein R⁴ and R⁵ each independently represents H or CH₃.

Also, urethane acrylates described in JP-A-51-37193, JP-B-2-32293 and JP-B-2-16765, and urethane compounds having an ethylene oxide skeleton described in JP-B-58-49860, JP-B-56-17654, JP-B-62-39417 and JP-B-62-39418 are preferably used. Furthermore, a photopolymerizable composition having remarkably excellent photosensitive speed can be obtained by using an addition polymerizable compound having an amino structure or a sulfide structure in its molecule, described in JP-A-63-277653, JP-A-63-260909 and JP-A-1-105238.

Other examples include polyfunctional acrylates and methacrylates, for example, polyester acrylates and epoxy acrylates obtained by reacting an epoxy resin with acrylic acid or methacrylic acid, described in JP-A-48-64183, JP-B-49-43191 and JP-B-52-30490. Specific unsaturated compounds described in JP-B-46-43946, JP-B-1-40337 and JP-B-1-40336, and vinylphosphonic acid type compounds described in JP-A-2-25493 can also be exemplified. In some cases, structure containing a perfluoroalkyl group described in JP-A-61-22048 can be preferably used. Moreover, photocurable monomers or oligomers described in Nippon Secchaku Kyokaishi (Journal of Japan Adhesion Society), Vol. 20, No. 7, pages 300 to 308 (1984) can also be used.

According to the invention, a polymerizable compound having an isocyanuric acid skeleton is exemplified as a preferable polymerizable compound from the standpoint of the compatibility between sensitivity and on-press development property. Specific examples of the polymerizable compound having an isocyanuric acid skeleton include tris[(meth)acryloyloxymethyl] isocyanurate, tris[(meth)acryloyloxyethyl] isocyanurate, tris[(meth)acryloyloxypropyl] isocyanurate, triallyl isocyanurate, bis[(meth)acryloyloxyethyl]hydroxyethyl isocyanurate, bis[(meth)acryloyloxymethyl] isocyanurate, allyhydroxyethyl isocyanurate, (meth)acryloyloxyethyl isocyanurate, isocyanuric acid ethylene oxide (EO) modified diacrylate and isocyanuric acid EO modified triacrylate.

Details of the method of using the polymerizable compound, for example, selection of the structure, individual or combination use, or an amount added, can be appropriately arranged depending on the characteristic design of the final lithographic printing plate precursor. For instance, the compound is selected from the following standpoints.

In view of the sensitivity, a structure having a large content of unsaturated groups per molecule is preferred and in many cases, a bifunctional or more functional compound is preferred. In order to increase the strength of image area, that is, cured layer, a trifunctional or more functional compound is preferred. A combination use of compounds different in the functional number or in the kind of polymerizable group (for example, an acrylic acid ester, a methacrylic acid ester, a styrene compound or a vinyl ether compound) is an effective method for controlling both the sensitivity and the strength.

The selection and use method of the polymerizable compound are also important factors for the compatibility and dispersibility with other components (for example, a binder polymer, a polymerization initiator or a coloring agent) in the image-recording layer. For instance, the compatibility may be improved in some cases by using the compound of low purity or using two or more kinds of the compounds in combination. A specific structure may be selected for the purpose of improving an adhesion property, for example, to a support or a protective layer.

In the invention, the polymerizable compound (C) is preferably used in an amount from 5 to 80% by weight, more preferably from 25 to 75% by weight, based on the nonvolatile component of the image-recording layer.

In the method of using the polymerizable compound, the structure, blend and amount added can be appropriately selected by taking account of the extent of polymerization inhibition due to oxygen, resolution, fogging property, change in refractive index, surface tackiness and the like. Further, depending on the case, a layer construction, for example, an undercoat layer or an overcoat layer, and a coating method, may also be considered.

### [Binder Polymer]

In the image-recording layer according to the invention, a binder polymer can be used for the purpose of improving film strength of the image-recording layer. The binder polymer for use in the invention can be selected from those heretofore known without restriction, and a polymer having a film-forming property is preferable. Examples of the binder polymer include acrylic resins, polyvinyl acetal resins, polyurethane resins, polyurea resins, polyimide resins, polyamide resins, epoxy resins, polystyrene resins, novolac type phenolic resins, polyester resins, synthesis rubbers and natural rubbers. Acrylic resins, polyvinyl acetal resins and polyurethane resins are particularly preferred.

The binder polymer may have a crosslinkable property in order to improve the film strength of the image area. In order to impart the crosslinkable property to the binder polymer, a crosslinkable functional group, for example, an ethylenically unsaturated bond is introduced into a main chain or side chain of the polymer. The crosslinkable functional group may be introduced by copolymerization.

Examples of the polymer having an ethylenically unsaturated bond in the main chain thereof include poly-1,4-butadiene and poly-1,4-isoprene.

Examples of the polymer having an ethylenically unsaturated bond in the side chain thereof include a polymer of an ester or amide of acrylic acid or methacrylic acid, which is a polymer wherein the ester or amide residue (R in —COOR or —CONHR) has an ethylenically unsaturated bond.

Examples of the residue (R described above) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X (wherein R¹ to R³ each represents a hydrogen atom, a halogen atom or an alkyl group having from 1 to 20 carbon atoms, an aryl group, alkoxy group or aryloxy group, or R¹ and R² or R¹ and R³ may be combined with each other to form a ring. n represents an integer of 1 to 10. X represents a dicyclopentadienyl residue).

Specific examples of the ester residue include —CH₂CH═CH₂ (described in JP-B-7-21633), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples of the amide residue include —CH₂CH═CH₂, —CH₂CH₂—Y (wherein Y represents a cyclohexene residue) and —CH₂CH₂—OCO—CH═CH₂.

The binder polymer having crosslinkable property is cured, for example, by addition of a free radical (a polymerization initiating radical or a growing radical of a polymerizable compound during polymerization) to the crosslinkable functional group of the polymer and undergoing addition polymerization between the polymers directly or through a polymerization chain of the polymerizable compound to form crosslinkage between the polymer molecules. Alternately, it is cured by generation of a polymer radical upon extraction of an atom (for example, a hydrogen atom on a carbon atom adjacent to the functional crosslinkable group) in the polymer by a free radial and connecting the polymer radicals with each other to form cross-linkage between the polymer molecules.

The content of the crosslinkable group in the binder polymer (content of the radical polymerizable unsaturated double bond determined by iodine titration) is preferably from 0.1 to 10.0 mmol, more preferably from 1.0 to 7.0 mmol, most preferably from 2.0 to 5.5 mmol, based on 1 g of the binder polymer. In the range described above, good sensitivity and good preservation stability can be obtained.

The binder polymer for use in the invention preferably has a hydrophilic group. The hydrophilic group contributes to impart the on-press development property to the image-recording layer. In particular, when the crosslinkable group and the hydrophilic group are present in the binder polymer, both printing durability and developing property are well achieved.

Examples of the hydrophilic group include a hydroxy group, a carboxyl group, a carboxylate group, a hydroxyethyl group, an alkylene oxide structure, a hydroxypropyl group, a polyoxyethyl group, a polyoxypropyl group, an amino group, an aminoethyl group, an aminopropyl group, an ammonium group, an amido group, a carboxymethyl group, a sulfo group and a phosphoric acid group. Preferably, for example, an amido group, a hydroxy group, a polyoxyethyl group and an alkylene oxide group are exemplified. The alkylene oxide structure represented by formula (2) shown below is most preferable. The alkylene oxide structure is preferably incorporated into a side chain of the binder polymer.

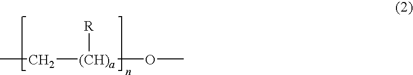

In formula (2), R represents a hydrogen atom or a methyl group, a represents an integer of 1, 3 or 5, and n represents an integer of 1 to 9. n preferably represents an integer of 1 to 8, more preferably an integer of 1 to 7, still more preferably an integer of 1 to 6, and most preferably an integer of 2 to 4.

In order to introduce the hydrophilic group into an acrylic resin or the like, a monomer having a hydrophilic group may be copolymerized. Specific examples of the copolymerizable monomer having a hydrophilic group include acrylamide, methacrylamide, N,N-dimethylacrylamide, N-isopropylacrylamide, N-vinylpyrrolidone, N-vinylacetamide, N-acryloylmorpholine, 2-hydroxyethyl acrylate, 2-hydroxyethyl methacrylate, polyoxyethylene monomethacrylate, polyoxyethylene monoacrylate, polyoxypropylene monomethacrylate, polyoxypropylene monoacrylate, meth(acrylate) of polyoxyethylene monoalkyl ether and meth(acrylate) of polyoxypropylene monoalkyl ether.

The copolymerizable monomers having a hydrophilic group may be used individually or in combination of two or more thereof. The content of the structural unit having a hydrophilic group in the binder polymer is preferably from 1 to 85% by mole, and particularly preferably from 5 to 70% by mole.

According to the invention, an oleophilic group containing carbon atoms, for example, an alkyl group, an aryl group, an aralkyl group or an alkenyl group may further be introduced into the binder polymer to the extent that the effects of the invention are not damaged. By the introduction of an oleophilic group, an ink acceptivity can be controlled.

In order to impart the oleophilicity to an acrylic resin, a hydrophobic monomer may be copolymerized. Examples of the copolymerizable monomer includes monomers selected from an acrylate, a methacrylate, an N,N-disubstituted acrylamide, an N,N-disubstituted methacrylamide, a styrene, acrylonitrile and methacrylonitrile.

Specific examples thereof include an acrylate, for example, an alkyl acrylate (preferably having from 1 to 20 carbon atoms in the alkyl group thereof) (e.g., methyl acrylate, ethyl acrylate, propyl acrylate, butyl acrylate, amyl acrylate, ethylhexyl acrylate, octyl acrylate, tert-octyl acrylate, chloroethyl acrylate, 2,2-dimethylhydroxypropyl acrylate, 5-hydroxypentyl acrylate, trimethylolpropane monoacrylate, pentaerythritol monoacrylate, glycidyl acrylate, benzyl acrylate, methoxybenzyl acrylate, furfuryl acrylate or tetrahydrofurfuryl acrylate) or an aryl acrylate (e.g., phenyl acrylate), a methacrylate, for example, an alkyl methacrylate (preferably having from 1 to 20 carbon atoms in the alkyl group thereof) (e.g., methyl methacrylate, ethyl methacrylate, propyl methacrylate, isopropyl methacrylate, amyl methacrylate, hexyl methacrylate, cyclohexyl methacrylate, benzyl methacrylate, chlorobenzyl methacrylate, octyl methacrylate, 4-hydroxybutyl methacrylate, 5-hydroxypentyl methacrylate, 2,2-dimethyl-3-hydroxypropyl methacrylate, trimethylolpropane monomethacrylate, pentaerythritol monomethacrylate, glycidyl methacrylate, furfuryl methacrylate or tetrahydrofurfuryl methacrylate) or an aryl methacrylate (e.g., phenyl methacrylate, cresyl methacrylate or naphthyl methacrylate), styrene, a styrene derivative, for example, an alkylstyrene (e.g., methylstyrene, dimethylstyrene, trimethylstyrene, ethylstyrene, diethylstyrene, isopropylstyrene, butylstyrene, hexylstyrene, cyclohexylstyrene, decylstyrene, benzylstyrene, chloromethylstyrene, trifluoromethylstyrene, ethoxymethylstyrene or acetoxymethylstyrene), an alkoxystyrene (e.g., methoxystyrene, 4-methoxy-3-methylstyrene or dimethoxystyrene), or a halogenostyrene (e.g., chlorostyrene, dichlorostyrene, trichlorostyrene, tetrachlorostyrene, pentachlorostyrene, bromostyrene, dibromostyrene, iodostyrene, fluorostyrene, trifluorostyrene, 2-bromo-4-trifluoromethylstyrene or 4-fluoro-3-trifluoromethylstyrene), acrylonitrile and methacrylonitrile.

Specific examples of the binder polymer for use in the invention are set forth below, but the invention should not be construed as being limited thereto.

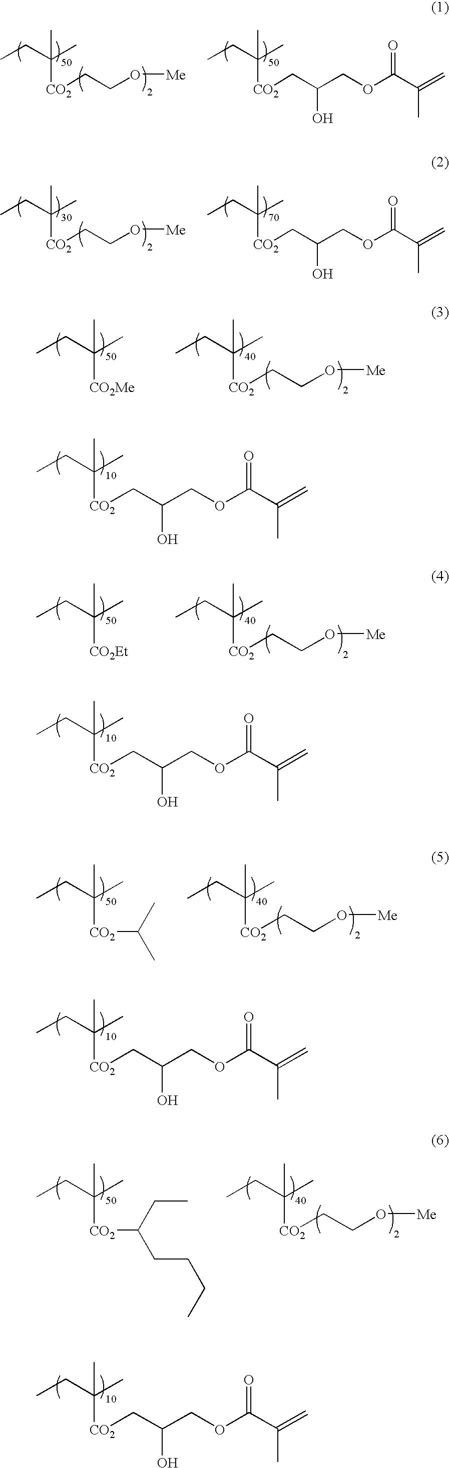

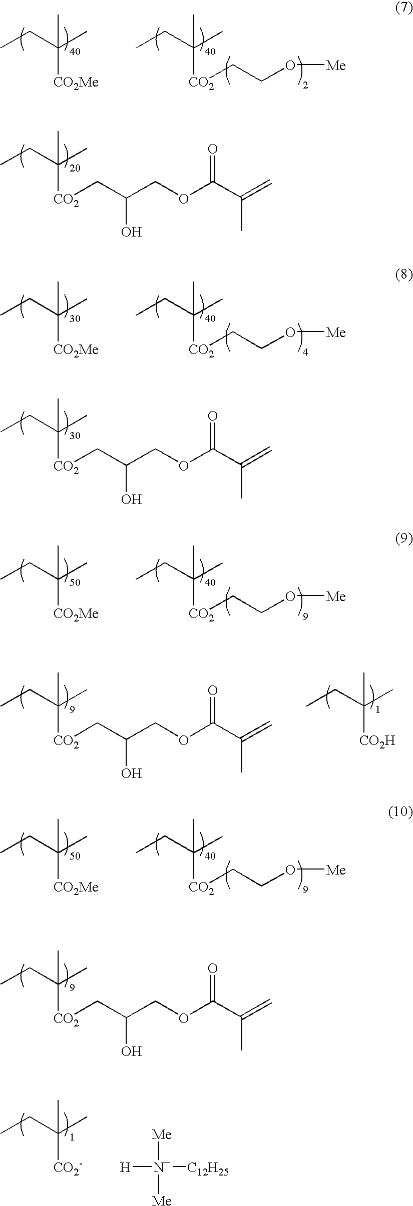

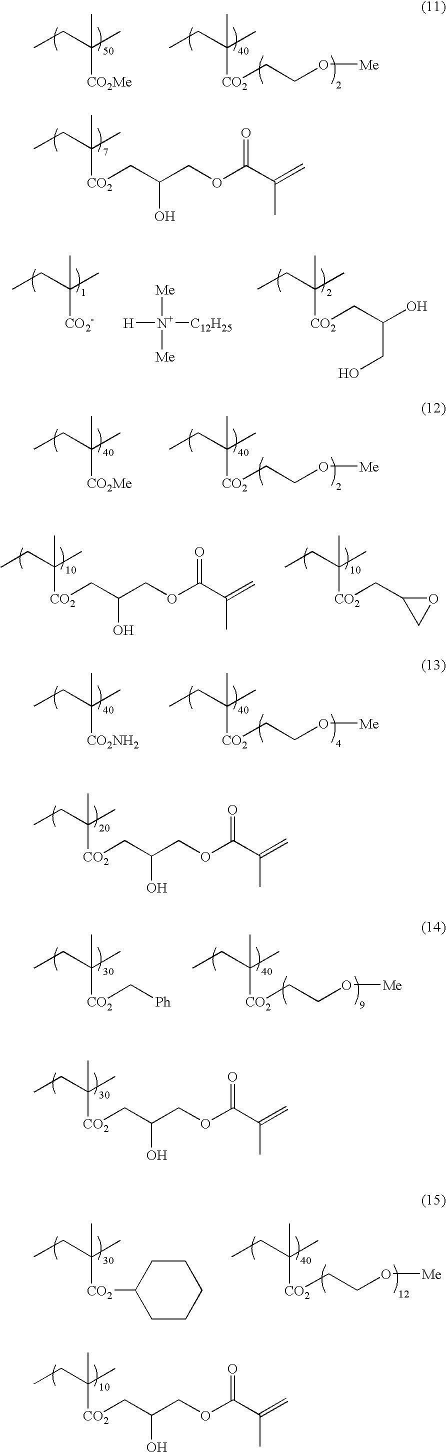

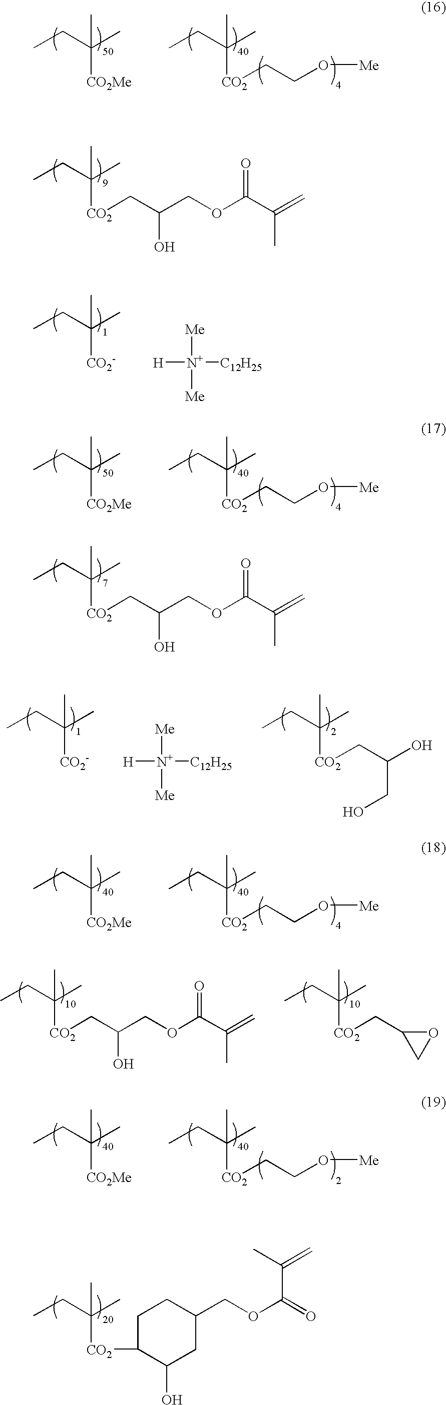

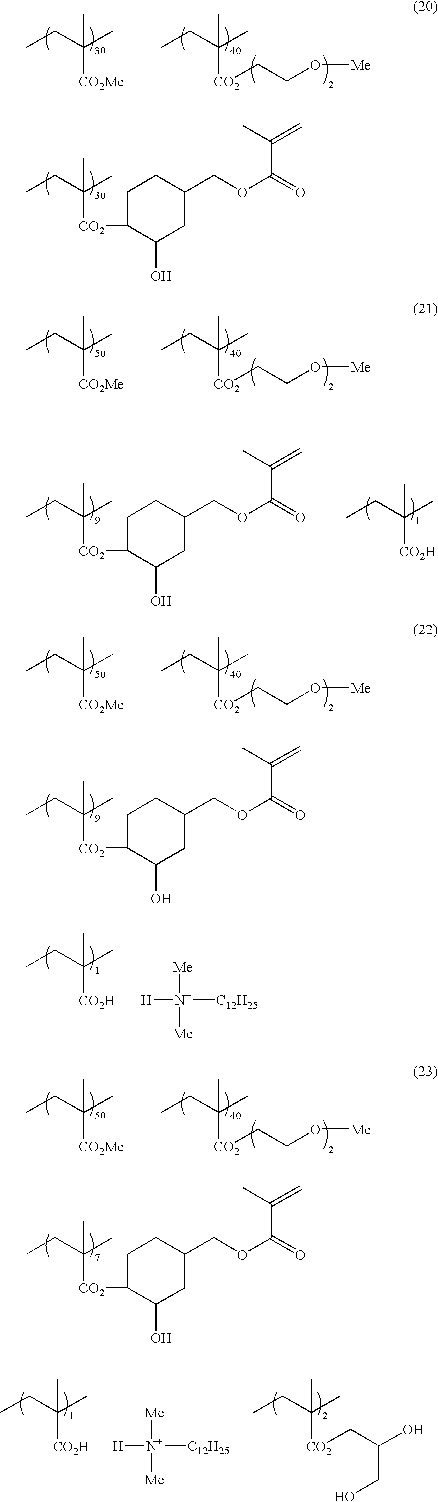

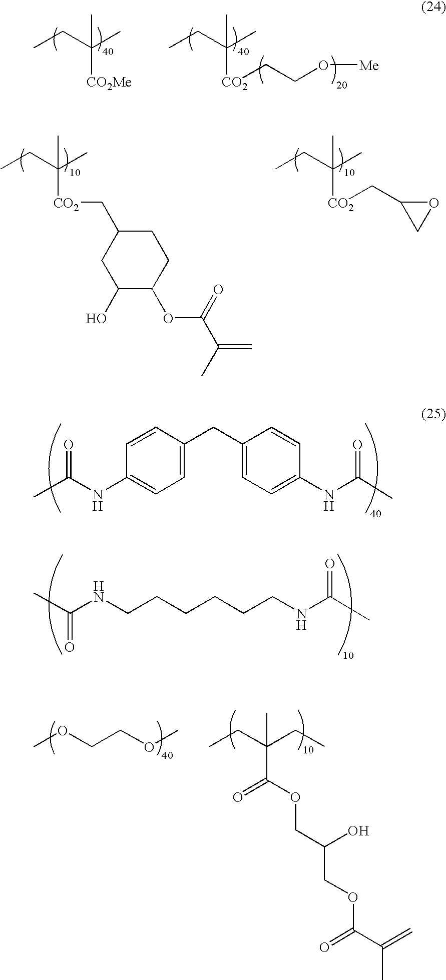

In order to improve the on-press development property of the image-recording layer, it is effective that an oleophilic binder polymer and a hydrophilic binder polymer are used in combination. Specific examples the hydrophilic binder polymer include gum arabic, casein, gelatin, a starch derivative, carboxy methyl cellulose and a sodium salt thereof, cellulose acetate, sodium alginate, a vinyl acetate-maleic acid copolymer, a styrene-maleic acid copolymer, polyacrylic acid and a salt thereof, polymethacrylic acid and a salt thereof, a homopolymer or copolymer of hydroxyethyl methacrylate, a homopolymer or copolymer of hydroxyethyl acrylate, a homopolymer or copolymer of hydroxypropyl methacrylate, a homopolymer or copolymer of hydroxypropyl acrylate, a homopolymer or copolymer of hydroxybutyl methacrylate, a homopolymer or copolymer of hydroxybutyl acrylate, a polyethylene glycol, a hydroxypropylene polymer, polyvinyl alcohol, a hydrolyzed polyvinyl acetate having a hydrolysis degree of 60% by mole or more, preferably 80% by mole or more, polyvinyl formal, polyvinyl butyral, polyvinyl pyrrolidone, a homopolymer or copolymer of acrylamide, a homopolymer or polymer of methacrylamide, a homopolymer or copolymer of N-methylolacrylamide, an alcohol-soluble nylon, a polyether of 2,2-bis-(4-hydroxyphenyl)propane and epichlorohydrin.

The weight average molecular weight (Mw) of the binder polymer is preferably 2,000 or more, more preferably 5,000 or more, and still more preferably from 10,000 to 300,000. The number average molecular weight (Mn) of the binder polymer is preferably 1,000 or more, and more preferably from 2,000 to 250,000. The polydispersity (weight average molecular weight/number average molecular weight) thereof is preferably from 1.1 to 10.

The binder polymer is available by purchasing a commercial product or synthesizing according to a known method.

The content of the binder polymer is ordinarily from 5 to 90% by weight, preferably from 5 to 80% by weight, more preferably from 10 to 70% by weight, based on the total solid content of the image-recording layer. In the range described above, good strength of the image area and good image-forming property can be obtained.

It is preferred that the polymerizable compound and the binder polymer are used in a weight ratio of 0.5/1 to 4/1.

### [Microcapsule and Microgel]

The image-recording layer according to the invention preferably has an embodiment of containing a microcapsule and/or microgel in order to obtain good on-press development property. Specifically, when the image-recording layer according to the invention is capable of conducting on-press development, it is preferred to incorporate a microcapsule and/or microgel into the image-recording layer.

The microcapsule for use in the invention contains all or part of the constituting components (including the constituting components (A) to (D) described above) of the image-recording layer encapsulated therein as described, for example, in JP-A-2001-277740 and JP-A-2001-277742. The constituting components of the image-recording layer may be present outside the microcapsules. It is a more preferable embodiment of the image-recording layer containing microcapsule that the hydrophobic constituting components are encapsulated in microcapsules and the hydrophilic constituting components are present outside the microcapsules.

According to the invention, the image-recording layer may have an embodiment containing a crosslinked resin particle, that is, a microgel. The microgel can contain a part of the constituting components (A) to (D) inside and/or on the surface thereof. Particularly, an embodiment of a reactive microgel containing the polymerizable compound (C) on the surface thereof is preferable in view of the image-forming sensitivity and printing durability.

As a method of microencapsulation or microgelation of the constituting component of the image-recording layer, known methods can be used.

Methods of producing the microcapsule include, for example, a method of utilizing coacervation described in U.S. Pat. Nos. 2,800,457 and 2,800,458, a method of using interfacial polymerization described in U.S. Pat. No. 3,287,154, JP-B-38-19574 and JP-B-42-446, a method of using deposition of polymer described in U.S. Pat. Nos. 3,418,250 and 3,660,304, a method of using an isocyanate polyol wall material described in U.S. Pat. No. 3,796,669, a method of using an isocyanate wall material described in U.S. Pat. No. 3,914,511, a method of using a urea-formaldehyde-type or urea-formaldehyde-resorcinol-type wall-forming material described in U.S. Pat. Nos. 4,001,140, 4,087,376 and 4,089,802, a method of using a wall material, for example, a melamine-formaldehyde resin or hydroxycellulose described in U.S. Pat. No. 4,025,445, an in-situ method by monomer polymerization described in JP-B-36-9163 and JP-B-51-9079, a spray drying method described in British Patent 930,422 and U.S. Pat. No. 3,111,407, and an electrolytic dispersion cooling method described in British Patents 952,807 and 967,074, but the invention should not be construed as being limited thereto.

A preferable microcapsule wall used in the invention has three-dimensional crosslinking and has a solvent-swellable property. From this point of view, a preferable wall material of the microcapsule includes polyurea, polyurethane, polyester, polycarbonate, polyamide and a mixture thereof, and polyurea and polyurethane are particularly preferred. Further, a compound having a crosslinkable functional group, for example, an ethylenically unsaturated bond, capable of being introduced into the binder polymer described hereinafter may be introduced into the microcapsule wall.

On the other hand, methods of preparing the microgel include, for example, a method of utilizing granulation by interfacial polymerization described in JP-B-38-19574 and JP-B-42-446 and a method of utilizing granulation by dispersion polymerization in a non-aqueous system described in JP-A-5-61214, but the invention should not be construed as being limited thereto.

To the method utilizing interfacial polymerization, known production methods of microcapsule can be applied.

The microgel preferably used in the invention is granulated by interfacial polymerization and has three-dimensional crosslinking. From this point of view, a preferable material to be used includes polyurea, polyurethane, polyester, polycarbonate, polyamide and a mixture thereof, and polyurea and polyurethane are particularly preferred.

The average particle size of the microcapsule or microgel is preferably from 0.01 to 3.0 μm, more preferably from 0.05 to 2.0 μm, particularly preferably from 0.10 to 1.0 μm. In the range described above, good resolution and good time-lapse stability can be achieved.

### [Other Components of Image-Recording Layer]

The image-recording layer according to the invention may further contain other components, if desired.

Other components constituting the image-recording layer according to the invention will be described blow.

### (1) Surfactant

In the image-recording layer according to the invention, a surfactant can be used in order to promote the development removability and on-press development property and to improve the state of coated surface.

The surfactant used includes, for example, a nonionic surfactant, an anionic surfactant, a cationic surfactant, an amphoteric surfactant and a fluorine-based surfactant. The surfactants can be used individually or in combination of two or more thereof.

The nonionic surfactant used in the invention is not particular restricted, and those hitherto known can be used. Examples of the nonionic surfactant include polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerol fatty acid partial esters, polyoxyethylenated castor oils, polyoxyethylene glycerol fatty acid partial esters, fatty acid diethanolamides, N,N-bis-2-hydroxyalkylamines, polyoxyethylene alkylamines, triethanolamine fatty acid esters, trialkylamine oxides, polyethylene glycols, and copolymers of polyethylene glycol and polypropylene glycol.

The anionic surfactant used in the invention is not particularly restricted and those hitherto known can be used. Examples of the anionic surfactant include fatty acid salts, abietic acid salts, hydroxyalkanesulfonic acid salts, alkanesulfonic acid salts, dialkylsulfosuccinic ester salts, straight-chain alkylbenzenesulfonic acid salts, branched alkylbenzenesulfonic acid salts, alkylnaphthalenesulfonic acid salts, alkylphenoxypolyoxyethylene propylsulfonic acid salts, polyoxyethylene alkylsulfophenyl ether salts, N-methyl-N-oleyltaurine sodium salt, N-alkylsulfosuccinic monoamide disodium salts, petroleum sulfonic acid salts, sulfated beef tallow oil, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styrylphenyl ether sulfate ester salts, alkyl phosphate ester salts, polyoxyethylene alkyl ether phosphate ester salts, polyoxyethylene alkyl phenyl ether phosphate ester salts, partial saponification products of styrene/maleic anhydride copolymer, partial saponification products of olefin/maleic anhydride copolymer, naphthalene sulfonate formalin condensates, alkyl polyoxyalkylene sulfoalkyl ether salts and alkenyl polyoxyalkylene sulfoalkyl ether salts.

The cationic surfactant used in the invention is not particularly restricted and those hitherto known can be used. Examples of the cationic surfactant include alkylamine salts, quaternary ammonium salts, polyoxyethylene alkyl amine salts and polyethylene polyamine derivatives.

The amphoteric surfactant used in the invention is not particularly restricted and those hitherto known can be used. Examples of the amphoteric surfactant include carboxybetaines, aminocarboxylic acids, sulfobetaines, aminosulfuric esters, and imidazolines.

In the surfactants described above, the term “polyoxyethylene” can be replaced with “polyoxyalkylene”, for example, polyoxymethylene, polyoxypropylene or polyoxybutylene, and such surfactants can also be used in the invention.

A further preferable surfactant includes a fluorine-based surfactant containing a perfluoroalkyl group in its molecule. Examples of the fluorine-based surfactant include an anionic type, for example, perfluoroalkyl carboxylates, perfluoroalkyl sulfonates or perfluoroalkyl phosphates, an amphoteric type, for example, perfluoroalkyl betaines, a cationic type, for example, perfluoroalkyl trimethyl ammonium salts, and a nonionic type, for example, perfluoroalkyl amine oxides, perfluoroalkyl ethylene oxide adducts, oligomers having a perfluoroalkyl group and a hydrophilic group, oligomers having a perfluoroalkyl group and an oleophilic group, oligomers having a perfluoroalkyl group, a hydrophilic group and an oleophilic group or urethanes having a perfluoroalkyl group and an oleophilic group. Further, fluorine-based surfactants described in JP-A-62-170950, JP-A-62-226143 and JP-A-60-168144 are also preferably exemplified.

Moreover, other examples of further preferable surfactant include alkyl polyoxyalkylene sulfoalkyl ether salts. Examples thereof include n-octyl(diethyleneoxy)sulfobutyl ether Na salt, 2-ethylhexyl(diethyleneoxy)sulfobutyl ether Na salt, n-decyl(diethyleneoxy)sulfobutyl ether Na salt, n-dodecyl(diethyleneoxy)sulfobutyl ether Na salt, n-octyl(diethyleneoxy)sulfobutyl ether K salt, 2-ethylhexyl(diethyleneoxy)sulfobutyl ether K salt, n-decyl(diethyleneoxy)sulfobutyl ether K salt, n-dodecyl(diethyleneoxy)sulfopropyl ether K salt, n-octyl(diethyleneoxy)sulfopropyl ether Na salt, 2-ethylhexyl(diethyleneoxy)sulfopropyl ether Na salt, 2-decyl(diethyleneoxy)sulfopropyl ether Na salt, n-decyl(diethyleneoxy)sulfopropyl ether Na salt, 2-ethylhexyl(diethyleneoxy)sulfobutyl ether ammonium salt, 2-ethylhexyl(diethyleneoxy)sulfobutyl ether triethylammonium salt and 2-ethylhexyl(diethyleneoxy)sulfobutyl ether pyridinium salt.

The surfactants can be used individually or in combination of two or more thereof. The content of the surfactant is preferably from 0.001 to 10% by weight, more preferably from 0.01 to 5% by weight, based on the total solid content of the image-recording layer.

### (2) Coloring Agent

In the image-recording layer according to the invention, a dye having a large absorption in the visible region can be used as a coloring agent of the image formed. Specifically, the dye includes Oil yellow #101, Oil yellow #103, Oil pink #312, Oil green BG, Oil blue BOS, Oil blue #603, Oil black BY, Oil black BS, Oil black T-505 (produced by Orient Chemical Industries, Ltd.), Victoria pure blue, Crystal violet (CI42555), Methyl violet (CI42535), Ethyl violet, Rhodamine B (CI45170B), Malachite green (CI42000), Methylene blue (CI52015) and dyes described in JP-A-62-293247. Further, a pigment, for example, a phthalocyanine pigment, an azo pigment, carbon black or titanium oxide can also preferably be used.

It is preferred to add the coloring agent since distinction between the image area and the non-image area is easily conducted after the formation of image.

The amount of the coloring agent added is preferably from 0.01 to 10% by weight based on the total solid content of the image-recording layer.

### (3) Print-Out Agent

To the image-recording layer according to the invention, a compound undergoing discoloration with an acid or radical can be added in order to form a print-out image.

As the compound used for such a purpose, various dyes, for example, of diphenylmethane type, triphenylmethane type, thiazine type, oxazine type, xanthene type, anthraquinone type, iminoquinone type, azo type and azomethine type are effectively used.

Specific examples thereof include dyes, for example, Brilliant green, Ethyl violet, Methyl green, Crystal violet, basic Fuchsine, Methyl violet 2B, Quinaldine red, Rose Bengal, Methanyl yellow, Thimol sulfophthalein, Xylenol blue, Methyl orange, Paramethyl red, Congo red, Benzo purpurin 4B, α-Naphthyl red, Nile blue 2B, Nile blue A, Methyl violet, Malachite green, Parafuchsine, Victoria pure blue BOH (produced by Hodogaya Chemical Co., Ltd.), Oil blue #603 (produced by Orient Chemical Industries, Ltd.), Oil pink #312 (produced by Orient Chemical Industries, Ltd.), Oil red 5B (produced by Orient Chemical Industries, Ltd.), Oil scarlet #308 (produced by Orient Chemical Industries, Ltd.), Oil red OG (produced by Orient Chemical Industries, Ltd.), Oil red RR (produced by Orient Chemical Industries, Ltd.), Oil green #502 (produced by Orient Chemical Industries, Ltd.), Spiron Red BEH special (produced by Hodogaya Chemical Co., Ltd.), m-Cresol purple, Cresol red, Rhodamine B, Rhodamine 6G, Sulfo Rhodamine B, Auramine, 4-p-diethylaminophenyliminonaphthoquione, 2-carboxyanilino-4-p-diethylaminophenyliminonaphthoquinone, 2-carboxystearylamino-4-p-N,N-bis(hydroxyethyl)aminophenyliminonaphthoquinone, 1-phenyl-3-methyl-4-p-diethylaminophenylimino-5-pyrazolon or 1-β-naphtyl-4-p-diethylaminophenylimino-5-pyrazolon, and a leuco dye, for example, p, p′, p″-hexamethyltriaminotriphenylmethane (leuco crystal violet) or Pergascript Blue SRB (produced by Ciba Geigy Ltd.).

In addition to those described above, a leuco dye known as a material for heat-sensitive paper or pressure-sensitive paper is also preferably used. Specific examples thereof include crystal violet lactone, malachite green lactone, benzoyl leuco methylene blue, 2-(N-phenyl-N-methylamino)-6-(N-p-tolyl-N-ethyl)aminofluoran, 2-anilino-3-methyl-6-(n-ethyl-p-tolidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N—N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-pipelidino-6-methyl-7-anilinofluoran, 3-pyrrolidino-6-methyl-7-anilinofluoran, 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalide and 3-(4-diethylaminophenyl)-3-(1-ethyl-2-methylindol-3-yl)phthalide.

The amount of the dye undergoing discoloration with an acid or radical used as the print-out agent is preferably from 0.01 to 10% by weight based on the solid content of the image-recording layer.

### (4) Polymerization Inhibitor

It is preferred to add a small amount of a thermal polymerization inhibitor to the image-recording layer according to the invention in order to inhibit undesirable thermal polymerization of the polymerizable compound (C) and a binder polymer having a polymerizable group during the production or preservation of the image-recording layer.

The thermal polymerization inhibitor preferably includes, for example, hydroquinone, p-methoxyphenol, di-tert-butyl-p-cresol, pyrogallol, tert-butyl catechol, benzoquinone, 4,4′-thiobis(3-methyl-6-tert-butylphenol), 2,2′-methylenebis(4-methyl-6-tert-butylphenol) and N-nitroso-N-phenylhydroxylamine aluminum salt.

The amount of the thermal polymerization inhibitor added is preferably from about 0.01 to about 5% by weight based on the total solid content of the image-recording layer.

### (5) Higher Fatty Acid Derivative

To the image-recording layer according to the invention, a higher fatty acid derivative, for example, behenic acid or behenic acid amide may be added to localize on the surface of the image-recording layer during a drying step after coating in order to avoid polymerization inhibition due to oxygen.

The amount of the higher fatty acid derivative added is preferably from about 0.1 to about 10% by weight based on the total solid content of the image-recording layer.

### (6) Plasticizer

The image-recording layer according to the invention may contain a plasticizer in order to improve the development removability and on-press development property.

The plasticizer preferably includes, for example, a phthalic acid ester, e.g., dimethyl phthalate, diethyl phthalate, dibutyl phthalate, diisobutyl phthalate, dioctyl phthalate, octyl capryl phthalate, dicyclohexyl phthalate, ditridecyl phthalate, butyl benzyl phthalate, diisodecyl phthalate or diallyl phthalate, a glycol ester, e.g., dimethylglycol phthalate, ethylphthalylethyl glycolate, methylphthalylethyl glycolate, butylphthalylbutyl glycolate or triethylene glycol dicaprylate ester, a phosphoric acid ester, e.g., tricresyl phosphate or triphenyl phosphate, an aliphatic dibasic acid ester, e.g., diisobutyl adipate, dioctyl adipate, dimethyl sebacate, dibutyl sebacate, dioctyl azelate or dibutyl maleate, polyglycidyl methacrylate, triethyl citrate, glycerin triacetyl ester and butyl laurate.

The content of the plasticizer is preferably about 30% by weight or less based on the total solid content of the image-recording layer.

### (7) Fine Inorganic Particle

The image-recording layer according to the invention may contain fine inorganic particle in order to increase the strength of cured film and to improve the development removability and on-press development property.

The fine inorganic particle preferably includes, for example, silica, alumina, magnesium oxide, titanium oxide, magnesium carbonate, calcium alginate and a mixture thereof. The fine inorganic particle can be used, for example, for strengthening the film or enhancing interface adhesion property due to surface roughening.

The fine inorganic particle preferably has an average particle size from 5 nm to 10 μm, more preferably from 0.5 to 3 μm. In the range described above, it is stably dispersed in the image-recording layer, sufficiently maintains the film strength of the image-recording layer and can form the non-imaging area excellent in hydrophilicity and prevented from the occurrence of stain at the time of printing.

The fine inorganic particle described above is easily available as a commercial product, for example, colloidal silica dispersion.

The content of the fine inorganic particle is preferably 40% by weight or less, more preferably 30% by weight or less, based on the total solid content of the image-recording layer.

### (8) Hydrophilic Low Molecular Weight Compound

The image-recording layer according to the invention may contain a hydrophilic low molecular weight compound in order to improve the development removability and on-press development property without accompanying degradation of the printing durability.

The hydrophilic low molecular weight compound includes a water-soluble organic compound, for example, a glycol compound, e.g., ethylene glycol, diethylene glycol, triethylene glycol, propylene glycol, dipropylene glycol or dipropylene glycol, or an ether or ester derivative thereof, a polyhydroxy compound, e.g., glycerine or pentaerythritol, an organic amine compound, e.g., triethanol amine, diethanol amine or monoethanol amine, or a salt thereof, an organic sulfonic acid compound, e.g., an alkyl sulfonic acid, toluene sulfonic acid or benzene sulfonic acid, or a salt thereof, an organic sulfamic acid compound, e.g., an alkyl sulfamic acid, or a salt thereof, an organic sulfuric acid compound, e.g., an alkyl sulfuric acid or an alkyl ether sulfuric acid, or a salt thereof, an organic phosphonic acid compound, e.g., phenyl phosphonic acid, or a salt thereof, an organic carboxylic acid, e.g., tartaric acid, oxalic acid, citric acid, malic acid, lactic acid, gluconic acid or an amino acid, or a salt thereof.

Of the compounds, an organic sulfonic acid, an organic sulfamic acid, an organic sulfate, for example, sodium salt or lithium salt of an organic sulfuric acid is preferably used.

Specific examples of the salt of organic sulfonic acid include sodium n-butylsulfonate, sodium isobutylsulfonate, sodium sec-butylsulfonate, sodium tert-butylsulfonate, sodium n-pentylsulfonate, sodium 1-ethylpropylsulfonate, sodium n-hexylsulfonate, sodium 1,2-dimethylpropylsulfonate, sodium 2-ethylbutylsulfonate, sodium cyclohexylsulfonate, sodium n-heptylsulfonate, sodium n-octylsulfonate, sodium tert-octylsulfonate, sodium n-nonylsulfonate, sodium allylsulfonate, sodium 2-methylallylsulfonate, sodium benzenesulfonate, sodium p-toluenesulfonate, sodium p-hydroxybenzenesulfonate, sodium p-styrenesulfonate, sodium isophthalic acid dimethyl-5-sulfonate, disodium 1,3-benzenedisulfonate, trisodium 1,3,5-benzenetrisulfonate, sodium p-chlorobenzenesulfonate, sodium 3,4-dichlorobenzenesulfonate, sodium 1-naphtylsulfonate, sodium 2-naphtylsulfonate, sodium 4-hydroxynaphtylsulfonate, disodium 1,5-naphtyldisulfonate, disodium 2,6-naphtyldisulfonate, trisodium 1,3,6-naphtyltrisulfonate and lithium salts of these compounds wherein the sodium is exchanged with lithium.

Specific examples of the salt of organic sulfamic acid include sodium n-butylsulfamate, sodium isobutylsulfamate, sodium tert-butylsulfamate, sodium n-pentylsulfamate, sodium 1-ethylpropylsulfamate, sodium n-hexylsulfamate, sodium 1,2-dimethylpropylsulfamate, sodium 2-ethylbutylsulfamate, sodium cyclohexylsulfamate and lithium salts of these compounds wherein the sodium is exchanged with lithium.

The hydrophilic low molecular weight compound has the hydrophobic portion of a small structure and almost no surface active function and thus, it can be clearly distinguished from the surfactant described hereinbefore in which a long-chain alkylsulfonate or a long-chain alkylbenzenesulfonate is preferably used.

As the organic sulfate, a compound represented by formula (3) shown below is particularly preferably used.

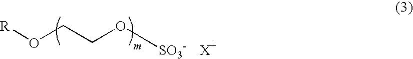

In formula (3), R represents a substituted or unsubstituted alkyl group, a substituted or unsubstituted alkenyl group, a substituted or unsubstituted alkynyl group, a substituted or unsubstituted aryl group or a substituted or unsubstituted heterocyclic group, m represents an integer of 1 to 4, and X represents sodium, potassium or lithium.

R in formula (3) preferably represents a substituted or unsubstituted, straight-chain, branched or cyclic alkyl group having from 1 to 12 carbon atoms, an alkenyl group having from 1 to 12 carbon atoms, an alkynyl group having from 1 to 12 carbon atoms or an aryl group having 20 or less carbon atoms. When these groups have a substituent, examples of the substituent include a straight-chain, branched or cyclic alkyl group having from 1 to 12 carbon atoms, an alkenyl group having from 1 to 12 carbon atoms, an alkynyl group having from 1 to 12 carbon atoms, a halogen atom and an aryl group having 20 or less carbon atoms.

Preferable examples of the compound represented by formula (3) include sodium oxyethylene 2-ethylhexyl ether sulfate, sodium dioxyethylene 2-ethylhexyl ether sulfate, potassium dioxyethylene 2-ethylhexyl ether sulfate, lithium dioxyethylene 2-ethylhexyl ether sulfate, sodium trioxyethylene 2-ethylhexyl ether sulfate, sodium tetraoxyethylene 2-ethylhexyl ether sulfate, sodium dioxyethylene hexyl ether sulfate, sodium dioxyethylene octyl ether sulfate and sodium dioxyethylene lauryl ether sulfate. Most preferable examples thereof include sodium dioxyethylene 2-ethylhexyl ether sulfate, potassium dioxyethylene 2-ethylhexyl ether sulfate and lithium dioxyethylene 2-ethylhexyl ether sulfate.

The amount of the hydrophilic low molecular weight compound added to the image-recording layer is preferably from 0.5 to 20% by weight, more preferably from 1 to 10% by weight, still more preferably from 2 to 8% by weight, based on the total solid content of the image-recording layer. In the range described above, good on-press development property and good printing durability are achieved.

The hydrophilic low molecular weight compounds may be used individually or as a mixture of two or more thereof.

### (9) Oil-Sensitizing Agent

In the case where an inorganic stratiform compound is incorporated into the protective layer described hereinafter, in order to improve the ink-receptive property, a phosphonium compound is preferably used in the image-recording layer.

The phosphonium compound functions as a surface covering agent (oil-sensitizing agent) of the inorganic stratiform compound and prevents deterioration of the ink-receptive property during printing due to the inorganic stratiform compound.

Preferable examples of the phosphonium compound include compounds represented by formulae (4) and (5) shown below. More preferable examples of the phosphonium compound include compounds represented by formula (4).

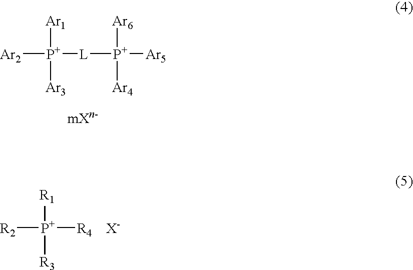

In formula (4), Ar₁ to Ar₆ each independently represents an aryl group or a heterocyclic group, L represents a divalent connecting group, Xⁿ⁻ represents a n-valent counter anion, n represents an integer of 1 to 3, and m represents a number satisfying n×m=2.

The aryl group preferably includes, for example, a phenyl group, a naphthyl group, a tolyl group, a xylyl group, a fluorophenyl group, a chlorophenyl group, a bromophenyl group, a methoxyphenyl group, an ethoxyphenyl group, a dimethoxyphenyl group, a methoxycarbonylphenyl group and a dimethylaminophenyl group.

The heterocyclic group preferably includes, for example, a pyridyl group, a quinolyl group, a pirimidinyl group, a thienyl group and a furyl group.

L is preferably a connecting group having from 6 to 15 carbon atoms, and more preferably a connecting group having from 6 to 12 carbon atoms.

Preferable examples of the counter anion represented by Xⁿ⁻ include a halogen anion, for example, Cl⁻, Br⁻ or I⁻, a sulfonate anion, a carboxylate anion, a sulfuric acid ester anion, PF₆⁻, BF₄⁻ and a perchlorate anion. Among them, a halogen anion, for example, Cl⁻, Br⁻ or I⁻, a sulfonate anion or a carboxylate anion is particularly preferable.

Specific examples of the phosphonium compound represented by formula (4) are set forth below.

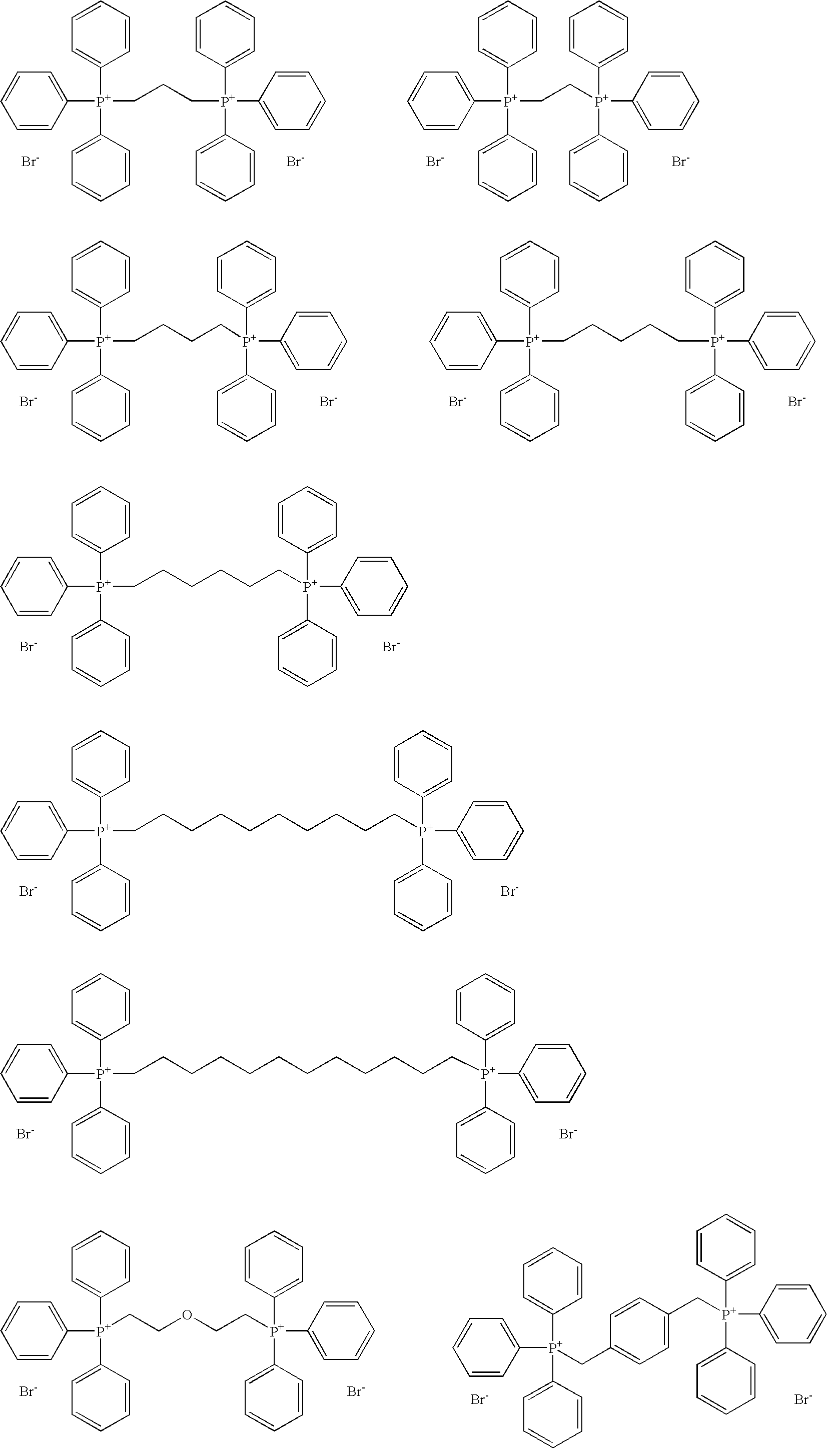

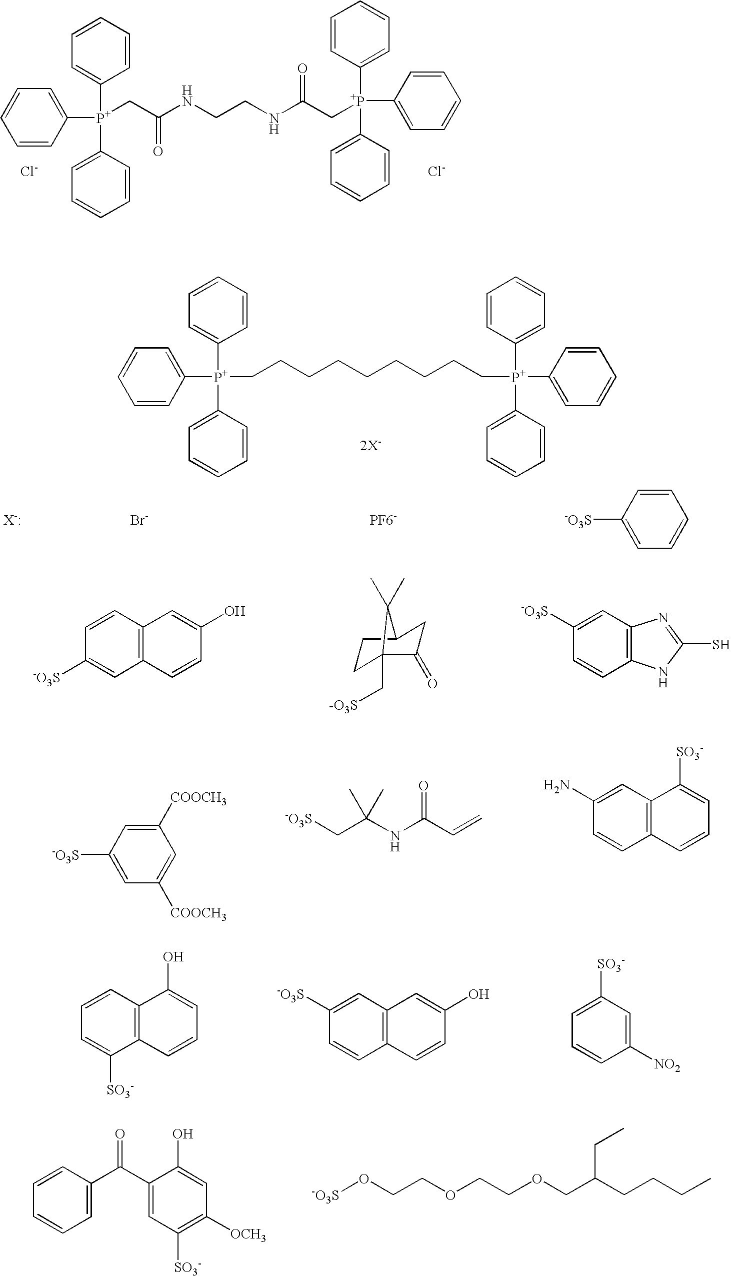

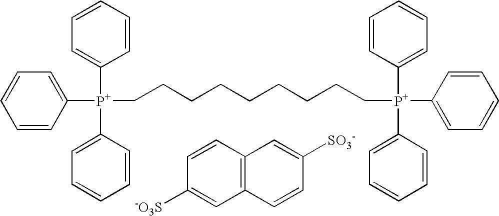

In formula (5) above, R₁ to R₄ each independently represents an alkyl group, an alkenyl group, an alkynyl group, a cycloalkyl group, an alkoxy group, an aryl group, an aryloxy group, an alkylthio group or a heterocyclic group, each of which may have a substituent, or a hydrogen atom. Alternatively, at least two of R₁ to R₄ may be combined with each other to from a ring. X⁻ represents a counter anion.

When R₁ to R₄ each independently represents the alkyl group, alkoxy group or alkylthio group, a carbon number thereof is ordinarily from 1 to 20. When R₁ to R₄ each independently represents the alkenyl group or alkynyl group, a carbon number thereof is ordinarily from 2 to 15. When R₁ to R₄ each independently represents the cycloalkyl group, a carbon number thereof is ordinarily from 3 to 8.

Examples of the aryl group include a phenyl group and a naphthyl group, examples of the aryloxy group include a phenoxy group and a naphthyloxy group, examples of the arylthio group include a phenylthio group, and examples of the heterocyclic group include a furyl group and a thienyl group.

Examples of the substituent which may be contained in these groups include an alkyl group, an alkenyl group, an alkynyl group, a cycloalkyl group, an alkoxy group, an alkoxycarbonyl group, an acyl group, an alkylthio group, an aryl group, an aryloxy group, an arylthio group, a sulfino group, a sulfo group, a phosphino group, a phosphoryl group, an amino group, a nitro group, a cyano group, a hydroxy group and a halogen atom. The substituent may further have a substituent.

The anion represented by X⁻ includes a halogenide anion, for example, Cr⁻, Br⁻, I⁻, an inorganic acid anion, for example, ClO₄⁻, PF₆⁻ or SO₄²⁻, an organic carboxylate anion or an organic sulfonate anion.

Examples of the organic group contained in the organic carboxylate anion or organic sulfonate anion include a methyl group, an ethyl group, a propyl group, a butyl group, a phenyl group, a methoxyphenyl group, a naphthyl group, a fluorophenyl group, a difluorophenyl group, a pentafluorophenyl group, a thienyl group and a pyrrolyl group. Among them, Cl⁻, Br⁻, I⁻, ClO₄⁻ or PF₆⁻ is preferable.

Specific examples of the phosphonium compound represented by formula (5) are set forth below.

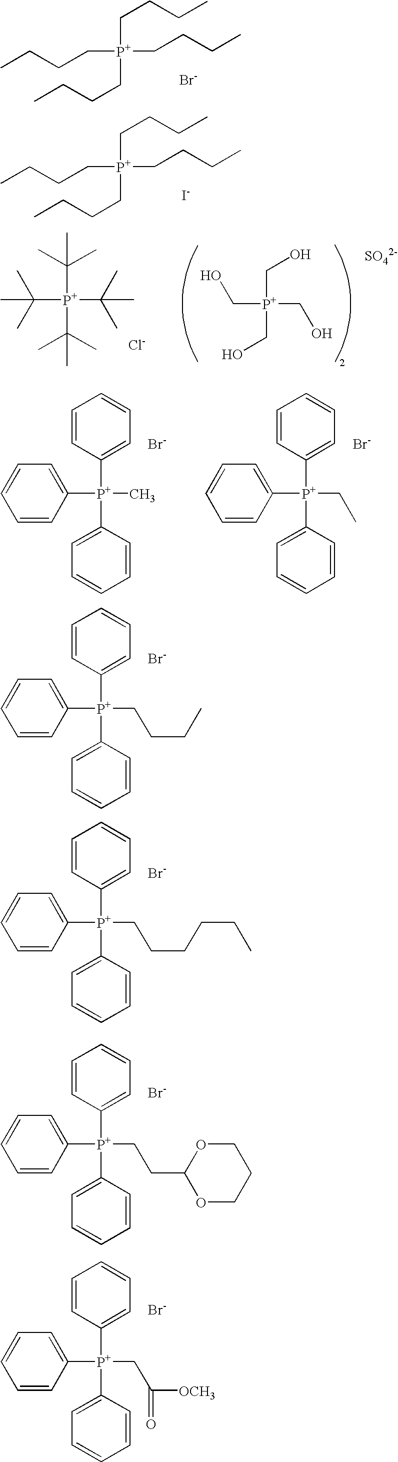

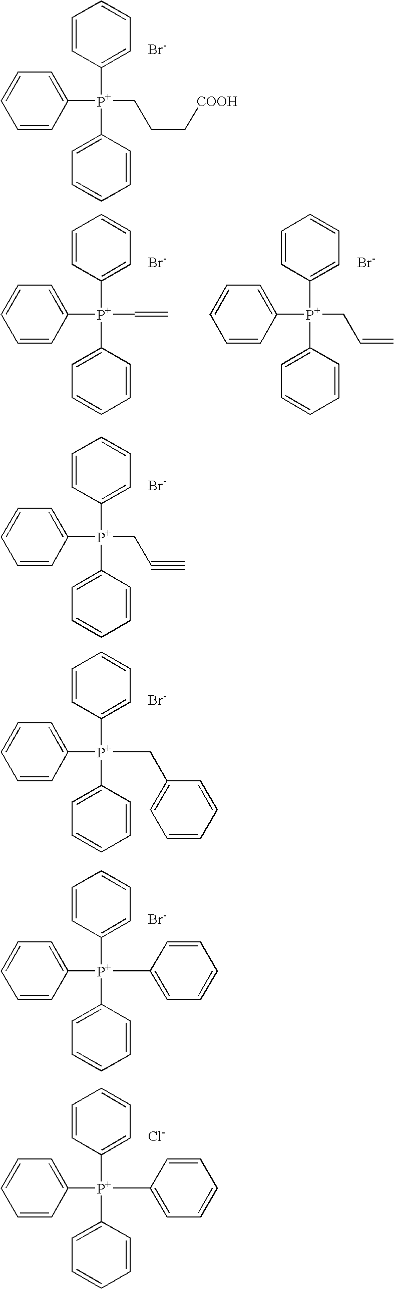

A nitrogen-containing low molecular weight compound described below is also exemplified as the oil-sensitizing agent, which is preferably used in the invention, as well as the phosphonium compound described above. Preferable examples of the nitrogen-containing low molecular weight compound include compounds having a structure represented by formula (6) shown below.

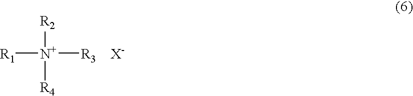

In formula (6), R₁ to R₄ each independently represents an alkyl group, an alkenyl group, an alkynyl group, a cycloalkyl group, an alkoxy group, an aryl group, an aralkyl group or a heterocyclic group, each of which may have a substituent, or a hydrogen atom, alternatively, at least two of R₁ to R₄ may be combined with each other to form a ring, and X⁻ represents an anion including PF₆⁻, BF₄⁻ or an organic sulfonate anion having a substituent selected from an alkyl group, an alkenyl group, an alkynyl group, a cycloalkyl group, an alkoxy group, an aryl group, an aralkyl group and a heterocyclic group.

Specifically, the nitrogen-containing low molecular weight compound for use in the invention includes an amine salt in which at least one of R₁ to R₄ in formula (6) is a hydrogen atom, a quaternary ammonium salt in which any of R₁ to R₄ in formula (6) is not a hydrogen atom. Also, it may have a structure of an imidazolinium salt represented by formula (7) shown below, of a benzimidazolinium salt represented by formula (8) shown below, of a pyridinium salt represented by formula (9) shown below, or of a quinolinium salt represented by formula (10) shown below.

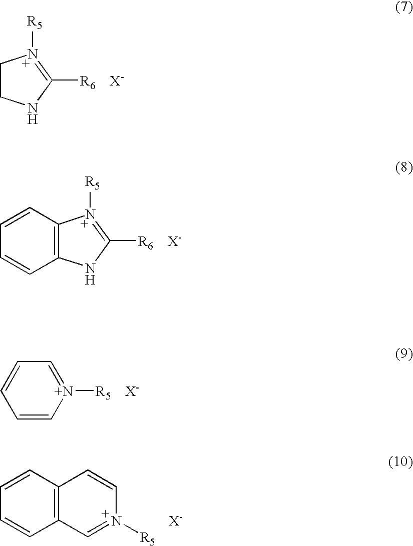

In the above formulae, R₅ and R₆ each independently represents an alkyl group, an alkenyl group, an alkynyl group, a cycloalkyl group, an alkoxy group, an aryl group, an aralkyl group or a heterocyclic group, each of which may have a substituent, or a hydrogen atom, and X⁻ represents an anion having the same meaning as X⁻ in formula (6).

Of the nitrogen-containing low molecular weight compounds, the quaternary ammonium salt and pyridinium salt are preferably used. Specific examples thereof are set forth below.

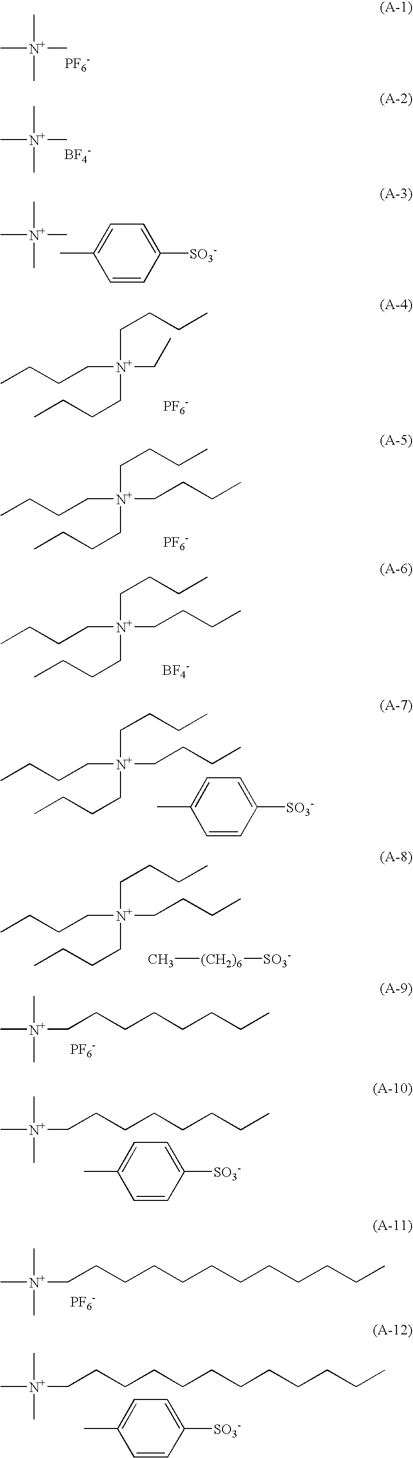

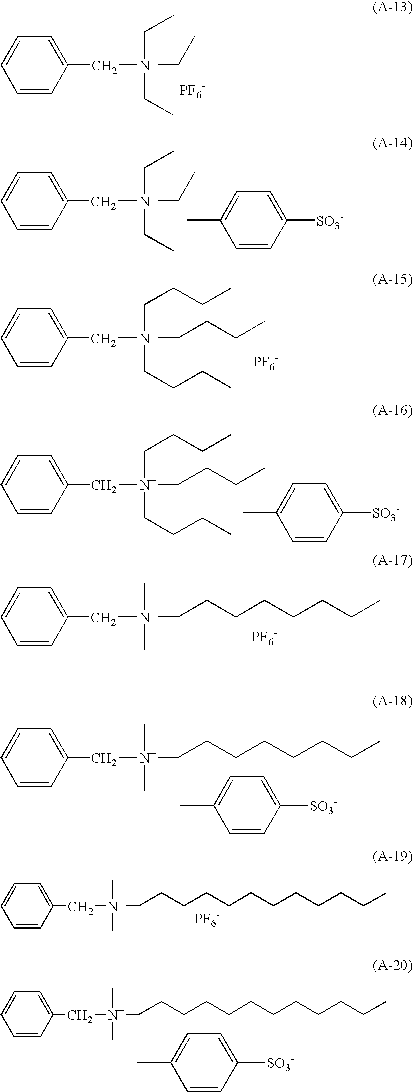

The amount of the phosphonium compound or nitrogen-containing low molecular weight compound added to the image-recording layer is preferably from 0.01 to 20% by weight, more preferably from 0.05 to 10% by weight, most preferably from 0.1 to 5% by weight, based on the solid content of the image-recording layer. In the range described above, good ink-receptive property during printing is obtained.

As the oil-sensitizing agent for use in the invention, an ammonium group-containing polymer described below is also preferably exemplified. The ammonium group-containing polymer may be any polymer containing an ammonium group in its structure and is preferably a polymer containing as repeating units, a structure represented by formula (11) shown below and a structure represented by formula (12) shown below.

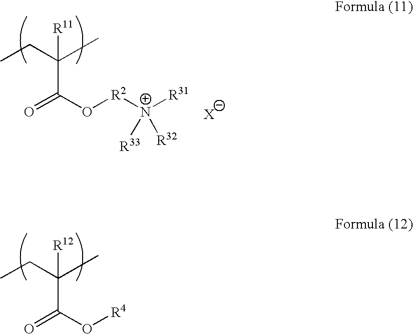

In formulae (11) and (12), R¹¹ and R¹² each independently represents a hydrogen atom or a methyl group, R² represents a divalent connecting group, for example, an alkylene group which may have a substituent or an alkyleneoxy group which may have a substituent, R³¹, R³² and R³³ each independently represents an alkyl group having from 1 to 10 carbon atoms or an aralkyl group, X⁻ represents an organic or inorganic anion, for example, F⁻, Cl⁻, Br⁻, I⁻, a benzenesulfonate anion which may have a substituent, a methylsulfate anion, an ethylsulfate anion, a propylsulfate anion, a butylsulfate anion which may be branched, an amylsulfate anion which may be branched, PF₆⁻, BF₄⁻ or B(C₆F₅)₄⁻, R⁴ represents an alkyl group having from 1 to 21 carbon atoms, an aralkyl group, an aryl group, —(C₂H₄O)ₙ—R⁵ or —(C₃H₆O)ₙ—R⁵, R⁵ represents a hydrogen atom, a methyl group or an ethyl group, and n represents 1 or 2.

The ammonium group-containing polymer includes at least one of the structural units represented by formula (11) and at least one of the structural units represented by formula (12), and it may include two or more of the structural units represented by formula (K8) or (K9) or both. A ratio of the both structural units is not particularly restricted and is particularly preferably from 5:95 to 80:20 in a molar ratio. The polymer may include other copolymerization component within a range of ensuring the effects of the invention.

As to the ammonium group-containing polymer, a reduced specific viscosity value (unit: cSt/g/ml) obtained according to the measuring method described below is preferably from 5 to 120, more preferably from 10 to 110, particularly preferably from 15 to 100.

### <Measuring Method of Reduced Specific Viscosity>

In a 20 ml measuring flask was weighed 3.33 g of a 30% by weight polymer solution (1 g as a solid content) and the measuring flask was filled up to the gauge line with N-methyl pyrrolidone. The resulting solution was put into an Ubbelohde viscometer (viscometer constant: 0.010 cSt/s) and a period for running down of the solution at 30° C. was measured. The viscosity was determined in a conventional manner according to the following calculating formula:

Kinetic viscosity=Viscometer constant×Period for liquid to pass through a capillary (sec)

The content of the ammonium group-containing polymer is preferably from 0.0005 to 30.0% by weight, more preferably from 0.001 to 20.0% by weight, most preferably from 0.002 to 15.0% by weight, based on the total solid content of the image-recording layer. In the range described above, good ink-receptive property is obtained. The ammonium group-containing polymer may further be incorporated into a protective layer.

Specific examples of the ammonium group-containing polymer are set forth below.

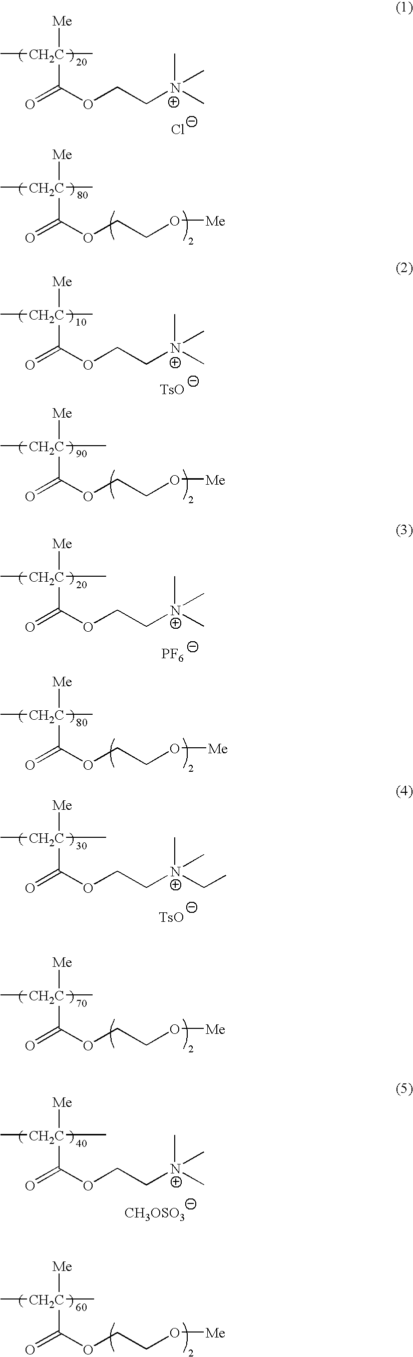

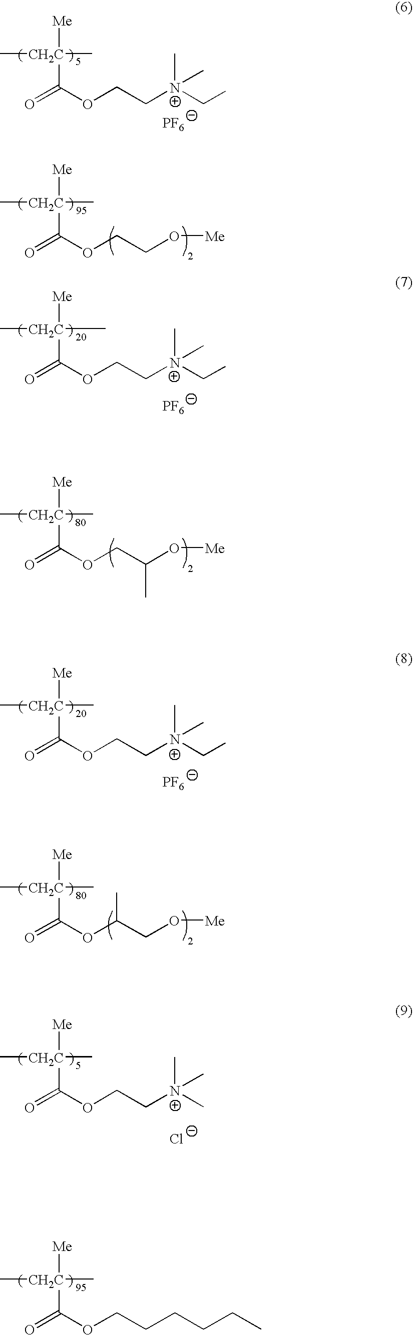

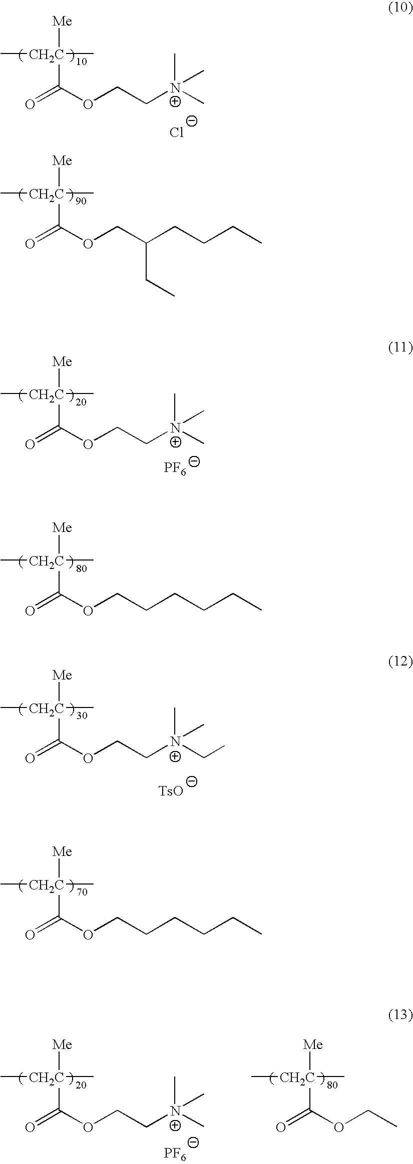

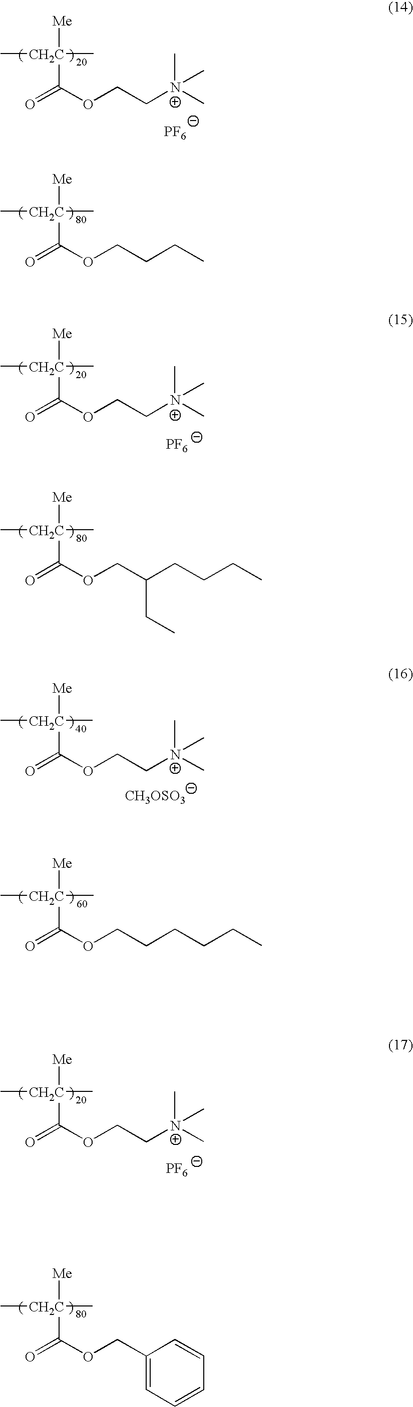

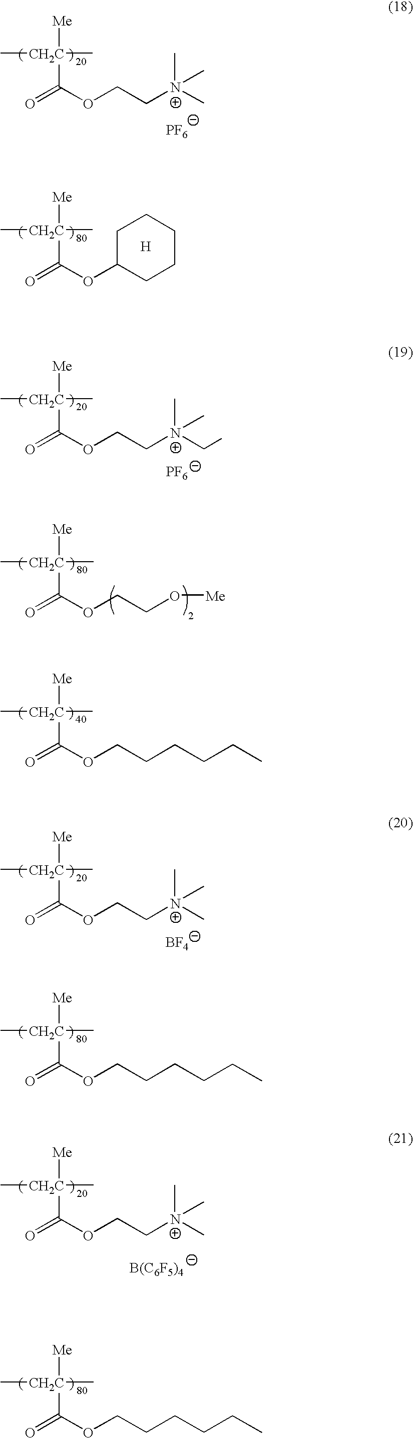

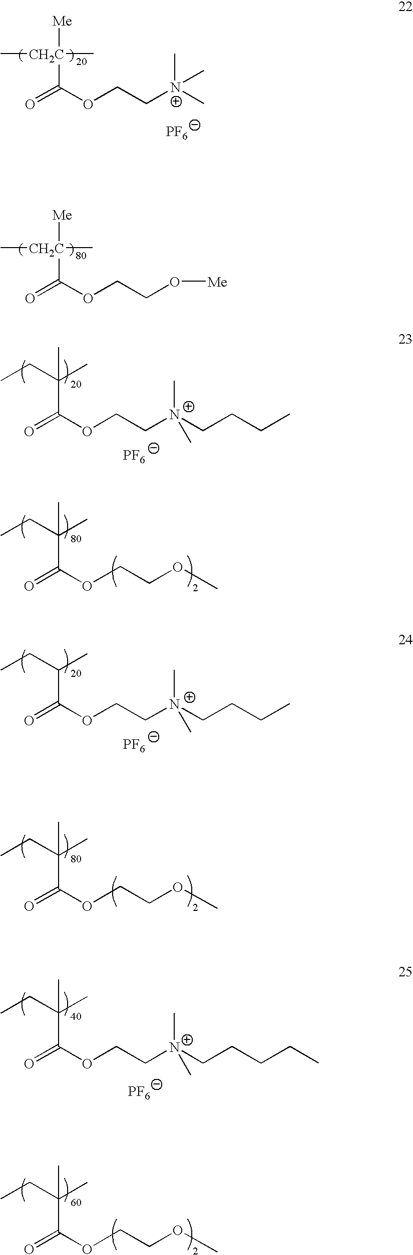

### (10) Inorganic Stratiform Compound

To the image-recording layer according to the invention, an inorganic stratiform compound which is preferably used in the protective layer described hereinafter may be added. The addition of inorganic stratiform compound to the image-recording layer is useful for improvements in printing durability, polymerization efficiency (sensitivity) and preservation stability.

The amount of the inorganic stratiform compound added to the image-recording layer is preferably from 0.1 to 50% by weight, more preferably from 0.3 to 30% by weight, most preferably from 1 to 10% by weight, based on the solid content of the image-recording layer.

### <Formation of Image-Recording Layer>

The image-recording layer according to the invention is formed by dispersing or dissolving each of the necessary constituting components described above in a solvent to prepare a coating solution and coating the solution on a support and drying.

The solvent used include, for example, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethylsulfoxide, sulfolane, γ-butyrolactone, toluene and water, but the invention should not be construed as being limited thereto. The solvents may be used individually or as a mixture. The solid content concentration of the coating solution is preferably from 1 to 50% by weight.

As to the image-recording layer according to the invention, it is also possible to form the image-recording layer of multilayer structure by preparing plural coating solutions by dispersing or dissolving the same or different constituting components described above into the same or different solvents and conducting repeatedly the coating and drying plural times.

The coating amount (solid content) of the image-recording layer formed on a support after coating and drying may be varied according to the intended purpose but is ordinarily preferably from 0.3 to 3.0 g/m². In the range described above, good sensitivity and good film property of the image-recording layer can be achieved.

Various methods can be used for the coating. Examples of the coating method include bar coater coating, spin coating, spray coating, curtain coating, dip coating, air knife coating, blade coating and roll coating.

### <Protective Layer>

In the lithographic printing plate precursor according to the invention, it is preferred to provide a protective layer (overcoat layer) on the image-recording layer.

The protective layer has a function for preventing, for example, occurrence of scratch in the image-recording layer or ablation caused by exposure with a high illuminance laser beam, in addition to the function for restraining an inhibition reaction against the image formation by means of oxygen blocking.

The components constituting the protective layer will be described below.

Ordinarily, the exposure process of a lithographic printing plate precursor is performed in the air. The image-forming reaction occurred upon the exposure process in the image-recording layer may be inhibited by a low molecular weight compound, for example, oxygen or a basic substance present in the air. The protective layer prevents the low molecular weight compound, for example, oxygen or the basic substance from penetrating into the image-recording layer and as a result, the inhibition of image-forming reaction at the exposure process in the air can be avoided. Accordingly, the property required of the protective layer is to reduce permeability of the low molecular compound, for example, oxygen. Further, the protective layer preferably has good transparency to light used for the exposure, is excellent in an adhesion property to the image-recording layer, and can be easily removed during the on-press development processing step after the exposure. With respect to the protective layer having such properties, there are described, for example, in U.S. Pat. No. 3,458,311 and JP-B-55-49729.

As a material for use in the protective layer, any water-soluble polymer and water-insoluble polymer can be appropriately selected to use. Specifically, a water-soluble polymer, for example, polyvinyl alcohol, a modified polyvinyl alcohol, polyvinyl pyrrolidone, polyvinyl imidazole, polyacrylic acid, polyacrylamide, a partially saponified product of polyvinyl acetate, an ethylene-vinyl alcohol copolymer, a water-soluble cellulose derivative, gelatin, a starch derivative or gum arabic, and a polymer, for example, polyvinylidene chloride, poly(meth)acrylonitrile, polysulfone, polyvinyl chloride, polyethylene, polycarbonate, polystyrene, polyamide or cellophane are exemplified.

The polymers may be used in combination of two or more thereof, if desired.

As a relatively useful material for use in the protective layer, a water-soluble polymer compound excellent in crystallinity is exemplified. Specifically, polyvinyl alcohol, polyvinyl pyrrolidone, polyvinyl imidazole, a water-soluble acrylic resin, for example, polyacrylic acid, gelatin or gum arabic is preferably used. Above all, polyvinyl alcohol, polyvinyl pyrrolidone and polyvinyl imidazole are more preferably used from the standpoint of capability of coating with water as a solvent and easiness of removal with dampening water at the printing. Among them, polyvinyl alcohol (PVA) provides most preferable results on the fundamental properties, for example, oxygen blocking property or removability with development.

The polyvinyl alcohol for use in the protective layer may be partially substituted with ester, ether or acetal as long as it contains a substantial amount of unsubstituted vinyl alcohol units necessary for maintaining water solubility. Also, the polyvinyl alcohol may partially contain other copolymerization components. For instance, polyvinyl alcohols of various polymerization degrees having at random a various kind of hydrophilic modified cites, for example, an anion-modified cite modified with an anion, e.g., a carboxyl group or a sulfo group, a cation-modified cite modified with a cation, e.g., an amino group or an ammonium group, a silanol-modified cite or a thiol-modified cite, and polyvinyl alcohols of various polymerization degrees having at the terminal of the polymer chain a various kind of modified cites, for example, the above-described anion-modified cite, cation modified cite, silanol-modified cite or thiol-modified cite, an alkoxy-modified cite, a sulfide-modified cite, an ester modified cite of vinyl alcohol with a various kind of organic acids, an ester modified cite of the above-described anion-modified cite with an alcohol or an epoxy-modified cite are also preferably used.

Preferable examples of the polyvinyl alcohol include those having a hydrolysis degree of 71 to 100% by mole and a polymerization degree of 300 to 2,400. Specific examples of the polyvinyl alcohol include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8, produced by Kuraray Co., Ltd.

Specific examples of the modified polyvinyl alcohol include that having an anion-modified cite, for example, KL-318, KL-118, KM-618, KM-118 or SK-5102, that having a cation-modified cite, for example, C-318, C-118 or CM-318, that having a terminal thiol-modified cite, for example, M-205 or M-115, that having a terminal sulfide-modified cite, for example, MP-103, MP-203, MP-102 or MP-202, that having an ester-modified cite with a higher fatty acid at the terminal, for example, HL-12E or HL-1203 and that having a reactive silane-modified cite, for example, R-1130, R-2105 or R-2130, all produced by Kuraray Co., Ltd.

It is also preferable that the protective layer contains an inorganic stratiform compound.

The stratiform compound is a particle having a thin tabular shape and includes, for instance, mica, for example, natural mica represented by the following formula: A (B, C)₂₋₅ D₄ O₁₀ (OH, F, O)₂, (wherein A represents any one of Li, K, Na, Ca, Mg and an organic cation, B and C each represents any one of Fe (II), Fe(III), Mn, Al, Mg and V, and D represents Si or Al) or synthetic mica, talc represented by the following formula: 3MgO.4SiO.H₂O, teniolite, montmorillonite, saponite, hectolite and zirconium phosphate.

Examples of the natural mica include muscovite, paragonite, phlogopite, biotite and lepidolite. Examples of the synthetic mica include non-swellable mica, for example, fluorphlogopite KMg₃(AlSi₃O₁₀)F₂ or potassium tetrasilic mica KMg_{2.5}(Si₄O₁₀)F₂, and swellable mica, for example, Na tetrasilic mica NaMg_{2.5}(Si₄O₁₀)F₂, Na or Li teniolite (Na, Li)Mg₂Li(Si₄O₁₀)F₂, or montmorillonite based Na or Li hectolite (Na, Li)_{1/8}Mg_{2/5}Li_{1/8}(Si₄O₁₀)F₂. Synthetic smectite is also useful.

Of the stratiform compounds, fluorine-based swellable mica, which is a synthetic stratiform compound, is particularly useful in the invention. Specifically, the swellable synthetic mica and an swellable clay mineral, for example, montmorillonite, saponite, hectolite or bentonite have a stratiform structure comprising a unit crystal lattice layer having thickness of approximately 10 to 15 angstroms, and metallic atom substitution in the lattices thereof is remarkably large in comparison with other clay minerals. As a result, the lattice layer results in lack of positive charge and to compensate it, a cation, for example, Li⁺, Na⁺, Ca²⁺, Mg²⁺ or an organic cation, e.g., an amine salt, a quaternary ammonium salt, a phosphonium salt or a sulfonium salt is adsorbed between the lattice layers. The stratiform compound swells upon contact with water. When share is applied under such condition, the stratiform crystal lattices are easily cleaved to form a stable sol in water. The bentnite and swellable synthetic mica have strongly such tendency.

The shape of the stratiform compound is, from the standpoint of control of diffusion, the thinner the thickness or the larger the plain size as long as smoothness of coated surface and transmission of actinic radiation are not damaged, the better. Therefore, an aspect ratio of the stratiform compound is ordinarily 20 or more, preferably 100 or more, particularly preferably 200 or more. The aspect ratio is a ratio of major axis to thickness of particle and can be determined, for example, from a projection drawing of particle by a microphotography. The larger the aspect ratio, the greater the effect obtained.

As for the particle diameter of the stratiform compound, an average diameter is ordinarily from 0.3 to 20 μm, preferably from 0.5 to 10 μm, particularly preferably from 1 to 5 μm. When the particle diameter is less than 0.3 μm, the inhibition of permeation of oxygen or moisture is insufficient and the effect of the stratiform compound can not be satisfactorily achieved. On the other hand, when it is larger than 20 μm, the dispersion stability of the particle in the coating solution is insufficient to cause a problem in that stable coating can not be performed. An average thickness of the particle is ordinarily 0.1 μm or less, preferably 0.05 μm or less, particularly preferably 0.01 μm or less. For example, with respect to the swellable synthetic mica that is the representative compound of the inorganic stratiform compounds, the thickness is approximately from 1 to 50 nm and the plain size is approximately from 1 to 20 μm.

When such an inorganic stratiform compound particle having a large aspect ratio is incorporated into the protective layer, strength of the coated layer increases and penetration of oxygen or moisture can be effectively inhibited and thus, the protective layer can be prevented from deterioration due to deformation, and even when the lithographic printing plate precursor is preserved for a long period of time under a high humidity condition, it is prevented from decrease in the image-forming property thereof due to the change of humidity and exhibits excellent preservation stability.

An example of common dispersing method for using the stratiform compound in the protective layer is described below.

Specifically, from 5 to 10 parts by weight of a swellable stratiform compound which is exemplified as a preferable stratiform compound is added to 100 parts by weight of water to adapt the compound to water and to be swollen, followed by dispersing using a dispersing machine. The dispersing machine used include, for example, a variety of mills conducting dispersion by directly applying mechanical power, a high-speed agitation type dispersing machine providing a large shear force and a dispersion machine providing ultrasonic energy of high intensity. Specific examples thereof include a ball mill, a sand grinder mill, a visco mill, a colloid mill, a homogenizer, a dissolver, a polytron, a homomixer, a homoblender, a keddy mill, a jet agitor, a capillary type emulsifying device, a liquid siren, an electromagnetic strain type ultrasonic generator and an emulsifying device having Polman whistle. A dispersion containing from 5 to 10% by weight of the inorganic stratiform compound thus prepared is highly viscous or gelled and exhibits extremely good preservation stability.

In the formation of a coating solution for protective layer using the dispersion, it is preferred that the dispersion is diluted with water, sufficiently stirred and then mixed with a solution of the polymer, for example, polyvinyl alcohol.

The content of the inorganic stratiform compound in the protective layer is ordinarily from 5/1 to 1/100 in terms of a weight ratio of the inorganic stratiform compound to the amount of a polymer used in the protective layer. When a plural kind of the inorganic stratiform compounds is used together, it is preferred that the total amount of the inorganic stratiform compounds is in the range of weight ratio described above.

As other additive for the protective layer, glycerin, dipropylene glycol, propionamide, cyclohexane diol, sorbitol or the like can be added in an amount corresponding to several % by weight of the water-soluble or water-insoluble polymer to impart flexibility. Also, a known additive, for example, a water-soluble (meth)acrylic polymer or a water-soluble plasticizer can be added in order to improve the physical property of the protective layer.

Further, the protective layer according to the invention is formed using a coating solution for protective layer as described below and to the coating solution for protective layer may be added known additives for increasing an adhesion property to the image-recording layer or for improving time-lapse stability of the coating solution.

Specifically, an anionic surfactant, a nonionic surfactant, a cationic surfactant or a fluorine-based surfactant can be added to the coating solution of protective layer in order to improve the coating property. More specifically, an anionic surfactant, for example, sodium alkyl sulfate or sodium alkyl sulfonate; an amphoteric surfactant, for example, alkylamino carboxylic acid salt or alkylamino dicarboxylic acid salt; or a non-ionic surfactant, for example, polyoxyethylene alkyl phenyl ether can be added. The amount of the surfactant added is from 0.1 to 100% by weight of the water-soluble or water-insoluble polymer.

Further, for the purpose of improving the adhesion property to the image-recording layer, for example, it is described in JP-A-49-70702 and BP-A-1,303,578 that sufficient adhesion can be obtained by mixing from 20 to 60% by weight of an acrylic emulsion, a water-insoluble vinyl pyrrolidone-vinyl acetate copolymer or the like in a hydrophilic polymer mainly comprising polyvinyl alcohol and coating the mixture on the image-recording layer. In the invention, any of such known techniques can be used.

Moreover, other functions can also be provided to the protective layer. For instance, by adding a coloring agent (for example, a water-soluble dye), which is excellent in permeability for infrared ray used for the exposure and capable of efficiently absorbing light at other wavelengths, a safe light adaptability can be improved without causing decrease in the sensitivity.

The formation of protective layer is performed by coating a coating solution for protective layer prepared by dispersing or dissolving the components of protective layer in a solvent on the image-recording layer, followed by drying.

The coating solvent may be appropriately selected in view of the polymer used, and when a water-soluble polymer is used, distilled water or purified water is preferably used as the solvent.

A coating method of the protective layer is not particularly limited, and known methods, for example, methods described in U.S. Pat. No. 3,458,311 and JP-B-55-49729 can be utilized.

Specifically, in the formation of the protective layer, for example, a blade coating method, an air knife coating method, a gravure coating method, a roll coating method, a spray coating method, a dip coating method or a bar coating method is used.

The coating amount of the protective layer is preferably in a range from 0.01 to 10 g/m², more preferably in a range from 0.02 to 3 g/m², most preferably in a range from 0.02 to 1 g/m², in terms of the coating amount after drying.

### <Support>

The support for use in the lithographic printing plate precursor according to the invention may have a hydrophilic surface on which at least an image-recording layer is provided, and is not particularly restricted as long as it is a dimensionally stable plate-like material. The support includes, for example, paper, paper laminated with plastic (for example, polyethylene, polypropylene or polystyrene), a metal plate (for example, aluminum, zinc or copper plate), a plastic film (for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate or polyvinyl acetal film) and paper or a plastic film laminated or deposited with the metal described above. Preferable examples of the support include a polyester film and an aluminum plate. Among them, the aluminum plate is preferred since it has good dimensional stability and is relatively inexpensive.

The aluminum plate includes a pure aluminum plate, an alloy plate comprising aluminum as a main component and containing a trace amount of hetero elements and a thin film of aluminum or aluminum alloy laminated with plastic. The hetero element contained in the aluminum alloy includes, for example, silicon, iron, manganese, copper, magnesium, chromium, zinc, bismuth, nickel and titanium. The content of the hetero element in the aluminum alloy is preferably 10% by weight or less. Although a pure aluminum plate is preferred in the invention, since completely pure aluminum is difficult to be produced in view of the refining technique, the aluminum plate may slightly contain the hetero element. The composition is not specified for the aluminum plate and those materials conventionally known and used can be appropriately utilized.

In advance of the use of aluminum plate, a surface treatment, for example, roughening treatment or anodizing treatment is preferably performed. The surface treatment facilitates improvement in the hydrophilic property and ensure for adhesion property between the image-recording layer and the support. Prior to the roughening treatment of the aluminum plate, a degreasing treatment, for example, with a surfactant, an organic solvent or an aqueous alkaline solution is conducted for removing rolling oil on the surface thereof, if desired.

The roughening treatment of the surface of the aluminum plate is conducted by various methods and includes, for example, mechanical roughening treatment, electrochemical roughening treatment (roughening treatment of electrochemically dissolving the surface) and chemical roughening treatment (roughening treatment of chemically dissolving the surface selectively).

As the method of the mechanical roughening treatment, a known method, for example, ball graining, brush graining, blast graining or buff graining can be used. Also, a transfer method can be employed wherein using a roll having concavo-convex shape the concavo-convex shape is transferred to the surface of aluminum plate during a rolling step of the aluminum plate.

The electrochemical roughening treatment method includes, for example, a method of conducting by passing alternating current or direct current in an electrolytic solution containing an acid, for example, hydrochloric acid or nitric acid. Also, a method of using a mixed acid described in JP-A-54-63902 can be exemplified.

The aluminum plate subjected to the roughening treatment is subjected, if desired, to an alkali etching treatment using an aqueous solution, for example, of potassium hydroxide or sodium hydroxide and further subjected to a neutralizing treatment, and then subjected to an anodizing treatment for improving the abrasion resistance, if desired.

As the electrolyte used for the anodizing treatment of the aluminum plate, various electrolytes capable of forming porous oxide film can be used. Ordinarily, sulfuric acid, hydrochloric acid, oxalic acid, chromic acid or a mixed acid thereof is used. The concentration of the electrolyte can be appropriately determined depending on the kind of the electrolyte used.

Since the conditions for the anodizing treatment are varied depending on the electrolyte used, they cannot be defined commonly. However, it is ordinarily preferred that electrolyte concentration in the solution is from 1 to 80% by weight, liquid temperature is from 5 to 70° C., current density is from 5 to 60 A/dm², voltage is from 1 to 100 V, and electrolysis time is from 10 seconds to 5 minutes. The amount of the anodized film formed is preferably from 1.0 to 5.0 g/m², more preferably from 1.5 to 4.0 g/m². In the range described above, good printing durability and good scratch resistance in the non-image area of lithographic printing plate can be achieved.

The aluminum plate subjected to the surface treatment and having the anodized film as described above is used as it is as the support in the invention. However, in order to more improve the adhesion property to a layer provided thereon, hydrophilicity, stain resistance, heat insulating property or the like, other treatment, for example, an enlarging treatment of micropores or a sealing treatment of micropores of the anodized film described in JP-A-2001-253181 and JP-A-2001-322365, or a surface hydrophilizing treatment by immersing in an aqueous solution containing a hydrophilic compound may be appropriately conducted. Needless to say, the enlarging treatment and sealing treatment are not limited to those described in the above-described patents and any conventionally known method may be employed. For instance, as the sealing treatment, as well as a sealing treatment with steam, a sealing treatment with fluorozirconic acid alone, a sealing treatment with sodium fluoride or a sealing treatment with steam having added thereto lithium chloride may be employed.

The sealing treatment for use in the invention is not particularly limited and conventionally known methods can be employed. Among them, a sealing treatment with an aqueous solution containing an inorganic fluorine compound, a sealing treatment with water vapor and a sealing treatment with hot water are preferred. The sealing treatments will be described in more detail below, respectively.

<1> Sealing Treatment with Aqueous Solution Containing Inorganic Fluorine Compound

As the inorganic fluorine compound used in the sealing treatment with an aqueous solution containing an inorganic fluorine compound, a metal fluoride is preferably exemplified.

Specific examples thereof include sodium fluoride, potassium fluoride, calcium fluoride, magnesium fluoride, sodium fluorozirconate, potassium fluorozirconate, sodium fluorotitanate, potassium fluorotitanate, ammonium fluorozirconate, ammonium fluorotitanate, fluorozirconic acid, fluorotitanic acid, hexafluorosilicic acid, nickel fluoride, iron fluoride, fluorophosphoric acid and ammonium fluorophosphate. Among them, sodium fluorozirconate, sodium fluorotitanate, fluorozirconic acid and fluorotitanic acid are preferred.

The concentration of the inorganic fluorine compound in the aqueous solution is preferably 0.01% by weight or more, more preferably 0.05% by weight or more, in view of performing satisfactory sealing of micropores of the anodized film, and it is preferably 1% by weight or less, more preferably 0.5% by weight or less, in view of the stain resistance.

The aqueous solution containing an inorganic fluorine compound preferably further contains a phosphate compound. When the phosphate compound is contained, the hydrophilicity on the anodized film surface is increased and thus, the on-press development property and stain resistance can be improved.

Preferable examples of the phosphate compound include phosphates of metal, for example, an alkali metal or an alkaline earth metal.

Specific examples of the phosphate compound include zinc phosphate, aluminum phosphate, ammonium phosphate, diammonium hydrogen phosphate, ammonium dihydrogen phosphate, monoammonium phosphate, monopotassium phosphate, monosodium phosphate, potassium dihydrogen phosphate, dipotassium hydrogen phosphate, calcium phosphate, sodium ammonium hydrogen phosphate, magnesium hydrogen phosphate, magnesium phosphate, ferrous phosphate, ferric phosphate, sodium dihydrogen phosphate, sodium phosphate, disodium hydrogen phosphate, lead phosphate, diammonium phosphate, calcium dihydrogen phosphate, lithium phosphate, phosphotungstic acid, ammonium phosphotungstate, sodium phosphotungstate, ammonium phosphomolybdate, sodium phosphomolybdate, sodium phosphite, sodium tripolyphosphate and sodium pyrophosphate. Among them, sodium dihydrogen phosphate, disodium hydrogen phosphate, potassium dihydrogen phosphate and dipotassium hydrogen phosphate are preferred.

The combination of inorganic fluorine compound and phosphate compound is not particularly limited, but it is preferred that the aqueous solution contains at least sodium fluorozirconate as the inorganic fluorine compound and at least sodium dihydrogen phosphate as the phosphate compound.

The concentration of the phosphate compound in the aqueous solution is preferably 0.01% by weight or more, more preferably 0.1% by weight or more, in view of improvement in the on-press development property and stain resistance, and it is preferably 20% by weight or less, more preferably 5% by weight or less, in view of solubility.

The ratio of respective compounds in the aqueous solution is not particularly limited, and the weight ratio between the inorganic fluorine compound and the phosphate compound is preferably from 1/200 to 10/1, more preferably from 1/30 to 2/1.

The temperature of the aqueous solution is preferably 20° C. or more, more preferably 40° C. or more, and it is preferably 100° C. or less, more preferably 80° C. or less.

The pH of the aqueous solution is preferably 1 or more, more preferably 2 or more, and it is preferably 11 or less, more preferably 5 or less.

A method of the sealing treatment with the aqueous solution containing an inorganic fluorine compound is not particularly limited and examples thereof include a dipping method and a spray method. One of the treatments may be used alone once or multiple times, or two or more thereof may be used in combination.

In particular, the dipping method is preferred. In the case of performing the treatment using the dipping method, the treating time is preferably one second or more, more preferably 3 seconds or more, and it is preferably 100 seconds or less, more preferably 20 seconds or less.

<2> Sealing Treatment with Water Vapor

Examples of the sealing treatment with water vapor include a method of continuously or discontinuously bringing water vapor under applied pressure or normal pressure into contact with the anodized film.

The temperature of the water vapor is preferably 80° C. or more, more preferably 95° C. or more, and it is preferably 105° C. or less.

The pressure of the water vapor is preferably in a range from (atmospheric pressure −50 mmAg) to (atmospheric pressure +300 mmAg) (from 1.008×10⁵ to 1.043×10⁵ Pa).

The time period for which water vapor is contacted is preferably one second or more, more preferably 3 seconds or more, and it is preferably 100 seconds or less, more preferably 20 seconds or less.

<3> Sealing Treatment with Hot Water

Examples of the sealing treatment with hot water include a method of dipping the aluminum plate having formed thereon the anodized film in hot water.

The hot water may contain an inorganic salt (for example, a phosphate) or an organic salt.

The temperature of the hot water is preferably 80° C. or more, more preferably 95° C. or more, and it is preferably 100° C. or less.

The time period for which the aluminum plate is dipped in the hot water is preferably one second or more, more preferably 3 seconds or more, and it is preferably 100 seconds or less, more preferably 20 seconds or less.

The hydrophilizing treatment includes an alkali metal silicate method described in U.S. Pat. Nos. 2,714,066, 3,181,461, 3,280,734 and 3,902,734. In the method, the support is subjected to immersion treatment or electrolytic treatment in an aqueous solution containing, for example, sodium silicate. In addition, the hydrophilizing treatment includes, for example, a method of treating with potassium fluorozirconate described in JP-B-36-22063 and a method of treating with polyvinyl phosphonic acid described in U.S. Pat. Nos. 3,276,868, 4,153,461 and 4,689,272.

As the support for use in the invention, a support subjected to immersion treatment, for example, with an aqueous of sodium silicate, as the hydrophilizing treatment, to attach Si atom on the surface thereof is preferably used. A support having 8 mg/m² or more of Si atom attached on its surface is particularly preferably used. The upper limit of the attachment amount of Si atom is 15 mg/m², and preferably 12 mg/m². The attachment amount of Si atom can be determined by fluorescent X-ray measurement.

As the amount of Si atom attached on the surface of support increases, the hydrophilicity ordinarily increases but water is apt to penetrate into an interface between the support and the image-recording layer. As a result, a problem of decreasing printing durability and a problem in that when the surface of image area is scratched after image exposure, the scratch is reproduced on a printed material may occur in some cases.

In case of using the image-recording layer according to the invention, however, since the printing durability is improved, degradation of printing durability can be restrained even when the support of high hydrophilicity having 8 mg/m² or more of Si atom attached on surface thereof is used.

In the case of using a support having a surface of insufficient hydrophilicity, for example, a polyester film, in the invention, it is desirable to coat a hydrophilic layer thereon to make the surface sufficiently hydrophilic. Examples of the hydrophilic layer preferably includes a hydrophilic layer formed by coating a coating solution containing a colloid of oxide or hydroxide of at least one element selected from beryllium, magnesium, aluminum, silicon, titanium, boron, germanium, tin, zirconium, iron, vanadium, antimony and a transition metal described in JP-A-2001-199175, a hydrophilic layer containing an organic hydrophilic matrix obtained by crosslinking or pseudo-crosslinking of an organic hydrophilic polymer described in JP-A-2002-79772, a hydrophilic layer containing an inorganic hydrophilic matrix obtained by sol-gel conversion comprising hydrolysis and condensation reaction of polyalkoxysilane and titanate, zirconate or aluminate, and a hydrophilic layer comprising an inorganic thin layer having a surface containing metal oxide. Among them, the hydrophilic layer formed by coating a coating solution containing a colloid of oxide or hydroxide of silicon is preferred.

Further, in the case of using, for example, a polyester film as the support in the invention, it is preferred to provide an antistatic layer on the hydrophilic layer side, opposite side to the hydrophilic layer or both sides of the support. When the antistatic layer is provided between the support and the hydrophilic layer, it also contributes to improve the adhesion property of the hydrophilic layer to the support. As the antistatic layer, a polymer layer having fine particles of metal oxide or a matting agent dispersed therein described in JP-A-2002-79772 can be used.

The support preferably has a center line average roughness of 0.10 to 1.2 μm. In the range described above, good adhesion property to the image-recording layer, good printing durability and good stain resistance can be achieved.

The thickness of the support is preferably from 0.1 to 0.6 mm, and more preferably from 0.15 to 0.4 mm.

### <Backcoat Layer>

After applying the surface treatment to the support or forming the undercoat layer (described hereinafter) on the support, a backcoat layer can be provided on the back surface of the support, if desired.

The backcoat layer preferably includes, for example, a coating layer comprising an organic polymer compound described in JP-A-5-45885 and a coating layer comprising a metal oxide obtained by hydrolysis and polycondensation of an organic metal compound or an inorganic metal compound described in JP-A-6-34174. Among them, use of an alkoxy compound of silicon, for example, Si(OCH₃)₄, Si(OC₂H₅)₄, Si(OC₃H₇)₄ or Si(OC₄H₉)₄ is preferred since the starting materials are inexpensive and easily available.

### <Undercoat Layer>

In the lithographic printing plate precursor according to the invention, an undercoat layer is provided between the support and the image-recording layer, if desired.

The undercoat layer strengthens adhesion between the support and the image-recording layer in the exposed area and makes removal of the image-recording layer from the support easy in the unexposed area, thereby improving the on-press development property. Further, it is advantageous that in the case of infrared laser exposure, since the undercoat layer acts as a heat insulating layer, heat generated upon the exposure does not diffuse into the support and is efficiently utilized and as a result, the increase in sensitivity can be achieved.

As a compound for undercoat layer, specifically, for example, a silane coupling agent having an addition-polymerizable ethylenic double bond reactive group described in JP-A-10-282679 and a phosphorus compound having an ethylenic double bond reactive group described in JP-A-2-304441 are preferably exemplified.

As the most preferable compound for undercoat layer, a polymer resin having an adsorbing group, a hydrophilic group and a crosslinkable group is exemplified. The polymer resin is preferably obtained by copolymerization of a monomer having an adsorbing group, a monomer having a hydrophilic group and a monomer having a crosslinkable group.

The polymer resin for undercoat layer preferably has an adsorbing group to the hydrophilic surface of support. Whether adsorptivity to the hydrophilic surface of support is present or not can be judged, for example, by the following method.

A test compound is dissolved in an easily soluble solvent to prepare a coating solution, and the coating solution is coated and dried on a support so as to have the coating amount after drying of 30 mg/m². After thoroughly washing the support coated with the test compound using the easily soluble solvent, the residual amount of the test compound that has not been removed by the washing is measured to calculate the adsorption amount of the test compound to the support. For measuring the residual amount, the residual amount of the test compound may be directly determined, or may be calculated by determining the amount of the test compound dissolved in the washing solution. The determination for the test compound can be performed, for example, by X-ray fluorescence spectrometry measurement, reflection absorption spectrometry measurement or liquid chromatography measurement. The compound having the adsorptivity to support is a compound that remains by 1 mg/m² or more even after conducting the washing treatment described above.

The adsorbing group to the hydrophilic surface of support is a functional group capable of forming a chemical bond (for example, an ionic bond, a hydrogen bond, a coordinate bond or a bond with intermolecular force) with a substance (for example, metal or metal oxide) or a functional group (for example, a hydroxy group) present on the hydrophilic surface of support. The adsorbing group is preferably an acid group or a cationic group.

The acid group preferably has an acid dissociation constant (pKa) of 7 or less. Examples of the acid group include a phenolic hydroxy group, a carboxyl group, —SO₃H, —OSO₃H, —PO₃H₂, —OPO₃H₂, —CONHSO₂—, —SO₂NHSO₂— and —COCH₂COCH₃. Among them, —OPO₃H₂ and —PO₃H₂ are particularly preferred. The acid group may be the form of a metal salt.

The cationic group is preferably an onium group. Examples of the onium group include an ammonium group, a phosphonium group, an arsonium group, a stibonium group, an oxonium group, a sulfonium group, a selenonium group, a stannonium group and iodonium group. Among them, the ammonium group, phosphonium group and sulfonium group are preferred, the ammonium group and phosphonium group are more preferred, and the ammonium group is most preferred.

Particularly preferable examples of the monomer having the adsorbing group which can be used in synthesis of the polymer resin suitable for the compound for undercoat layer include a compound represented by the following formula (U1) or (U2):

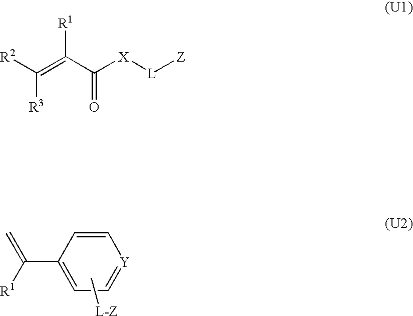

In formulae (U1) and (U2), R¹, R² and R³ each independently represents a hydrogen atom, halogen atom or an alkyl group having from 1 to 6 carbon atoms.

R¹, R² and R³ each independently represents preferably a hydrogen atom or an alkyl group having from 1 to 6 carbon atoms, more preferably a hydrogen atom or an alkyl group having from 1 to 3 carbon atoms, most preferably a hydrogen atom or a methyl group. It is particularly preferred that R² and R³ each represents a hydrogen atom.

Z represents a functional group adsorbing to the hydrophilic surface of support. With respect to the adsorbing functional group, the above description on the adsorbing group can be referred to.

In formulae (U1) and (U2), L represents a single bond or a divalent connecting group. It is preferred that L represents a divalent aliphatic group (for example, an alkylene group, a substituted alkylene group, an alkenylene group, a substituted alkenylene group, an alkinylene group or a substituted alkinylene group), a divalent aromatic group (for example, an arylene group or a substituted arylene group), a divalent heterocyclic group or a combination of each of these groups with an oxygen atom (—O—), a sulfur atom (—S—), an imino group (—NH—), a substituted imino group (—NR—, where R represents an aliphatic group, an aromatic group or a heterocyclic group) or a carbonyl group (—CO—).

The divalent aliphatic group may have a cyclic structure or a branched structure. The number of carbon atoms of the divalent aliphatic group is preferably from 1 to 20, more preferably from 1 to 15, most preferably from 1 to 10. It is preferred that the divalent aliphatic group is a saturated aliphatic group rather than an unsaturated aliphatic group. The divalent aliphatic group may have a substituent. Examples of the substituent include a halogen atom, a hydroxy group, an aromatic group and a heterocyclic group.

The number of carbon atoms of the divalent aromatic group is preferably from 6 to 20, more preferably from 6 to 15, most preferably from 6 to 10. The divalent aromatic group may have a substituent. Examples of the substituent include a halogen atom, a hydroxy group, an aliphatic group, an aromatic group and a heterocyclic group.

It is preferred that the divalent heterocyclic group has a 5-membered or 6-membered ring as the hetero ring. Other heterocyclic ring, an aliphatic ring or an aromatic ring may be condensed to the heterocyclic ring. The divalent heterocyclic group may have a substituent. Examples of the substituent include a halogen atom, a hydroxy group, an oxo group (═O), a thioxo group (═S), an imino group (═NH), a substituted imino group (═N—R, where R represents an aliphatic group, an aromatic group or a heterocyclic group), an aliphatic group, an aromatic group and a heterocyclic group.

It is preferred that L represents a divalent connecting group containing a plurality of polyoxyalkylene structures in the invention. It is more preferred that the polyoxyalkylene structure is a polyoxyethylene structure. Specifically, it is preferred that L contains —(OCH₂CH₂)ₙ— (n is an integer of 2 or more).

In formula (U1), X represents an oxygen atom (—O—) or imino group (—NH—). Preferably, X represents an oxygen atom.

In formula (U2), Y represents a carbon atom or a nitrogen atom. In the case where Y is a nitrogen atom and L is connected to Y to form a quaternary pyridinium group, Z is not mandatory and may represents a hydrogen atom because the quaternary pyridinium group itself exhibits the adsorptivity.

Representative examples of the compound represented by formula (U1) or (U2) are set forth below.

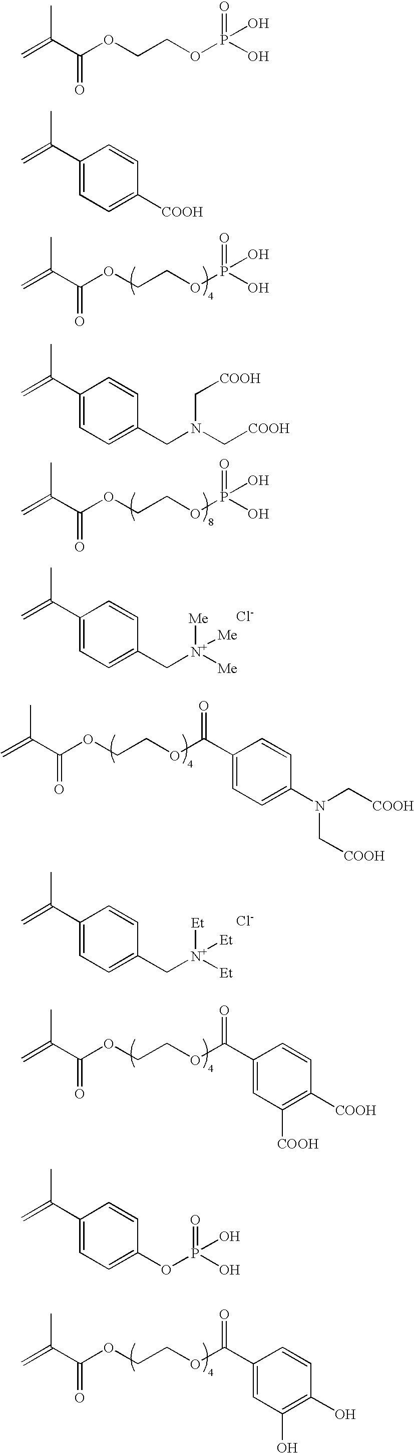

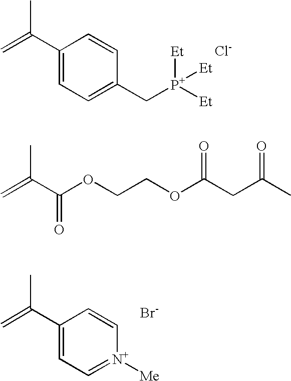

The polymer resin suitable for the compound for undercoat layer preferably has a hydrophilic group. The hydrophilic group preferably includes, for example, a hydroxy group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfo group and a phosphoric acid group. Among them, a sulfo group exhibiting a highly hydrophilic property is preferable.

Specific examples of the monomer having a sulfo group include a sodium salt or amine salt of methallyloxybenzenesulfonic acid, allyloxybenzenesulfonic acid, allylsulfonic acid, vinylsulfonic acid, p-styrenesulfonic acid, methallylsulfonic acid, acrylamido-tert-butylsulfonic acid, 2-acrylamido-2-methylpropanesulfonic acid or (3-acryloyloxypropyl)buthylsulfonic acid. Among them, from the standpoint of the hydrophilic property and handling property in the synthesis thereof, sodium salt of 2-acrylamido-2-methylpropanesulfonic acid is preferable.

Such a monomer is preferably used in the synthesis of the polymer resin suitable for the compound for undercoat layer.

The polymer resin for undercoat layer according to the invention preferably has a crosslinkable group. The crosslinkable group acts to improve the adhesion property to the image area. In order to impart the crosslinking property to the polymer resin for undercoat layer, introduction of a crosslinkable functional group, for example, an ethylenically unsaturated bond into the side chain of the polymer or introduction by formation of a salt structure between a polar substituent of the polymer resin and a compound containing a substituent having a counter charge to the polar substituent of the polymer resin and an ethylenically unsaturated bond is used.

Examples of the polymer having the ethylenically unsaturated bond in the side chain thereof include a polymer of an ester or amide of acrylic acid or methacrylic acid, wherein the ester or amide residue (R in —COOR or —CONHR) has the ethylenically unsaturated bond.

Examples of the residue (R described above) having an ethylenically unsaturated bond include —(CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X (wherein R¹ to R³ each represents a hydrogen atom, a halogen atom or an alkyl group having from 1 to 20 carbon atoms, an aryl group, alkoxy group or aryloxy group, or R¹ and R² or R¹ and R³ may be combined with each other to form a ring. n represents an integer of 1 to 10. X represents a dicyclopentadienyl residue).

Specific examples of the ester residue include —CH₂CH═CH₂ (described in JP-B-7-21633) —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂NHCOO—CH₂CH═CH₂ and —CH₂CH₂O—X (wherein X represents a dicyclopentadienyl residue).

Specific examples of the amide residue include —CH₂CH═CH₂, —CH₂CH₂O—Y (wherein Y represents a cyclohexene residue) and —CH₂CH₂OCO—CH═CH₂.

As a monomer having a crosslinkable group for the polymer resin for undercoat layer, an ester or amide of acrylic acid or methacrylic acid having the crosslinkable group described above is preferably used.

The content of the crosslinkable group (content of the radical polymerizable unsaturated double bond determined by iodine titration) in the polymer resin for undercoat layer is preferably from 0.1 to 10.0 mmol, more preferably from 1.0 to 7.0 mmol, most preferably from 2.0 to 5.5 mmol, based on 1 g of the polymer resin. In the range described above, preferable compatibility between the sensitivity and stain resistance and good preservation stability can be achieved.

The weight average molecular weight (Mw) of the polymer resin for undercoat layer is preferably 5,000 or more, more preferably from 10,000 to 300,000. The number average molecular weight (Mn) of the polymer resin is preferably 1,000 or more, more preferably from 2,000 to 250,000. The polydispersity (weight average molecular weight/number average molecular weight) thereof is preferably from 1.1 to 10.

The polymer resin for undercoat layer may be any of a random polymer, a block polymer, a graft polymer and the like, and is preferably a random polymer.

The polymer resins for undercoat layer may be used individually or in combination of two or more thereof.

A coating solution for undercoat layer is obtained by dissolving the polymer resin for undercoat layer in an organic solvent (for example, methanol, ethanol, acetone or methyl ethyl ketone) and/or water.

The coating solution for undercoat layer may contain an infrared absorbing agent.

In order to coat the coating solution for undercoat layer on the support, various known methods can be used. Examples of the method include bar coater coating, spin coating, spray coating, curtain coating, dip coating, air knife coating, blade coating and roll coating.

The coating amount (solid content) of the undercoat layer is preferably from 0.1 to 100 mg/m², and more preferably from 1 to 30 mg/m².

### <<Printing Method>>

The printing method in the case where the image-recording layer of the lithographic printing plate precursor according to the invention is capable of being subjected to on-press development is described below.

The printing method according to the invention comprises a step of exposing imagewise the lithographic printing plate precursor according to the invention described above and a printing step by supplying printing ink and dampening water to perform printing without undergoing any development processing of the exposed lithographic printing plate precursor, whereby the unexposed area of the lithographic printing plate precursor is removed in the course of the printing step.

The printing method according to the invention will be described in more detail below.

As the light source used for the imagewise exposure in the invention, a laser is preferable. The laser for use in the invention is not particularly restricted and preferably includes, for example, a solid laser or semiconductor laser emitting an infrared ray having a wavelength of 760 to 1,200 nm and a semiconductor laser emitting light having a wavelength of 250 to 420 nm.

With respect to the infrared ray laser, the output is preferably 100 mW or more, the exposure time per pixel is preferably within 20 microseconds, and the irradiation energy is preferably from 10 to 300 mJ/cm². With respect to the semiconductor laser emitting light having a wavelength of 250 to 420 nm, the output is preferably 0.1 mW or more. In case of using any laser, in order to shorten the exposure time, it is preferred to use a multibeam laser device.

The exposed lithographic printing plate precursor is mounted on a plate cylinder of a printing machine. In case of using a printing machine equipped with a laser exposure apparatus, the lithographic printing plate precursor is mounted on a plate cylinder of the printing machine and then subjected to the imagewise exposure.

After the imagewise exposure of the lithographic printing plate precursor, for example, by an infrared laser, when printing ink and dampening water are supplied to perform printing without undergoing a development processing step, for example, a wet development processing step, in the exposed area of the image-recording layer, the image-recording layer cured by the exposure forms the printing ink receptive area having the oleophilic surface. On the other hand, in the unexposed area, the uncured image-recording layer is removed by dissolution or dispersion with the dampening water and/or printing ink supplied to reveal the hydrophilic surface in the area. As a result, the dampening water adheres on the revealed hydrophilic surface and the printing ink adheres to the exposed area of the image-recording layer, whereby printing is initiated.

While either the dampening water or printing ink may be supplied at first on the surface of lithographic printing plate precursor, it is preferred to supply the printing ink at first in view of preventing the dampening water from contamination with the constituting component of the image-recording layer removed. As the dampening water and printing ink, dampening water and printing ink for conventional lithographic printing can be used, respectively.

Thus, the lithographic printing plate precursor is subjected to the on-press development on an offset printing machine and used as it is for printing a large number of sheets.

In the case where the lithographic printing plate precursor according to the invention is unable to be subjected to the on-press development as described above but requires a development processing step, for example, a wet type development processing step, the development processing is performed between the exposure step and the printing step.

The development processing which can be applied to the invention is determined according to the image-recording layer and it is preferred that the lithographic printing plate precursor according to the invention is subjected to the development processing described below.

### (Development Processing)

The developer for use in the invention is preferably an aqueous solution having pH of 2 to 10. The developer is preferably, for example, water alone or an aqueous solution containing water as a main component (containing 60% by weight or more of water). Particularly, an aqueous solution having the composition similar to that of conventionally known dampening water, an aqueous solution containing a surfactant (for example, an anionic, nonionic or cationic surfactant) and an aqueous solution containing a water-soluble polymer compound are preferable. An aqueous solution containing both the surfactant and the water-soluble polymer compound is especially preferable. The pH of the developer is more preferably from 3 to 8, and still more preferably a weak acidic of 4 to 6.9.

The components capable of being included in the developer are described in detail below.

The anionic surfactant for use in the developer includes, for example, fatty acid salts, abietic acid salts, hydroxyalkanesulfonic acid salts, alkanesulfonic acid salts, dialkylsulfosuccinic acid salts, straight-chain alkylbenzenesulfonic acid salts, branched alkylbenzenesulfonic acid salts, alkylnaphthalenesulfonic acid salts, alkylphenoxypolyoxy ethylene propylsulfonic acid salts, polyoxyethylene alkylsulfophenyl ether salts, N-methyl-N-oleyltaurine sodium salt, N-allylsulfosuccinic acid monoamide disodium salts, petroleum sulfonic acid salts, sulfated castor oil, sulfated beef tallow oil, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styryl phenyl ether sulfate ester salts, alkyl phosphate ester salts, polyoxyethylene alkyl ether phosphate ester salts, polyoxyethylene alkyl phenyl ether phosphate ester salts, partially saponified products of styrene-maleic anhydride copolymer, partially saponified products of olefin-maleic anhydride copolymer and naphthalene sulfonate formalin condensates. Of the compounds, dialkylsulfosuccinic acid salts, alkyl sulfate ester salts and alkylnaphthalenesulfonic acid salts are particularly preferably used.

The cationic surfactant for use in the developer is not particularly limited and conventionally known cationic surfactants can be used. Examples of the cationic surfactant include alkylamine salts, quaternary ammonium salts, polyoxyethylene alkyl amine salts and polyethylene polyamine derivatives.

The nonionic surfactant for use in the developer includes, for example, polyethylene glycol type higher alcohol ethylene oxide addacts, alkylphenol ethylene oxide addacts, fatty acid ethylene oxide addacts, polyhydric alcohol fatty acid ester ethylene oxide addacts, higher alkylamine ethylene oxide addacts, fatty acid amide ethylene oxide addacts, ethylene oxide addacts of fat, polypropylene glycol ethylene oxide addacts, dimethylsiloxane-ethylene oxide block copolymers, dimethylsiloxane-(propylene oxide-ethylene oxide) block copolymers, fatty acid esters of polyhydric alcohol type glycerol, fatty acid esters of pentaerythritol, fatty acid esters of sorbitol and sorbitan, fatty acid esters of sucrose, alkyl ethers of polyhydric alcohols and fatty acid amides of alkanolamines.

The nonionic surfactants may be used individually or as a mixture of two or more thereof. In the invention, ethylene oxide addacts of sorbitol and/or sorbitan fatty acid esters, polypropylene glycol ethylene oxide addacts, dimethylsiloxane-ethylene oxide block copolymers, dimethylsiloxane-(propylene oxide-ethylene oxide) block copolymers and fatty acid esters of polyhydric alcohols are more preferable.

Further, from the standpoint of stable solubility in water or opacity, with respect to the nonionic surfactant used in the developer according to the invention, the HLB (hydrophile-lipophile balance) value thereof is preferably 6 or more, more preferably 8 or more. The content of the nonionic surfactant in the developer is preferably from 0.01 to 10% by weight, and more preferably from 0.01 to 5% by weight.

Furthermore, an oxyethylene adduct of acetylene glycol type or acetylene alcohol type or a surfactant, for example, a fluorine-based surfactant or a silicon-based surfactant can also be used.

Of the surfactants used in the developer according to the invention, the nonionic surfactant is particularly preferable in view of foam depressing property.

The water-soluble polymer compound for use in the developer according to the invention includes, for example, soybean polysaccharide, modified starch, gum arabic, dextrin, a cellulose derivative (for example, carboxymethyl cellulose, carboxyethyl cellulose or methyl cellulose) or a modified product thereof, pllulan, polyvinyl alcohol or a derivative thereof, polyvinyl pyrrolidone, polyacrylamide, an acrylamide copolymer, a vinyl methyl ether/maleic anhydride copolymer, a vinyl acetate/maleic anhydride copolymer and a styrene/maleic anhydride copolymer.

As the soybean polysaccharide, those known can be used. For example, as a commercial product, Soyafive (trade name, produced by Fuji Oil Co., Ltd.) is available and various grade products can be used. The soybean polysaccharide preferably used has viscosity in a range from 10 to 100 mPa/sec in a 10% by weight aqueous solution thereof.

As the modified starch, known modified starch can be used. The modified starch can be prepared, for example, by a method wherein starch, for example, of corn, potato, tapioca, rice or wheat is decomposed, for example, with an acid or an enzyme to an extent that the number of glucose residue per molecule is from 5 to 30 and then oxypropylene is added thereto in an alkali.

Two or more of the water-soluble polymer compounds may be used in combination. The content of the water-soluble polymer compound in the developer is preferably from 0.1 to 20% by weight, more preferably from 0.5 to 10% by weight.

The developer according to the invention may contain an organic solvent. The organic solvent that can be contained in the developer include, for example, an aliphatic hydrocarbon (e.g., hexane, heptane, Isopar E, Isopar H, Isopar G (produced by Esso Chemical Co., Ltd.), gasoline or kerosene), an aromatic hydrocarbon (e.g., toluene or xylene), a halogenated hydrocarbon (methylene dichloride, ethylene dichloride, trichlene or monochlorobenzene) and a polar solvent.

Examples of the polar solvent include an alcohol (e.g., methanol, ethanol, propanol, isopropanol, benzyl alcohol, ethylene glycol monomethyl ether, 2-ethyoxyethanol, diethylene glycol monoethyl ether, diethylene glycol monohexyl ether, triethylene glycol monomethyl ether, propylene glycol monoethyl ether, propylene glycol monomethyl ether, polyethylene glycol monomethyl ether, polypropylene glycol, tetraethylene glycol, ethylene glycol monobutyl ether, ethylene glycol monobenzyl ether, ethylene glycol monophenyl ether, methyl phenyl carbinol, n-amyl alcohol or methylamyl alcohol), a ketone (e.g., acetone, methyl ethyl ketone, ethyl butyl ketone, methyl isobutyl ketone or cyclohexanone), an ester (e.g., ethyl acetate, propyl acetate, butyl acetate, amyl acetate, benzyl acetate, methyl lactate, butyl lactate, ethylene glycol monobutyl acetate, polyethylene glycol monomethyl ether acetate, diethylene glycol acetate, diethyl phthalate or butyl levulinate) and others (e.g., triethyl phosphate, tricresyl phosphate, N-phenylethanolamine or N-phenyldiethanolamine).

When the organic solvent is insoluble in water, it may be employed by being solubilized in water using a surfactant or the like. In the case where the developer contains the organic solvent, the concentration of the organic solvent is desirably less than 40% by weight in view of safety and inflammability.

Into the developer according to the invention, an antiseptic agent, a chelating agent, a defoaming agent, an organic acid, an inorganic acid, an inorganic salt or the like can be incorporated in addition to the above components.

As the antiseptic agent, for example, phenol or a derivative thereof, formalin, an imidazole derivative, sodium dehydroacetate, a 4-isothiazolin-3-one derivative, benzisothiazolin-3-one, a benzotriazole derivative, an amidine guanidine derivative, a quaternary ammonium salt, a pyridine derivative, a quinoline derivative, a guanidine derivative, diazine, a triazole derivative, oxazole, an oxazine derivative and a nitro bromo alcohol, e.g., 2-bromo-2-nitropropane-1,3-diol, 1,1-dibromo-1-nitro-2-ethanol or 1,1-dibromo-1-nitro-2-propanol are preferably used.

As the chelating agent, for example, ethylenediaminetetraacetic acid, potassium salt thereof, sodium salt thereof; diethylenetriaminepentaacetic acid, potassium salt thereof, sodium salt thereof; triethylenetetraminehexaacetic acid, potassium salt thereof, sodium salt thereof; hydroxyethylethylenediaminetriacetic acid, potassium salt thereof, sodium salt thereof; nitrilotriacetic acid, sodium salt thereof; organic phosphoric acids, for example, 1-hydroxyethane-1,1-diphosphonic acid, potassium salt thereof, sodium salt thereof; aminotri(methylenephosphonic acid), potassium salt thereof, sodium salt thereof; and phosphonoalkanetricarboxylic acids are illustrated. A salt of an organic amine is also effectively used in place of the sodium salt or potassium salt in the chelating agents.

As the defoaming agent, for example, a conventional silicone-based self-emulsifying type or emulsifying type defoaming agent, and a nonionic surfactant having HLB of 5 or less are used. The silicone defoaming agent is preferably used. Any of emulsifying dispersing type and solubilizing type can be used.

As the organic acid, for example, citric acid, acetic acid, oxalic acid, malonic acid, salicylic acid, caprylic acid, tartaric acid, malic acid, lactic acid, levulinic acid, p-toluenesulfonic acid, xylenesulfonic acid, phytic acid and an organic phosphonic acid are illustrated. The organic acid can also be used in the form of an alkali metal salt or an ammonium salt.

As the inorganic acid and inorganic salt, for example, phosphoric acid, methaphosphoric acid, ammonium primary phosphate, ammonium secondary phosphate, sodium primary phosphate, sodium secondary phosphate, potassium primary phosphate, potassium secondary phosphate, sodium tripolyphosphate, potassium pyrophosphate, sodium hexamethaphosphate, magnesium nitrate, sodium nitrate, potassium nitrate, ammonium nitrate, sodium sulfate, potassium sulfate, ammonium sulfate, sodium sulfite, ammonium sulfite, sodium hydrogen sulfate and nickel sulfate are illustrated.

The developer described above can be used as a developer and a development replenisher for the exposed lithographic printing plate precursor and it is preferably applied to an automatic processor described hereinafter. In the case of conducting the development processing using an automatic processor, the developer becomes fatigued in accordance with the processing amount, and hence the processing ability may be restored using a replenisher or a fresh developer. Such a replenishment system can be preferably applied to the invention.

The development processing using the aqueous solution having pH of 2 to 10 according to the invention is preferably performed by an automatic processor equipped with a supplying means for a developer and a rubbing member. As the automatic processor, there are illustrated an automatic processor in which a lithographic printing plate precursor after image exposure is subjected to a rubbing treatment while it is transporting described in JP-A-2-220061 and JP-A-60-59351, and an automatic processor in which a lithographic printing plate precursor after image-recording placed on a cylinder is subjected to a rubbing treatment while rotating the cylinder described in U.S. Pat. Nos. 5,148,746 and 5,568,768 and British Patent 2,297,719. Among them, the automatic processor using a rotating brush roll as the rubbing member is particularly preferred.

The rotating brush roller which can be preferably used in the invention can be appropriately selected by taking account, for example, of scratch resistance of the image area and nerve strength of a support of the lithographic printing plate precursor. As for the rotating brush roller, a known rotating brush roller produced by implanting a brush material in a plastic or metal roller can be used. For example, a rotating brush roller described in JP-A-58-159533 and JP-A-3-100554, or a brush roller described in JP-UM-B-62-167253 (the term “JP-UM-B” as used herein means an “examined Japanese utility model publication”), in which a metal or plastic groove-type member having implanted therein in rows a brush material is closely radially wound around a plastic or metal roller acting as a core, can be used.

As the brush material, a plastic fiber (for example, a polyester-based synthetic fiber, e.g., polyethylene terephthalate or polybutylene terephthalate, a polyamide-based synthetic fiber, e.g., nylon 6.6 or nylon 6.10, a polyacrylic synthetic fiber, e.g., polyacrylonitrile or polyalkyl (meth)acrylate, and a polyolefin-based synthetic fiber, e.g., polypropylene or polystyrene) can be used. For instance, a brush material having a fiber bristle diameter of 20 to 400 μm and a bristle length of 5 to 30 mm can be preferably used.

The outer diameter of the rotating brush roller is preferably from 30 to 200 mm, and the peripheral velocity at the tip of the brush rubbing the plate surface is preferably from 0.1 to 5 msec.

It is preferred to use a plurality, that is, two or more of the rotating brush rollers.

The rotary direction of the rotating brush roller for use in the invention may be the same direction or the opposite direction with respect to the transporting direction of the lithographic printing plate precursor according to the invention, but when two or more rotating brush rollers are used in an automatic processor, it is preferred that at least one rotating brush roller rotates in the same direction and at least one rotating brush roller rotates in the opposite direction with respect to the transporting direction. By such arrangement, the image-recording layer in the non-image area can be more steadily removed. Further, a technique of rocking the rotating brush roller in the rotation axis direction of the brush roller is also effective.

The developer at the development processing can be used at an appropriate temperature and is preferably used from 10 to 50° C.

In the invention, the lithographic printing plate after the rubbing treatment described above may be subsequently subjected to water washing, a drying treatment and an oil-desensitization treatment, if desired. In the oil-desensitization treatment, a known oil-desensitizing solution can be used.

In a plate making process of the lithographic printing plate precursor according to the invention, the entire surface of the lithographic printing plate precursor may be heated, if desired, before or during the exposure or between the exposure and the development. By the heating, the image-forming reaction in the image-recording layer is accelerated and advantages, for example, improvement in the sensitivity and printing durability and stabilization of the sensitivity are obtained. For the purpose of increasing the image strength and printing durability, it is also effective to perform entire after-heating or entire exposure of the image after the development. Ordinarily, the heating before the development is preferably performed under a mild condition of 150° C. or lower. When the temperature is too high, a problem may arise in that undesirable fog occurs in the non-image area. On the other hand, the heating after the development can be performed using a very strong condition. Ordinarily, the heat treatment is carried out in a temperature range of 200 to 500° C. When the temperature is too low, the sufficient effect of strengthening the image may not be obtained, whereas when it is excessively high, problems of deterioration of the support and thermal decomposition of the image area may occur.

The lithographic printing plate obtained according to the development processing described above is mounted on an offset printing machine and used for printing a large number of sheets.

As a plate cleaner used for removing stain on the printing plate at the printing, a plate cleaner for PS plate conventionally known is used. Examples thereof include CL-1, CL-2, CP, CN-4, CN, CG-1, PC-1, SR and IC (produced by Fuji Film Co., Ltd.).

### EXAMPLES

The present invention will be described in more detail with reference to the following examples, but the invention should not be construed as being limited thereto.

### Synthesis Example 1

### Synthesis of Specific Compound (I-10)

### (Synthesis of Intermediate A)

Into a reaction vessel equipped with a condenser and a stirrer were put 653 parts by weight of triglycidyl isocyanurate, 653 parts by weight of pyridine and 1,500 parts by weight of acetonitrile and to the mixture was dropwise added 1,233 parts by weight of phenyl chloroformate with stirring under cooling with ice. After the completion of the dropwise addition, the mixture was continued to stir for 4 hours to deposit white solids. To the mixture was added 7,000 parts by weight of water and stirred for one hour and then the white solids were collected by filtration. The crystals thus-obtained were washed by pouring water and dried in vacuo to obtain 1,550 parts by weight of Intermediate A (tri(2-(phenoxycarbonyloxy)ethyl)) isocyanurate).

### (Synthesis of Specific Compound (I-10))

Into a reaction vessel equipped with a condenser and a stirrer were put 187 parts by weight of Intermediate A and 1,000 parts by weight of tetrahydrofuran and to the mixture was dropwise added 96.5 parts by weight of di(2-hydroxyethyl)amine with stirring at 25° C. The mixture was continued to stir for 4 hours and then the solvent was distilled off under a reduced pressure until the reaction product became slurry. To the slurry was added 4,000 parts by weight of ethyl acetate and the mixture was repeatedly extracted tree times with each 4,000 parts by weight of water. The aqueous phase was dried by distillation under a reduced pressure to obtain 137 parts by weight of Specific compound (I-10).

### Synthesis Example 2

### Synthesis of Specific Compound (I-10)

To a 500 ml flask equipped with a condenser and a stirrer were added 50 g of triglycidyl isocyanurate, 200 ml of water and 0.1 g of sulfuric acid and the mixture was stirred at 90° C. for 3 hours. The reaction mixture was neutralized by adding a 0.01 N aqueous sodium hydroxide solution and treated with an ion-exchange resin to remove an inorganic component and then the solvent was removed under a reduced pressure to obtain Specific Compound (J-1).

Other compounds represented by formula (I) were also synthesized in a similar manner.

### Examples 1 to 23 and Comparative Examples 1 to 6

### 1. Preparation of Lithographic Printing Plate Precursor

### (1) Preparation of Support

An aluminum plate (material: JIS A 1050) having a thickness of 0.3 mm was subjected to a degreasing treatment at 50° C. for 30 seconds using a 10% by weight aqueous sodium aluminate solution in order to remove rolling oil on the surface thereof and then grained the surface thereof using three nylon brushes embedded with bundles of nylon bristle having a diameter of 0.3 mm and an aqueous suspension (specific gravity: 1.1 g/cm³) of pumice having a median size of 25 μm, followed by thorough washing with water. The plate was subjected to etching by immersing in a 25% by weight aqueous sodium hydroxide solution of 45° C. for 9 seconds, washed with water, then immersed in a 20% by weight aqueous nitric acid solution at 60° C. for 20 seconds, and washed with water. The etching amount of the grained surface was about 3 g/m².

Then, using an alternating current of 60 Hz, an electrochemical roughening treatment was continuously carried out on the plate. The electrolytic solution used was a 1% by weight aqueous nitric acid solution (containing 0.5% by weight of aluminum ion) and the temperature of electrolytic solution was 50° C. The electrochemical roughening treatment was conducted using an alternating current source, which provides a rectangular alternating current having a trapezoidal waveform such that the time TP necessary for the current value to reach the peak from zero was 0.8 msec and the duty ratio was 1:1, and using a carbon electrode as a counter electrode. A ferrite was used as an auxiliary anode. The current density was 30 A/dm² in terms of the peak value of the electric current, and 5% of the electric current flowing from the electric source was divided to the auxiliary anode. The quantity of electricity in the nitric acid electrolysis was 175 C/dm² in terms of the quantity of electricity when the aluminum plate functioned as an anode. The plate was then washed with water by spraying.

The plate was further subjected to an electrochemical roughening treatment in the same manner as in the nitric acid electrolysis above using as an electrolytic solution, a 0.5% by weight aqueous hydrochloric acid solution (containing 0.5% by weight of aluminum ion) having temperature of 50° C. and under the condition that the quantity of electricity was 50 C/dm² in terms of the quantity of electricity when the aluminum plate functioned as an anode. The plate was then washed with water by spraying.

The plate was then subjected to an anodizing treatment using as an electrolytic solution, a 15% by weight aqueous sulfuric acid solution (containing 0.5% by weight of aluminum ion) at a current density of 15 A/dm² to form a direct current anodized film of 2.5 g/m², washed with water and dried to prepare Support (1).

### <Preparation of Support A>

In order to ensure the hydrophilicity of the non-image area, Support (1) was subjected to silicate treatment using a 1.5% by weight aqueous sodium silicate No. 3 solution at 70° C. for 12 seconds. The attachment amount of Si was determined by an X-ray fluorescence spectrometer (RIX3000 produced by Rigaku Corp.) and found to be 6 mg/m². Subsequently, the support was washed with water to obtain Support (2). The center line average roughness (Ra) of Support (2) was measured using a stylus having a diameter of 2 μm and found to be 0.51 μm.

Coating solution for undercoat layer shown below was coated on Support (2) so as to have a dry coating amount of 8 mg/m² to prepare Support A.

### [Coating Solution for Undercoat Layer]

| | |
|---|---|
| Compound (1) for undercoat layer shown below (Mw: 100,000) | 0.019 g |
| Methanol | 9.00 g |
| Distilled water | 1.00 g |

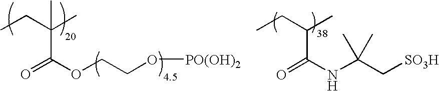

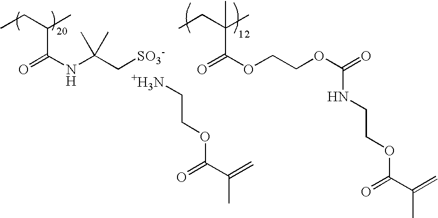

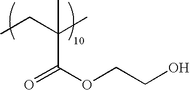

Compound (1) for undercoat layer

### (2) Formation of Image-Recording Layer

Coating solution (1) for image-recording layer having the composition shown below was coated on Support A described above by a bar and dried in an oven at 100° C. for 60 seconds to form an image-recording layer having a dry coating amount of 1.0 g/m².

Coating solution (1) for image-recording layer was prepared by mixing Photosensitive solution (1) shown below with Microgel solution (1) shown below just before the coating, followed by stirring.

### [Photosensitive Solution (1)]

| | |
|---|---|
| Binder Polymer (1) shown below (Mw: 60,000) | 0.185 g |
| Infrared Absorbing Agent (1) shown below | 0.030 g |
| Polymerization initiator (Compound I-28 described hereinbefore) | 0.162 g |
| Polymerizable compound shown in Table 1 | 0.385 g |
| Pionin A-20 (produced by Takemoto Oil & Fat Co., Ltd.) | 0.055 g |
| Oil-sensitizing Agent (1) shown below | 0.044 g |
| Fluorine-based Surfactant (1) shown below (Mw: 13,000) | 0.008 g |
| Methyl ethyl ketone | 1.091 g |
| 1-Methoxy-2-propanol | 8.609 g |
| Specific compound according to invention shown in Table 1 | 0.062 g |
| [Microgel solution (1)] | |
| Microgel (1) shown below | 2.640 g |
| Distilled water | 2.425 g |

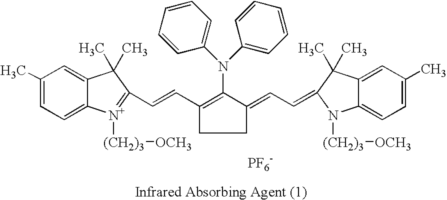

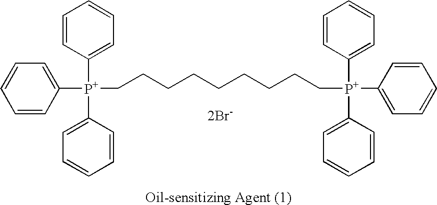

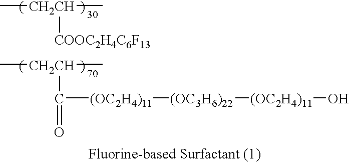

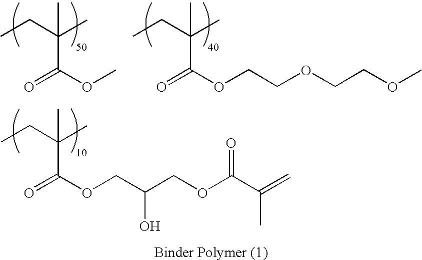

### (Preparation of Microgel (1))

An oil phase component was prepared by dissolving 10 g of adduct of trimethylol propane and xylene diisocyanate (Takenate D-110N, produced by Mitsui Takeda Chemical Co., Ltd.), 3.15 g of pentaerythritol triacrylate (SR444, produced by Nippon Kayaku Co., Ltd.) and 0.1 g of Pionin A-41C (produced by Takemoto Oil & Fat Co., Ltd.) in 17 g of ethyl acetate. As an aqueous phase component, 40 g of a 4% by weight aqueous solution of PVA-205 was prepared. The oil phase component and the aqueous phase component were mixed and emulsified using a homogenizer at 12,000 rpm for 10 minutes. The resulting emulsion was added to 25 g of distilled water and stirred at room temperature for 30 minutes and then at 50° C. for 3 hours. The microgel liquid thus-obtained was diluted using distilled water so as to have the solid concentration of 15% by weight. The average particle size of the microgel was 0.2 μm.

### (3) Formation of Protective Layer

Coating solution (1) for protective layer having the composition shown below was coated on the image-recording layer described above by a bar and dried in an oven at 120° C. for 60 seconds to form a protective layer having a dry coating amount of 0.15 g/m², thereby preparing a lithographic printing plate precursor.

### [Coating Solution (1) for Protective Layer]

| | |
|---|---|
| Dispersion of inorganic stratiform compound (1) shown below | 1.5 g |
| Aqueous 6% by weight solution of polyvinyl alcohol (CKS 50, | 0.55 g |
| sulfonic acid-modified, saponification degree: 99% by mole or | |
| more, polymerization degree: 300, produced by Nippon | |
| Synthetic Chemical Industry Co., Ltd.) | |
| Aqueous 6% by weight solution of polyvinyl alcohol (PVA-405, | 0.03 g |
| saponification degree: 81.5% by mole, polymerization degree: | |
| 500, produced by Kuraray Co., Ltd.) | |
| Aqueous 1% by weight solution of surfactant (Emalex 710, | 8.60 g |
| produced by Nihon Emulsion Co., Ltd. | |
| Ion-exchanged water | 6.0 g |

### (Preparation of Dispersion of Inorganic Stratiform Compound (1))

To 193.6 g of ion-exchanged water was added 6.4 g of synthetic mica (Somasif ME-100, produced by CO—OP Chemical Co., Ltd.) and the mixture was dispersed using a homogenizer until an average particle size (according to a laser scattering method) became 3 μm to prepare Dispersion of inorganic stratiform compound (I). The aspect ratio of the inorganic particle thus-dispersed was 100 or more.

### 2. Evaluation of Lithographic Printing Plate Precursor

The lithographic printing plate precursor was exposed by Luxel Platesetter T-6000III equipped with an infrared semiconductor laser, produced by Fuji Film Co., Ltd. under the conditions of a rotational number of external drum of 1,000 rpm, laser output of 70% and resolution of 2,400 dpi. The exposed image contained a solid image and a 50% halftone dot chart of a 20 μm-dot FM screen.

The exposed lithographic printing plate precursor was mounted without undergoing development processing on a plate cylinder of a printing machine (Lithrone 26, produced by Komori Corp.). Using dampening water (Ecolity-2 (produced by Fuji Film Co., Ltd.)/tap water=2/98 (volume ratio)) and Values-G (N) Black Ink (produced by Dainippon Ink & Chemicals, Inc.), the dampening water and ink were supplied according to the standard automatic printing start method of Lithrone 26 to perform printing on 100 sheets of Tokubishi art paper (76.5 kg) at a printing speed of 10,000 sheets per hour.

### (A) On-Press Development Property

The printing was performed as described above and a number of the printing papers required until the on-press development of the unexposed area of the image-recording layer on the printing machine was completed to reach a state where the ink was not transferred to the printing paper in the non-image area was measured to evaluate the on-press development property. The results obtained are shown in Table 1.

### (B) Printing Durability

After performing the evaluation for the on-press development property, the printing was continued. As the increase in a number of printing papers, the image-recording layer was gradually abraded to cause decrease in the ink density on the printing paper. A number of printing papers wherein a value obtained by measuring a halftone dot area rate of the 50% halftone dot of FM screen on the printing paper using a Gretag densitometer decreased by 5% from the value measured on the 100^{th} paper of the printing was determined to evaluate the printing durability. The results obtained are shown in Table 1.

(C) On-Press Development Property after Lapse of Time

The lithographic printing plate precursor was allowed to stand in a constant temperature and humidity reservoir at 45° C. and relative humidity of 75% for 3 days and then subjected to the exposure and printing in the same manner as described above to evaluate the on-press development property.

As the number of sheet is closer to the number of sheets on the evaluation of on-press development property (A) without the enforced preservation, it is judged that the preservation stability is better. The results obtained are shown in Table 1.

### (D) Scratch Resistance

The lithographic printing plate precursor was exposed under the condition described above and the exposed area of solid image was scratched using a scratch testing machine equipped with a rubber needle having a diameter of 5.0 mm Φ while changing load. Thereafter, the lithographic printing plate precursor was subjected to the on-press development under the condition described above and the maximum load at which the scratch was not recognized on a printed material was determined. The results obtained are shown in Table 1.

TABLE 1
Examples 1 to 23 and Comparative Examples 1 to 6

| | | | | On-Press Development | Printing | |
|---|---|---|---|---|---|---|
| | Specific | Polymerizable | On-Press Development | Property after Lapse | Durability | Scratch |
| | Compound | Compound | Property (sheets) | of Time (sheets) | (×10³ sheets) | Resistance (g) |
| Example 1 | I-3 | A | 5 | 15 | 75 | 50 |
| Example 2 | I-4 | A | 7 | 20 | 70 | 50 |
| Example 3 | I-6 | A | 5 | 16 | 75 | 50 |
| Example 4 | I-10 | A | 4 | 12 | 75 | 50 |
| Example 5 | I-11 | A | 4 | 12 | 75 | 50 |
| Example 6 | I-12 | A | 8 | 18 | 70 | 50 |
| Example 7 | I-13 | A | 7 | 17 | 70 | 50 |
| Example 8 | I-15 | A | 5 | 15 | 75 | 50 |
| Example 9 | I-22 | A | 5 | 15 | 65 | 50 |
| Example 10 | I-28 | A | 5 | 15 | 75 | 50 |
| Example 11 | J-1 | A | 5 | 15 | 75 | 50 |
| Example 12 | J-2 | A | 5 | 15 | 70 | 50 |
| Example 13 | J-3 | A | 5 | 18 | 75 | 50 |
| Example 14 | J-4 | A | 4 | 14 | 65 | 50 |
| Example 15 | J-6 | A | 5 | 16 | 65 | 50 |
| Example 16 | J-7 | A | 5 | 15 | 70 | 50 |
| Example 17 | J-8 | A | 5 | 16 | 65 | 50 |
| Example 18 | J-9 | A | 5 | 20 | 65 | 50 |
| Example 19 | J-10 | A | 5 | 16 | 65 | 50 |
| Example 20 | J-11 | A | 4 | 12 | 60 | 50 |
| Example 21 | J-1 | B | 5 | 15 | 55 | 50 |
| Example 22 | J-2 | B | 5 | 15 | 55 | 50 |
| Example 23 | I-3 | B | 5 | 15 | 55 | 50 |
| Comparative | None | A | Development Failure | Development Failure | — | 50 |
| Example 1 | | | | | | |
| Comparative | C-1 | A | Development Failure | Development Failure | — | 50 |
| Example 2 | | | | | | |
| Comparative | C-2 | A | 100 | Development Failure | 60 | 50 |
| Example 3 | | | | | | |
| Comparative | None | B | Development Failure | Development Failure | — | 45 |
| Example 4 | | | | | | |
| Comparative | C-1 | B | Development Failure | Development Failure | — | 45 |
| Example 5 | | | | | | |
| Comparative | C-2 | B | Development Failure | Development Failure | 30 | 45 |
| Example 6 | | | | | | |

The structures of Comparative Compound C-1, Comparative Compound C-2, Polymerizable Compound A and Polymerizable Compound B are shown below.

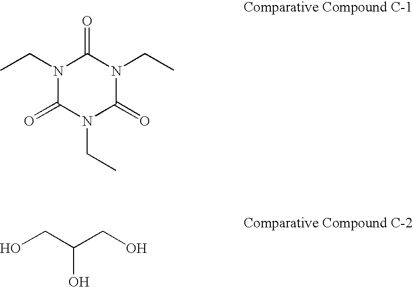

### Polymerizable Compound A

Aronix M-215 (produced by Toagosei Co., Ltd., isocyanuric acid EO modified diacrylate)

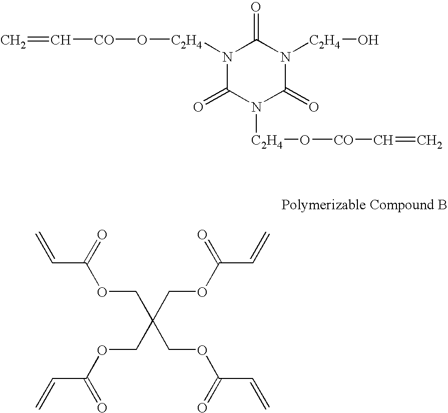

As is apparent from the results shown in Table 1, the lithographic printing plate precursors according to the invention exhibit the excellent on-press development property which is kept after the lapse of time while maintaining good printing durability in comparison with the lithographic printing plate precursors of Comparative Examples 1 to 6. Also, the lithographic printing plate precursors which further contain the polymerizable compound having an isocyanuric acid structure according to the invention are particularly excellent in the balance between the printing durability and the on-press development property.

What is claimed is:

1. A lithographic printing plate precursor comprising: a support; and an image-recording layer comprising (A) an infrared absorbing agent, (B) a polymerization initiator, (C) a polymerizable compound and (D) a compound represented by the following formula (I): 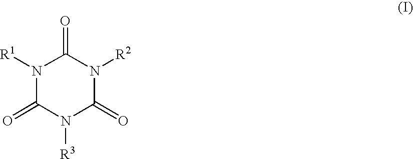
wherein R¹ to R³ each independently represents a hydrogen atom or a group selected from an alkyl group, an aryl group and a heterocyclic group, provided that at least one of R¹ to R³ represents the group having a substituent containing an amido bond, the group having a substituent containing a urethane bond, the group having a substituent containing a urea bond or the group having two or more hydroxy groups.

2. The lithographic printing plate precursor as claimed in claim 1, wherein the group selected from an alkyl group, an aryl group and a heterocyclic group which has a substituent containing an amido bond, a urethane bond or a urea bond further has a hydroxy group.

3. The lithographic printing plate precursor as claimed in claim 1, wherein at least one of R¹ to R³ in the formula (I) is an alkyl group having two or more hydroxy groups.

4. The lithographic printing plate precursor as claimed in claim 1, wherein the polymerizable compound comprises an isocyanuric acid skeleton.

5. The lithographic printing plate precursor as claimed in claim 1, wherein the image-recording layer is capable of forming an image by supplying printing ink and dampening water on a printing machine after imagewise exposure to remove an unexposed area.

6. The lithographic printing plate precursor as claimed in claim 1, wherein the image-recording layer comprises the compound represented by the formula (I) in an amount of from 0.01 to 50% by weight based on a solid content of the image-recording layer.

7. The lithographic printing plate precursor as claimed in claim 1, which further comprises a protective layer comprising an inorganic stratiform compound, so that the support, the image-recording layer and the protective layer are provided in this order.

8. A printing method comprising:
mounting the lithographic printing plate precursor as claimed in claim 1 on a printing machine after imagewise exposure or exposing imagewise the lithographic printing plate precursor claimed in claim 1 after mounting on a printing machine; and
conducting on-press development processing by supplying printing ink and dampening water to the exposed lithographic printing plate precursor to perform printing.
